(19) United States
(12) Patent Application Publication
(10) Pub. No.: US 2013/0325498 A1
(43) Pub. Date: Dec. 5, 2013

(54) Health Outcome Prediction and Management System and Method

(71) Applicant: United States of America, as represented by the Secretary of the Army, Fort Detrick, MD (US)

(72) Inventors: Stephen R. Muza, JR., Medway, MA (US); Beth A. Beidleman, Holliston, MA (US); Charles S. Fulco, Medway, MA (US); Allen Cymerman, Framingham, MA (US)

(21) Appl. No.: 13/910,254

(22) Filed: Jun. 5, 2013

Related U.S. Application Data
(60) Provisional application No. 61/655,802, filed on Jun. 5, 2012.

(51) Int. Cl. G06F 19/00

(52) U.S. Cl. CPC G06F 19/3437
USPC 705/2

(57) ABSTRACT

A system, method and apparatus for providing statistical estimates useful for decision support, including computer networks and software configured to provide such support. The methods and apparatus herein are particularly useful for providing information to health care providers, mission commanders and decision makers as it relates to the statistical modeling of the severity, prevalence and category of prevalence of various diseases in general, and to Acute Mountain Sickness in particular.

### RIGHTS IN THE INVENTION

This invention was made with support from the United States Government, specifically, the United States Army Research Institute of Environmental Medicine; and, accordingly, the United States government has certain rights in this invention.

### FIELD AND BACKGROUND OF THE INVENTION

The invention relates generally to systems, methods and apparatus for providing statistical estimates useful for decision support, including computer networks and software configured to provide such support. The methods and apparatus herein are particularly useful for providing information to health care providers, mission commanders and decision makers as it relates to the statistical modeling of the severity, prevalence and category of prevalence of various diseases in general, and to Acute Mountain Sickness in particular.

ACUTE MOUNTAIN SICKNESS (AMS) is a syndrome of nonspecific symptoms including headache, nausea, vomiting, sleepiness, difficulty breathing, dizziness, anorexia, tachycardia, and insomnia (1). AMS may progress to high altitude pulmonary edema (NAPE) or high altitude cerebral edema (HACE), both of which are potentially life threatening.

AMS is caused by exposure to altitudes exceeding 2500 m and often resolves by acclimatization without further ascent (2). The symptoms frequently appear within a few to 24 h of exposure and usually resolve after several days as acclimatization to altitude develops.

High altitude, rapid ascent, and lack of prior acclimatization are the primary risk factors for developing AMS (1, 3, 4, 5). Symptoms are avoided or reduced in severity by slow or staged ascent to allow progressive acclimatization at higher altitudes, but optimal ascent patterns are uncertain, and recommendations range from 150 to 600 m/day. Acetazolamide ameliorates the effects of AMS and is the preferred prophylactic (1).

With increased participation in mountain recreation, recent deployment of U.S. troops to Afghanistan, and modern means of transportation allowing for rapid ascent to altitude, more people are being exposed to the dangers of AMS (6, 7, 8).

Despite decades of research, no biomathematical models exist to estimate AMS over a wide range of altitudes and time points in unacclimatized lowlanders following rapid ascent utilizing demographic and physiologic descriptors. Previous models of AMS have severe limitations due to select study populations (i.e., mountaineers and trekkers), limited range of altitudes and time points, and lack of control for factors such as acclimatization status, ascent rate, medication usage, hydration status, and environmental conditions (2, 6, 9, 10). Furthermore, none of these models estimate different grades of AMS (i.e., mild, moderate, severe) which is extremely important given that mild AMS is a mere nuisance whereas severe AMS can turn into a life-threatening situation (11). In many cases estimates of altitude illness and acclimatization status are derived from non-validated, limited tables of estimates published in mountain medicine textbooks and high altitude mountaineering literature. The currently available estimates typically represent a “snapshot” usually presenting the estimates as an overall incidence of altitude illness or acclimatization status for a given altitude with no assessment of the changes in altitude illness and acclimatization as a function of time at high altitude. Given that a typical high altitude operation or activity occurs over several days to weeks at altitude, predicting the dynamic change in AMS severity and prevalence over time is essential for mission success.

The invention comprises a number of substantial, novel and non-obvious improvements over the prior art, including but not limited to uniquely presenting the predicted estimates as a function of time at high altitude thus capturing the dynamic nature of altitude illness and acclimatization; basing estimates of altitude illness and acclimatization on validated predictive models over a wide range of altitudes; incorporating into the model factors (e.g., altitude, time, sex and physical activity, etc.) that significantly modify the predictive estimates; and, integrating novel and non-obvious predictive models into a user-friendly (possibly networked) software application or as part of a system or apparatus that provides clear, easy-to-use screens for entering relevant mission parameters and displaying estimates of altitude illness, acclimatization, and work performance in both text and graphic formats.

Another problem is that there are no predictive models of altitude acclimatization as a function of altitude exposure. Further, there is no single until of measurement for quantifying and comparing altitude exposures of varying ascent profiles.

Therefore, a need exists for medical and mission planners to obtain accurate estimates of altitude illness and physical performance capabilities in order to effectively plan high-altitude operations.

Additionally, a need exists for leaders to obtain accurate, real-time, individual assessment of acclimatization status, altitude illness and performance capabilities.

Further, a need exists for medical providers to obtain point-of-care decision support tools for diagnosis and treatment of illnesses in general and altitude illnesses specifically.

### SUMMARY OF THE INVENTION

A system, method and apparatus is disclosed, comprising an Altitude Illness Management Decision Aid (AIAMDA) that integrates novel and nonobvious predictive models of altitude sickness, physical work performance, and altitude acclimatization for populations ascending to high altitudes into a user-friendly software application which itself may be part of a networked system. This decision aid tool provides estimates of altitude illness risk and work performance decrements for a wide range of altitude ascent profiles, and provides customized (individualized) altitude acclimatization protocols as well as the ability to track real-time acclimatization status. The invention represents the next generation of state-of-the-art guidance for risk management of altitude stress.

In one embodiment, the invention is a decision aid, based on a validated predictive models, that provides guidance on risk management associated with “altitude stress”, e.g., altitude illness, acclimatization, work performance at high altitude, etc. One embodiment of the decision aid feature of this invention incorporates several modules, each designed to predict prevalence and severity for different aspects of altitude stress. For example, one module provides information on the prevalence and severity of Acute Mountain Sickness at various altitude ranges, with the risk index adjusted for factors such as gender, work intensity, etc. The decision aids not only provide risk estimates, but also allow end-users to track acclimatization status in real time in such a way that it will facilitate work intensity to be adjusted to reduce user risk. One embodiment of the decision aid tool disclosed herein will provide customized altitude acclimatization protocols, track acclimatization status, and give estimates of altitude sickness risk and work performance decrements for a wide range of altitude ascent profiles.

Presently, no software application or other process exists that provides estimations of altitude acclimatization status based on likelihood of altitude sickness and the magnitude of work impairment. This invention presents novel and non-obvious integration of predictive statistical models of altitude acclimatization status in a wearable device and/or as part of a networked system that automatically tracks a subject's altitude exposure and provides real-time estimates of altitude acclimatization for a wide range of possible target or operation altitudes. Moreover, whereas the prior art was limited in that the available guidance on altitude acclimatization is based largely on mitigating the risk of developing altitude sickness, various aspects of the present invention add the capability of estimating altitude status as a function of work performance at a given high altitude.

By automating a function that has previously been done using laborious and time intensive methods or even guesswork, this invention represents the next generation of high-altitude effects management.

The AIAMDA is of modular design, comprising of at least one module supporting a specific outcome metric such as, for example: altitude acclimatization management and status, acute mountain sickness estimation, and physical work performance estimation. Detailed description of various embodiments of the modules comprising the AIAMDA are provided below.

This invention provides users with state of the art guidance for risk management of high altitude stress: altitude illness, altitude work performance, and altitude acclimatization. The invention can be used in both planning missions/activities at high altitudes and real time management of high altitude exposure to effectively induce altitude acclimatization. In the planning phase, the decision aid will provide the user with estimates of risk of altitude illness and work performance decrements for a given ascent profile to a target altitude. In the planning phase, this decision aid can be used to compare the benefits (i.e., risk reduction) associated with alternative ascent profiles. With better estimates of risk, the user can appropriately resource their activity to manage the risk. The invention can be used to develop altitude acclimatization plans for mitigating the risk of altitude illness and work performance decrements, and in real time with appropriate user inputs can estimate current altitude acclimatization status.

Presently, no software application or other process, system or apparatus exist that provides the estimations of altitude illness, acclimatization status and work performance. A novel feature of this invention is the integration of our novel and non-obvious predictive models of altitude illness, work performance, and acclimatization status in a software application providing an end-user with new capabilities to estimate risk of altitude illness, work performance decrements, and altitude acclimatization in a single, multifunction, user-friendly application.

The invention addresses several shortcomings associated with the current state of the art for predicting the prevalence and severity of AMS and managing acclimatization status in pre-mission planning and during ongoing operations. The prior art is limited to fixed and narrow time parameters, whereas the various models embodied in this invention allow for a dynamic range of time, altitudes and confounding parameters all of which continuously adjust the risk assessment and management data in real-time.

It is an object of the present invention to provide for predictive models of disease and illness prevalence in general and AMS prevalence, onset and symptom severity following rapid ascent to altitude in particular.

It is another object of the present invention to provide for predictive models of physical performance capabilities following rapid ascent to altitude.

It is yet a further object of the present invention to provide for probabilities of AMS prevalence and severity following rapid ascent to altitude.

Certain embodiments of this invention are designed to integrate with physiological status monitoring systems such as that disclosed in U.S. patent application Ser. No. 10/595,672 which is incorporated herein by reference in its entirety.

Certain embodiments of this invention are designed to be used in conjunction with a personal altitude acclimatization monitor (PAAM) as further described herein.

It is a certain object of this invention to provide a system for maintaining automated, real-time, precise assessments of current altitude acclimatization status.

It is another object of this invention to present the predicted acclimatization status to a user as a function of both time and a selected operational altitude in order to capture the dynamic nature of altitude acclimatization.

It is another object of this invention that the user be able to retrieve information generated and stored on the disclosed system through the use of visually displayed screens in both text and graphic formats for easy interpretation and readability.

It is yet another object of this invention to allow managers and decision-makers the capability of estimating altitude acclimatization status as a function of work performance at a given operational altitude.

In various embodiments of this invention, the predictive model or models are designed to accept data relating to the individual characteristics of rapid ascent, unacclimatized personnel operating at law and high levels of physical activity.

In various other embodiments of this invention, the predictive model or models are designed to consider data comprising at least (and not necessarily limited to) one or more of the following categories: subject demographics, sex, age, resident altitude, rate of ascent, operational altitude, work intensity, duration of exposure at operational altitude, AMS symptom severity scores, data collection time-points, physical performance assessment metrics, cognitive performance assessment metrics, specialized skill performance assessment metrics, ventilation, blood & urine parameters, pulse oximetry, medications, VO2 Max, Body-Mass Index, actigraphy, diet, descriptive predictors (i.e. fitness level), physiological predictors (e.g., sea-level PETCO₂, resting heart rate (HR), and additional data that may be useful in predictive models such as those for AMS.

In an aspect of the present invention, the system and method will provide guidance to leaders and decision-makers based on, at least (and not necessarily limited to) one or more of the following estimates: estimates of acclimatization as a function of target altitude, estimates of acclimatization status for a range of higher altitudes, and real-time estimates of the altitude acclimatization status of personnel based on their longitudinal histories.

In one aspect, the present invention provides a machine-readable medium or media having instructions recorded thereon that are configured to instruct the processor to input a regression model specification.

In another aspect, the present invention provides a method for providing decision support.

In yet another aspect, the present invention provides a computer network that includes a server computer and a server module. The server computer includes a processor and memory. The computer network also includes a first client computer, not necessarily different from the server computer. The first client computer includes a first user display device, a first user input device, and a client module. The computer network also includes a second client computer, not necessarily different from the first client computer or the server computer. The second client computer has a second user display device not necessarily different from the first user display device, a second user input device not necessarily different from the first user input device, and a second client module. The server module includes instruction code configured to (a) instruct the processor to communicate common regression models to the first client module and store regression module specification received from the first client module.

It will thus be appreciated that configurations of the present invention facilitate rapid translation of evidence-based predictive models into robust tools (for example, Web-based tools) capable of providing visual representations of predicted outcomes.

In the management of illness, for example, physicians and management personnel can get immediate probability estimates for outcomes such as acute mountain sickness, survival, frequency, or other predictive projections of illness outcomes given an initial set of parameters.

Some configurations provide a broad assortment of graphical outputs that facilitate the sharing of information with decision management personnel.

The various features of novelty that characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a flowchart of one embodiment of the altitude illness decision aid module

FIG. 2 is a flowchart of an alternate embodiment of the altitude illness decision aid module.

FIG. 3 is a flowchart of one embodiment of the physical work performance decision aid.

FIG. 4 is a flowchart of an alternate embodiment of the physical work performance decision aid module

FIG. 5 is a bar graph showing the impact of increasing altitude on fixed pace performance.

FIG. 6 is a line graph showing the impact of increasing altitude on fixed relative intensity (% VO2max) Performance for a standardized competitive event at varying altitudes.

FIG. 7 is a line graph showing the impact of increasing altitude on fixed relative intensity (% VO2max) Performance for the performance of a foot march with combat load.

FIG. 8 is a flowchart of one embodiment of the altitude acclimatization management module.

FIG. 9 is a flowchart of an alternate embodiment of the altitude acclimatization management module.

FIG. 10 is a flowchart of one embodiment of the altitude acclimatization status calculator module.

FIG. 11 is a flowchart of an alternate embodiment of the altitude acclimatization status calculator module.

FIG. 12 is a flowchart of one embodiment of the automated altitude acclimatization status calculator module.

FIG. 13 is a line graph showing varying individual ascent profiles to 4000 m over a period of days.

FIG. 14 is a bar graph showing a cumulative altitude exposure calculation for an individual ascent profile.

FIG. 15 is a bar graph showing cumulative altitude exposure calculations (meter/days) for varying ascent profiles to 4000 m.

FIG. 16 is a line graph showing the predicted prevalence of AMS at 4000 m as a function of cumulative altitude exposure (expressed in meter-days).

FIG. 17 is a pictorial block diagram of a configuration of one embodiment of a computer network of the present invention.

FIG. 18 is an example of a display for the altitude illness decision aid system requesting parameter data.

FIG. 19 is an example of a display of the acclimatization decision aid system requesting parameter data.

FIG. 20 is a flow chart illustrating the steps in one embodiment of the method of developing a model for predicting AMS prevalence of this invention.

FIG. 21 is an example of a display for the altitude illness and acclimatization decision aid system showing a probability curve for AMS prevalence as a function of time at altitude (in hours).

FIG. 22 is an example of a display for the altitude illness and acclimatization decision aid system showing AMS symptom severity scores as a function of time at altitude (in hours).

FIG. 23 is an example of a display for the altitude illness and acclimatization decision aid system showing a bar graph that displays an estimate of the percentage of personnel that will be affected by AMS and the symptoms they may experience as a function of spending 24 hours at 3500 m.

FIG. 24 is an example of a display for the altitude illness decision aid system displaying probabilities of AMS severity based on parameter data.

FIG. 25 is a process diagram that illustrates the creation of a statistical model through the use of data collection and statistical processing, together with the prognostic use of the statistical model in evaluating new responses.

FIG. 26 shows a health care decision aid management system, in accord with one embodiment of the invention.

FIG. 27 shows a flow chart illustrating an operation of the system of FIG. 26.

FIG. 28 illustrates a WAN/LAN of medical evaluation system users connected to a local server which permits the users to share information.

FIG. 29 is a compilation of four line graphs showing AMS prediction model symptom severity output for both high and low activity men and women plotted separately and both high activity men and women and low activity men and women plotted together.

FIG. 30 is a compilation of four line graphs showing AMS prediction model probability for both high and low activity men and women plotted separately and both high activity men and women and low activity men and women plotted together.

FIG. 31 is a compilation of four bar graphs showing AMS prediction model case severity for both high and low activity men and women.

FIG. 32 is a photograph of one embodiment of the personal altitude acclimatization monitor (PAAM) of this invention.

FIG. 33 is a line graph of arterial oxygen partial pressure plotted against arterial oxygen saturation over at the conclusion of a simulated 12-mile road march at various simulated altitudes.

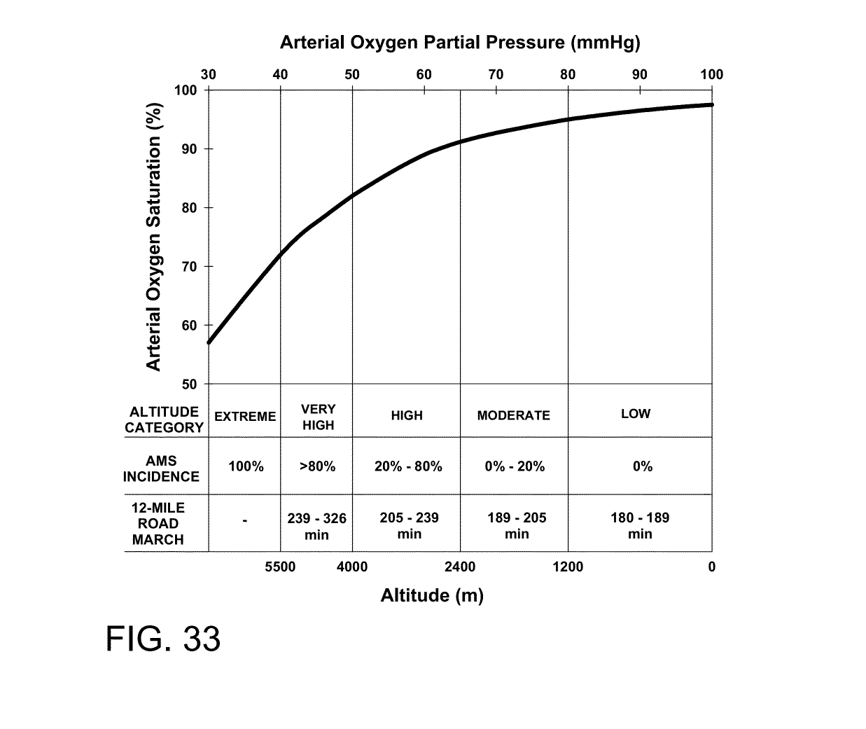

### DESCRIPTION OF THE PREFERRED EMBODIMENTS

To aid in understanding the invention, several terms are either defined below or in the Table Definition for Variables (Table 2) below.

We use the terms “response”, “outcome” or “dependent variable” for measurements that are free to vary in response to other variables called “predictor variables”, “independent variables” or “explanatory variables”.

Dependent and independent variables may be measured using the following nomenclature:

“Nominal Variables”: binary, dichotomous or binomial discrete variables consisting of only two categories. Variables comprising more than two distinct sets of categories are called “multinomial” or “polytomous”.

“Ordinal Variables”: variables describing discrete, categorical, qualitative data that are organized by natural or ranked order, that could include count or frequency per category data.

“Continuous Variables”: variables whose measurements fall on a continuous scale that could include both interval and ratio scale measurements or other quantitative data. Continuous Variables are also known as “covariates”.

A “Factor” is a qualitative, explanatory variable whose categories are subdivided into levels.

“Fixed Effects” means the systematic (or fixed) part a the model which is a specification for the vector m in terms of a number of unknown parameters β₁, . . . , β_{P}. In the case of ordinary linear models, this specification takes the form

$$m = {\sum }_{1}^{p} {x}_{j} {β}_{j} ,$$

where the β's are the parameters whose values are usually unknown and have to be estimated from the data. If we let i index the observations than the systematic part of the model may be written

$$E ( {Y}_{i} ) = {μ}_{i} = {\sum }_{1}^{p} {x}_{ij} {β}_{j} ; i = 1 , … , n ,$$

where xᵢⱼ is the value of the j^{th} covariate for observation i. In matrix notation (where m is n×1, X is n×p and b is p×1) we may write

m=Xb

where X is the model matrix and b is the vector parameters. The actual value of these parameters are usually unknown and have to be estimated from the data. For multi-level mixed models of change, the fixed effects effects capture systematic interior individual differences in change trajectory according to values of the level-2 predictor(s).

“Random Effects” within the context of multi-level fixed models means residuals of level-2 outcomes (the individual growth parameters) that remained “unexplained” by the level-2 predictor(s).

“Multilevel” means a statistical model comprising at least two sublevel models.

As used herein, the terms “coefficients” and “coefficient values,” unless otherwise explicitly specified, are intended to include within their scope that only coefficients, but also any constant or other terms that may be necessary for a model. Such terms may include, for example, and intercept term, a mean squared error term, and/or a number of degrees or freedom term. In addition, “coefficient” data, as used herein, also includes, unless explicitly stated, data computed “on-the-fly” from one or more parent parameters (e.g., the data is computed as a function of and other parameter that is retrieved from a database or requested as input).

### Background Statistical Theory

To provide explicit statements about population processes, statistical models are expressed using parameters-intercepts, slopes, variances, and so on-that represent specific population quantities of interest. One fits a postulated statistical model to sample data in order to estimate the population parameters' unknown values. Most methods of estimation provide a measure of “goodness-of-fit”-such as an R² statistic.

One can use the estimated parameter values derived from a model to draw conclusions about the direction and magnitude of hypothesized effects in the population. Hypothesis tests and confidence intervals may be used to make inferences from the sample back to the population.

These principles will be discussed in more detail generally below, and as they pertain specifically to the application of the various embodiments of this invention.

### Notation (12)

Generally, but not exclusively, we denote the random variables by upper case italic letters and observed values by the corresponding lower case letter. For example, the observations y1, y2, . . . , yₙ are regarded as realizations of random variables Y₁, Y₂, . . . , Yₙ. Greek letters are used to denote parameters and the corresponding lowercase Roman letters are used to denote estimates or estimators; occasionally the symbol ̂ is used for estimators are estimates. For example, the parameter β is estimated by \hat{β} or b. Sometimes these conventions are not strictly adhere to, either to avoid access the notation where the meaning should be apparent from the context, for formatting reasons or for reasons of editorial convenience.

Factors and matrices, whether random or not, are denoted by bold lower and upper case letters, respectively. Thus, y represents a vector of observations

$$[ \begin{matrix}{y}_{1} \\ ⋮ \\ {y}_{n}\end{matrix} ]$$

or a vector of random variables

$$[ \begin{matrix}{Y}_{1} \\ ⋮ \\ {Y}_{n}\end{matrix} ] ,$$

β denotes a vector parameters and X is a matrix. The superscript used for matrix transpose or when a column vectors written as a row

y=[Y₁, . . . ,Yₙ]^{T}.

The probability density function of a continuous random variable Y (or the probability mass function if Y is discrete) is referred to simply as a probability distribution and denoted by

f(y;θ)

where θ represents the parameters of the distribution.

On occasion, we may use dot (.) subscripts for summations and bar (-) for means, thus

$$\overline{y} = \frac{1}{N} {\sum }_{i = 1}^{N} {y}_{i} = \frac{1}{N} y .$$

The expected value and variance of a random variable Y are denoted by E(Y) and var(Y) respectively. Suppose random variables, Y₁, . . . , Tₙ are independent with E(Yᵢ)=Ξᵢ and var(Yᵢ)=σᵢ² for i=1, . . . , n. Let the random variable W be a linear combination of the Yᵢ's

W=a₁Y₁+a₂Y₂+ . . . +aₙYₙ,

where the s are constants. Then the expected value of W is

E(W)=a₁μ₁+a₂μ₂+ . . . +aₙμₙ

and its variance is

var(W)=a₁²σ₁²+a₂²σ₂²+ . . . +aₙ²σₙ².

The matrix notation of the set of observations is denoted by a column vector of observations y={y₁, . . . , yₙ}^{T}. The set of covariates or explanatory variables is arranged as an n×p matrix of X. Each row of X refers to a different unit or observation, and each column to a different covariate. Associated with each covariate is a coefficient or parameter, usually unknown and estimated. The set of parameters is a vector of dimension p, usually denoted by β={β₁, . . . , βₚ}^{T}. For any given value of β, we can define a vector of residuals

e(β)=y−Xβ

### Model Selection (12)

The process of model fitting may be broken down into three components (often repeated iteratively):

(i) model selection;
(ii) parameter estimation, and;
(iii) prediction.

An important characteristic of generalized linear models is that they assume independent (or at least uncorrelated) observations. A second assumption assumes that there is a single error term in the model.

The choice of scale for analysis is in an important aspect of model selection. A common choice is between an analysis of Y, i.e. the original scale, or log Y. With generalized linear models Normality and constancy of variance are not required, although the way in which the variance depends on the mean must be known.

Part of developing a good model is the choice of the independent or x-variables (or covariates as they are known) to be included in the systematic part of the model. A balance must be struck between improving the fit to the observed data by adding a next return to the model and the usually undesirable increase in complexity implicit in the addition of this extra term.

Model-checking techniques may be either informal or formal. Informal techniques rely upon the human mind and eye to detect patterns such models. Formal methods rely on embedding the current model in a wider class that includes extra parameters. The current model passes the check if the inclusion of extra parameters do not markedly improve the fit. Formal methods thus look for deviations from the fit.

Formal methods for dealing with isolated discrepancies include adding dummy variants taken the value 1 for the discrepant unit and zero elsewhere. The change in deviance and then measures the effect of that unit on the fit. The addition of such a dummy variant has an effect on the fit equivalent to deleting that unit from the data matrix.

The components of the generalized linear model Y are independent Normal variables with constant variance σ² and

E(Y)=m where m=Xb.

### Estimation (12)

In the case of generalized linear models, estimation proceeds by defining a measure of goodness-of-fit between the observed data and the fitted values generated by the model. In the parameter estimates are the values that minimize the goodness-of-fit criterion. Therefore, the estimates of most interest to us are those obtained by maximizing the likelihood or log likelihood of the parameters for the data observed.

Comparing alternate models that involve different sets of predictors requires the use of non-nested techniques of log-likelihood measure: the Akaike Information Criterion (AIC) and the Bayesian Information Criterion (BIC). Each is based on the log-likelihood statistic, but add a “penalty” to the LL according to pre-specified criteria. The AIC penalty is based upon the number of model parameters, whereas the BIC also includes the sample size in determining the penalty (e.g. larger samples will need larger improvements). However, there are few objective standards for comparing the results of information criteria, especially for small differences.

### Prediction (12)

Prediction is concerned with statements about the likely values of unobserved events. To be useful, predicted quantities need to be company by measures of precision. These are ordinarily calculated on the assumption that this set-up that produce the data remains constant, and that the model used in the analysis is substantially correct.

The fitting of a simple linear relationship between the ys and the xs requires us to choose from the set of all possible pairs of parameter values a particular pair (a,b) that makes the patterned set ŷ₁, ŷ₂, . . . , ŷₙ closest to the observed data. A number of techniques exist to measure the discrepancy of the model from the observed data, such as the sum least squared deviations method

S(y,ŷ)=Σ(yᵢ−ŷᵢ)²

The appropriateness of this method as a measure of discrepancy depends on stochastic independence and the assumption that the variance of each observation is independent of its mean value.

### Linear Model Form (12)

### For the Model

y=α+βx,

a causal, linear relationship is defined between x and y, which demonstrates how the variation in a known observed quantity, in this case x, affects the outcome measured as y. If we know the actual values of parameters α and β we can determine precisely the corresponding values of y. However, in practice, we have to estimate the value of these parameters, to bring them to describe as closely as possible an approximate linear relationship between independent variable x and dependent variable y. These estimated values, denoted as ŷ₁, ŷ₂, . . . , ŷₙ or \hat{μ}₁, \hat{μ}₂, . . . , \hat{μ}ₙ, are the theoretical or fitted values generated by the model and the data that represent approximations of the data value and may be summarized by the pair (a,b).

### Generalized Linear Models (13)

Generalized linear models include: linear regression and analysis-of-variance models, logit and probit models, log-linear models and multinomial response models for counts and models for survival data.

Generalized Mixed Linear Models contain both systematic effects and random effects. The model offers a simple summary of the data in terms of the major systematic effects together with a summary of the nature and magnitude of the unexplained or random variation.

The Generalized Mixed Linear Models model is defined in terms of a set of independent variables Y₁, . . . , Y_{N} each with a distribution from the exponential family and the following properties:

1. The distribution of each Yᵢ has the canonical form and depends on a single parameter θᵢ (the θᵢ's do not all have to be the same), thus

f(yᵢ;θᵢ)=exp[yᵢbᵢ(θᵢ)+cᵢ(θᵢ)+dᵢ(yᵢ)].

2. The distributions of all the Yᵢ's are of the same form (e.g., all Normal or all binomial) so that the subscripts on b, c and d are not needed.

Thus the join probability density function of Y₁, . . . , Y_{N} is

$$f ( {y}_{1} , … , {y}_{N} ; {θ}_{1} , … , {θ}_{N} ) = {{∐}^{N}}_{i = 1} exp [ {y}_{i} b ( {θ}_{i} ) + c ( {θ}_{i} ) + d ( {y}_{i} ) ] = exp [ {\sum }_{i = 1}^{N} {y}_{i} b ( {θ}_{i} ) + {\sum }_{i = 1}^{N} c ( {θ}_{i} ) + {\sum }_{i = 1}^{N} d ( {y}_{i} ) ] .$$

Suppose that E(Yᵢ)=μᵢ where μᵢ is some function of θᵢ. For the generalized linear model, there is a transformation of μᵢ such that

g(μᵢ)=xᵢ^{T}β

In this equation, g is a monotone, differentiable function called the link function; xᵢ is a p×1 vector of explanatory variables (covariates and dummy variables for levels of factors),

$${x}_{i} = [ \begin{matrix}{x}_{i 1} \\ ⋮ \\ {x}_{ip}\end{matrix} ] so {x}_{i}^{T} = [ {x}_{i 1} … {x}_{ip} ]$$

and β is the p×1 vector of parameters

$$β = [ \begin{matrix}{β}_{1} \\ ⋮ \\ {β}_{p}\end{matrix} ] .$$

The vector xᵢ is the i^{th} column of the design matrix X.

Thus a generalized linear model has three components:

1. Response variables Y₁, . . . , Y_{N} which are assumed to share the same distribution from the exponential family. The general linear model may ordinarily be considered to have a random component where the components of Y have independent Normal distributions with E(Y)=m and constant variance σ²;
2. A set of parameters β and explanatory variables

$$X = [ \begin{matrix}{X}_{1}^{T} \\ ⋮ \\ {X}_{N}^{T}\end{matrix} ] = [ \begin{matrix}{x}_{11} & … & {x}_{ip} \\ ⋮ & & ⋮ \\ {x}_{N 1} & & {x}_{N p}\end{matrix} ] ;$$

For ordinary linear models, the general linear model may be considered to have systematic or fixed component: covariates x_{1,} x_{2,} . . . ,xₚ produce a linear predictor η given by

$$η = {\sum }_{1}^{p} {x}_{j} {β}_{j} ;$$

3. A monotone link function such that

g(μᵢ)=xᵢ^{T}β

where

E(Yᵢ)=μᵢ.

For ordinary linear models, the general linear model may be considered to have a link between the random and systematic components:

m=η,

where ηᵢ=_{g}(uᵢ), otherwise known as the link function.

The Prediction Vector containing the outcome point-estimate(s) is then given by

\hat{μ}=g⁻¹(\hat{η})

where g⁻¹ is the appropriate inverse link function (see Table 1).

The systematic (or fixed) part of the model is a specification for the vector m in terms of a number of unknown parameters β₁, . . . , β_{P}. In the case of ordinary linear models, this specification takes the form

$$m = {\sum }_{1}^{p} {x}_{j} {β}_{j} ,$$

where the β's are the parameters whose values are usually unknown and have to be estimated from the data. If we let i index the observations than the systematic part of the model may be written

$$E ( {Y}_{i} ) = {μ}_{i} = {\sum }_{1}^{p} {x}_{ij} {β}_{j} ; i = 1 , … , n ,$$

where xᵢⱼ is the value of the j^{th} covariate for observation i. In matrix notation (where m is n×1, X is n×p and b is p×1) we may write

m=Xb

where X is the model matrix and b is the vector parameters. The actual value of these parameters are usually unknown and have to be estimated from the data.

### Link Function (13)

The link function relates the linear predictor η to the expected value μ of a datum y. In classical linear models the mean and the linear predictor are identical. If the parameter is characterized as a count with a Poisson distribution, this relationship is expressed by the log link, ρ=log μ, with its inverse μ=e^{η}. For binomial parameters, the three principal link functions include the following:

1. logit: η=log {μ/(1−μ)}
2. probit: η=Φ⁻¹(μ); where Φ(.) is the Normal cumulative distribution function;
3. complementary log-log: η=log {−log(1−μ)}

TABLE 1
Inverse Link Functions

| | |
|---|---|
| Identity | μ = η |
| Log | μ = e^{η} |
| Logit | μ = (1+e^{-η})⁻¹ |
| Power | $μ = \{ \begin{matrix}{η}^{1 / λ} & if λ > 0 \\ {e}^{η} & if λ = 0\end{matrix}$ |
| Complementary log-log | μ = 1 − e^{-e}^{^{η}} |
| Cumulative logit** | πᵢ = (1 + e^{-e}^{^{η}}_{ⁱ})⁻¹ i = 1, . . . , s |
| Cumulative probit** | πᵢ = Φ(ηᵢ)^{*} i = 1, . . . , s |
| Cumulative complementary log-log | ${π}_{i = 1 - {e}^{- {e}^{{η}_{i}}}} i = 1 , … , s$ |
| Generalized logit | ${μ}_{i} = \{ \begin{matrix}{{e}^{{η}_{i}} ( 1 + {\sum }_{j = 1}^{s} {e}^{{η}_{j}} )}^{- 1} & i = 1 , … , s \\ ( 1 + {\sum }_{j = 1}^{s} {e}^{{η}_{j}} ) & i = s + 1\end{matrix}$ |
| Proportional hazards | μ = Sⱼ^{e}^{^{η}} |

${ }^{**} For mulit \text{-} state models , {μ}_{i} = \{ \begin{matrix}{π}_{i} i = 1 \\ {π}_{i} - {\sum }_{j = 1}^{i - 1} {π}_{j} i = 2 , … , s \\ 1 - {\sum }_{j = 1}^{i - 1} {π}_{j} i = s + i\end{matrix}$ *Φ is the standard normal distribution function.

### General Logistic Mixed Model (12)

The general logistic regression model takes the form:

$$logit {π}_{i} = log ( \frac{{π}_{i}}{1 - {π}_{i}} ) = {x}_{i}^{T} β$$

where xᵢ is a vector of continuous measurements corresponding to covariates and dummy variables corresponding to factor levels and β is the parameter vector. This model is suitable for analyzing data involving binary or binomial responses and several explanatory variables.

Maximum likelihood estimates of the parameters β, and consequently of the probabilities πᵢ=g(xᵢ^{T}β), are obtained by maximizing the log-likelihood function

$$l ( π , y ) = {\sum }_{i = 1}^{N} [ {y}_{i} log ( \frac{{y}_{i}}{{\hat{y}}_{i}} ) + ( {n}_{i} - {y}_{i} ) log ( 1 - {π}_{i} ) + log ( \begin{matrix}{n}_{i} \\ {y}_{i}\end{matrix} ) ]$$

Deviance of this model is measured as

$$D = 2 {\sum }_{i = 1}^{N} [ {y}_{i} log ( \frac{{y}_{i}}{{\hat{y}}_{i}} ) + ( {n}_{i} - {y}_{i} ) log ( \frac{( {n}_{i} - {y}_{i} )}{{n}_{i} - {\hat{y}}_{i}} ) ]$$

### Binomial Distribution (12)

In a series of binary events, each with only two possible outcomes, the random variable Y represents the number of “successes” in n independent trials in which the probability of success, π, is the same in all trials. Y has the binomial distribution with probability density function

$$f ( y ; π ) = ( \begin{matrix}n \\ y\end{matrix} ) {{π}^{y} ( 1 - π )}^{n - y} ,$$

where y takes the values 0, 1, 2, . . . , n. This function may be re-written as

$$f ( y ; μ ) = exp [ y log π - y log ( 1 - π ) + ln ( 1 - π ) + log ( \begin{matrix}n \\ y\end{matrix} ) ]$$

with the natural parameter

$$( log it ) = log it ( π ) = log ( \frac{π}{1 - π} ) = log ( π ) - log ( 1 - π )$$

### Nominal Logistic Regression (12)

A response category is arbitrarily chosen as a reference category giving the following logits for the other categories of interest:

$$log it ( {π}_{j} ) = log ( \frac{{π}_{j}}{{π}_{1}} ) = {x}_{j}^{T} {β}_{j} , for j = 2 , … , J .$$

The (j through 1) logit equations are used simultaneously to estimate the parameters βⱼ. Once the parameter estimates bⱼ have been obtained, the linear predictors xⱼ^{T}bⱼ can be calculated:

\hat{π}ⱼ=\hat{π}₁exp(xⱼ^{T}bⱼ) for j=2, . . . ,J.

But \hat{π}₁+\hat{π}₂+ . . . +\hat{π}_{J}=1 so

$${\hat{π}}_{1} = \frac{1}{1 + {\sum }_{j = 2}^{J} exp ( {x}_{j}^{T} {b}_{j} )}$$

$$and$$

$${\hat{π}}_{j} = \frac{exp ( {x}_{j}^{T} {b}_{j} )}{1 + {\sum }_{j = 2}^{J} exp ( {x}_{j}^{T} {b}_{j} )} , for j = 2 , … , J$$

Fitted values (“expected frequencies”) for each covariate can be calculated by multiplying the estimated probabilities \hat{π}ⱼ by the total frequency of the covariate.

The Pearson chi-squared residual is calculated:

$${r}_{i} = \frac{{o}_{i} - {e}_{i}}{\sqrt{{e}_{i}}}$$

where oᵢ and eᵢ are the observed and expected frequencies for i=1, . . . , N where N is J times the number of distinct covariate patterns.

Goodness-of-fit statistics for normal logical regression models include:

Chi-squared statistic

X²=Σᵢ₌₁^{N}rᵢ²

### Deviance

D=2[l(bₘₐₓ)−l/(b)];

where l(b) is the maximum value of the log-likelihood function for fitted model, and l(bₘₐₓ) for the maximal model

There parameters are often expressed as odds ratios:

$${OR}_{j} = \frac{{π}_{jp}}{{π}_{ja}} / \frac{{π}_{1 p}}{{π}_{1 a}}$$

in the instance of a response variable with J categories and a binary explanatory variable x, relative to the reference category j=1 and where πⱼₚ and πⱼₐ denote the probabilities of response category j(j=1, . . . , J).
For the model

$$log ( \frac{{π}_{j}}{{π}_{1}} ) = {β}_{0 j} + {β}_{1 j} x , for j = 2 , … , J$$

the log odds are

$$log ( \frac{{π}_{ja}}{{π}_{1 a}} ) = {β}_{0 j} , when x = 0 , \\ log ( \frac{{π}_{jp}}{{π}_{1 p}} ) = {β}_{0 j} + {β}_{1 j} x , when x = 1.$$

Therefore, the logarithm of the odds ratio can be written:

$$log {OR}_{j} = log ( \frac{{π}_{jp}}{{π}_{1 p}} ) - log ( \frac{{π}_{ja}}{{π}_{1 a}} ) = {β}_{1 j}$$

and ORⱼ=exp(β₁ⱼ) as estimated by exp(b₁ⱼ).

### Cumulative Logit Model

The cumulative odds for the jth category is

$$\frac{P ( z \leq {C}_{j} )}{P ( z > {C}_{j} )} = \frac{{π}_{1} + {π}_{2} + … + {π}_{j}}{{π}_{j + 1} + … + {π}_{J}} ;$$

and the cumulative logit model is

$$log \frac{{π}_{1} + … + {π}_{j}}{{π}_{j + 1} + … + {π}_{J}} = {x}_{j}^{T} {β}_{j} .$$

### Proportional Odds Model (12)

If linear predictor xⱼ^{T}βⱼ has an intercept term β₀ⱼ which depends on the category j, but the other explanatory variables no not depend on j, then the model is the proportional odds model which may be written in the form of:

$$log \frac{{π}_{1} + … + {π}_{j}}{{π}_{j + 1} + … + {π}_{J}} = {β}_{0 j} + {β}_{1} {x}_{1} + … + {β}_{p - 1} {x}_{p - 1}$$

### Log-Linear Models for Counts (12)

The analysis of counted data may be modeled using log-linear techniques. In such a model, the two components of the classical linear model (as defined above) are replaced by substituting multiplicative methods for additive for systematic effects, and Poisson distribution in lieu of Normal distribution for Nominal error distribution. The Poisson distribution has only one adjustable parameter, namely the mean μ, which must be positive. Hence, we set μ=exp(η) and η rather than μ obeys the linear model. This construction ensures that μ remains positive for all η and hence positive for all parameters and covariate combinations.

### Multi-Level Model for Change

This invention employs a new class of statistical models to investigate the change of AMS severity over time at altitude. The basic characteristic of this model is the inclusion of random subject effects in order to account for the influence of individual subjects on their repeated observations. These random subject effects describe each person's starting point and trend across time, and explain the correctional structure of the longitudinal data. The advantage of this model is that it is robust to missing data, irregularly spaced measurements, unbalanced data, violations of constant variance and independence of residuals, and can easily handle both time-varying and time-invariant covariates. As such, the various embodiments of the invention disclosed offer several advantages over the typical univariate and multivariate repeated measures analysis of variance techniques commonly used in the art today.

### Longitudinal Data (14)

The outcomes of repeated measurements over time on the same subjects are an example of longitudinal data. For this reason longitudinal data from a group of subjects are likely to exhibit correlation between successive measurements. This means, that for such data, the assumption that the outcomes are assumed to be independent is no longer valid.

When analyzing generalized linear models for longitudinal data is helpful to examine three specific quantities:

(1) sample means of the estimated intercepts and slopes. The level-1 estimated intercepts and slopes are unbiased estimates of initial status and rate of change for each person.
(2) sample variances (or standard deviations) of the estimated intercepts and slopes. These measures quantify the amount of observed inter-individual heterogeneity in change.
(3) sample correlation between the estimated intercepts and slopes. This correlation summarizes the association between fitted initial status and fitted rate of change.

Consider longitudinal data in which Yⱼₖ is the measurement at time tₖ on subject who was selected at random from the population of interest. A linear model for this situation would be:

Yⱼₖ=βₒ+aⱼ+(β₁+bⱼ)tₖ+eⱼₖ

where βₒ and β₁ are the intercept and slope parameters for the population, αⱼ and bⱼ are random effects and we want to estimate βₒ,β₁,σₐ²,σ_{b}² and σₑ².

A generalized linear model for longitudinal data must include components at two levels: (1) a level-1 sub model that describes how individuals change over time; and (2) a level-2 sub model that describes how these changes vary across individuals. Taken together, these two components form what is known as a multilevel statistical model.

### Individual Growth Model (Level-1 Sub-model)(14)

The level-1 component of the multilevel model, also known as the individual growth model, represents the change we expect each member of the population to experience during the time period under study. Because each individual draws his or her own coefficients from an unknown random distribution of parameters, the multilevel model for change is often termed a random coefficients model.

The form of the individual growth model can be as follows:

Yᵢⱼ=[π₀ᵢ+π₁ᵢ(FACᵢⱼ−1)]+[εᵢⱼ]

where Yᵢⱼ is the dependent outcome measurement we are trying to model for subject i at time j, asserting that the relationship is a linear function of a designated factor or covariate and an associate error term εᵢⱼ (assumed to be Normally distributed −εᵢⱼ˜N(0,σ_{ε}²)). The model includes individual growth parameters π₀ᵢ and π₁ᵢ (intercept and slope) that characterize the shape of the linear model for the ith subject in a population. The brackets distinguish between two parts of the sub-model: the structural part (in the first set of brackets) and stochastic part (in the second set of brackets).

### Level-2 Sub-Model (14)

The level-2 sub-model codifies the relationship between interindividual differences in the change trajectories and time-invariant characteristics of the individual, Subjects in a level-one linear change model can differ only in their intercepts and slopes. The model thus allows us to ask specific questions about the relationship between the individual growth parameters and predictors.

The level-2 sub-model has four features:

First, its outcomes must be the individual growth parameters. Second, the level-2 sub-model must be written in separate parts, one for each level-one growth parameter. Third, each part must specify a relationship between an individual growth parameter and the predictor. Fourth, each model must allow individuals who share common predictor values to vary in their individual change trajectories. This means that each level-2 sub model must allow for stochastic variation in the individual growth parameters.

These considerations are considered in the following level-2 submodel for data involving one factor (FAC):

π₀ᵢ=γ₀₀+γ₀₁FACᵢ+ζ₀ᵢ

π₁ᵢ=γ₁₀+γ₁₁FACᵢ+ζ₁ᵢ

This demonstrates that the level-2 sub-model has more than one component, each resembling a regular regression model. Taken together, the two components treat the intercept (π₀ᵢ) and the slope (π₁ᵢ) of an individual's growth trajectory as a level-2 outcomes that may be associated with the predictor/factor FAC. Each component also has its own residual—here, ζₒᵢ and ζ₁ᵢ—that permits the level-1 parameters (the π's) of one subject to differ stochastically and those of others. The two components of this level-2 sub-model have seven population parameters: the four regression parameters shown, and three residual variance/covariance parameters. All are estimated when the multilevel model for change is fit to the data.

### Fixed Effects (14)

The structural parts of the level-2 sub-model contained for level-2 parameters: γ₀₀,γ₀₁,γ₁₀,γ₁₁, known collectively as the fixed effects. The fixed effects capture systematic interior individual differences in change trajectory according to values of the level-2 predictor(s). Level-2 parameters may be interpreted much like regular regression coefficients, except that they describe variation in “outcomes” that are themselves level-1 individual growth parameters.

### Random Effects (14)

Each part of the level-2 sub-model contains a residual that allows the value each person's growth parameters to be scattered around the relevant population averages. These residuals, ζ₀ᵢ and ζ₁ᵢ, represent those portions of the level-2 outcomes (the individual growth parameters) that remained “unexplained” by the level-2 predictor(s). The population variances and covariance or random effects are may be designated as σ₀²,σ₁² and σ₀₁. Because the level-2 residuals represent deviations between the individual growth parameters and their respective population averages, their variances summarize the population variation in true individual intercept and slope around these averages. Because they describe those portions of the intercepts and slope left over after accounting for the effects of the models predictors, they are actually conditionally residual variances. These variance parameters allow us to determine how much heterogeneity interchange remains after accounting for the effects of program participation?

Because we have two level-2 residuals, we describe their underlying behavior using a bivariate distribution. The standard assumption is that the two level-2 residuals are bivariate normal with mean 0, unknown variances and unknown covariance. We can express these assumptions compactly using matrix notation by writing:

$$[ \begin{matrix}{ζ}_{0 i} \\ {ζ}_{1 i}\end{matrix} ] ∼ N ( [ \begin{matrix}0 \\ 0\end{matrix} ] , [ \begin{matrix}{σ}_{0}^{2} & {σ}_{01} \\ {σ}_{10} & {σ}_{1}^{2}\end{matrix} ] ) .$$

The first matrix on the right in parentheses specifies the bivariate distribution's mean vector; here, we assume it to be 0 for each residual (as usual). The second matrix specifies the bivariate distribution's variance-covariance matrix, also known as the level-2 arrow covariance matrix because it captures the covariation among the level-2 residuals. The complete set of residual variances and co-variances for both level-1 and level-2 submodels are known collectively as the models' variance components.

A number of programs for fitting multilevel models to longitudinal data are available and are interchangeable, including but not limited to: HLM (15), MLn (16), GENMOD, and VARCL; SAS (17) PROC MIXED and PROC NLMIXED, STATA (18) “xt” routines, SPLUS (19) NLME library, BUGS (20) and MIXREG. There is evidence that all the different packages produce the same, or similar, answers to a given problem (21).

Single Parameter Tests for the Fixed Effects (14)

As a regular regression, you can conduct a hypothesis test on each fixed effect using a single parameter test. Although you can equate the parameter value to any pre-specified value in your hypothesis test, most commonly one will examine the null hypothesis that, controlling for all other predictors in the model, the population value of the parameter is, 0,H₀:γ=0, against the two-sided alternative that it is not, H₁:γ≠0. This hypothesis is tested for each fixed effect by computing the z-statistic:

$$z = \frac{\hat{γ}}{ase ( \hat{γ} )} .$$

Tests for variance components evaluate whether there is any remaining residual outcome variation that could potentially be explained by other predictors. The level of the particular variance component dictates the type or predictor that might be added. In general, all the tests are similar in that they assess the evidence concerning the no hypothesis that the parameters population value is 0, 0,H₀:σ² against the alternative that it is not, H₁:σ²≠0.

This test can be achieved using single parameter tests such as a z-statistic or by squaring the z-statistic and labeling it as a chi-squared statistic on 1 degree of freedom.

### Composite Multilevel Model for Change (14)

Level-1 and 2 sub-models may be collapsed together algebraically into a single composite model. As the individual growth parameters of the level-1 sub-model are the outcomes of the level-2 sub-model, the two models may be collapsed together by substituting for π₀ᵢ and π₁ᵢ from the level-2 sub-model into the level-1 sub-model as shown:

### Given

Submodel level-1: Yᵢⱼ=[π₀ᵢ+π₁ᵢ(FACᵢⱼ−1)]+[εᵢⱼ] and,
Submodel level-2: π₀ᵢ=γ₀₀+γ₀₁FACᵢ+ζ₀ᵢ
π₁ᵢ=γ₁₀+γ₁₁FACᵢ+ζ¹ⁱ
   we derive through substitution the following equation:

Yᵢⱼ=(γ₀₀γ₀₁FACᵢ+ζ₀ᵢ)+(γ₁₀+γ₁₁FACᵢ+ζ₁ᵢ)(FACᵢⱼ−1)+εᵢⱼ.

Multiplying out and rearranging terms yields the composite multilevel model for change:

Yᵢⱼ=[γ₀₀+γ₀₁FACᵢⱼ+γ₀₁FACᵢ+γ₁₁(FACᵢ×FACᵢⱼ)]+[ζ₀ᵢ+ζ₁ᵢFACᵢⱼεᵢⱼ]

with brackets separating out the model's structural and stochastic components.

### Structural Component of the Composite Model (14)

The structural component of the composite model retains the same fixed effects, γ₀₀,γ₀₁,γ₁₀,γ₁₁, which serve to describe the average change trajectories for individuals distinguished by their level-2 predictor values. Although their interpretation is identical to that of their sublevel counterparts, the fixed factors in the composite model describe patterns of change in a different way. Rather than correlating each sublevel predictor separately, it relates each sublevel predictor simultaneously to the dependent variable of interest while at the same time accounting for cross-level interaction.

### Stochastic Component of the Composite Model (14)

The composite multilevel model features a composite residual term, [ζ₀₁+ζ₁ᵢFACᵢⱼ+εᵢⱼ], which describes the difference between the observed and the expected value of Y for individual i on occasion j. It's form reveals that residuals can both be autocorrelated and heteroscedastic within person. The composite model allows for heteroscedasticity via the level-2 residual ζ₁ᵢ. Because ƒ₁ᵢ is multiplied by FAC in the composite residual, its magnitude can differ across occasions. If there are systematic differences in the magnitudes of the composite residuals across occasions, there will be accompanying differences in the residual variance causing heteroscedasticity.

The presence of the time-invariant ζ₀ᵢ's and ζ₁ᵢ's in the composite residual allows the residuals to be autocorrelated, both sharing the same residual on every occasion.

### Methods of Estimation for Composite Multilevel Models (14)

The new terms introduced in composite multilevel models necessitates that alternate methods of fitting the multilevel model for change are adopted, specifically: full and restricted methods of generalized least squares (GLS) estimation and iterative generalized least squares (IGLS) estimation.

GLS estimation is an extension of ordinary least-squares (OLS) estimation. Like OLS, GLS, seeks parameter estimates that minimize the sum of squared residuals, but unlike OLS, allows the residuals to be autocorrelated and heteroscedastic in the composite model. GLS is applied in two stages: in the first stage data is regressed on the model's predictors using OLS methods and an error covariance matrix is estimated; second, the estimated covariance matrix is treated as the true error covariance matrix in a second run of the composite model using GLS.

IGLS is essentially taking the same processed used for GLS and applying it iteratively, each time using the previous set of estimated fixed effects to re-estimate the error covariance, which then leads to GLS estimates of the fixed effects that are thus further refined. This process is repeated until the output meets pre-set conditions for convergence of a best-fit.

### Varying Spaces and Waves of Data Sets (14)

The multilevel model for change is not affected by the individual-specific cadence of the level-1 predictor that may vary from case to case as it is fit using the actual numeric value of the temporal predictor. Unlike approaches such as repeated measures analysis of variance, multilevel models of change do not require that the data sets be balanced, that is the number of measurements vary across individuals. The only requirement for modeling unbalanced data sets using multilevel models of change is that there are enough subjects with enough waves of data for the numeric algorithms to converge on a best-fit model, allowing one to estimate one or more of the variance components. The flexibility of the multilevel model also enables one to incorporate time-varying predictors as each predictor has its own value on each occasion. However, one must be careful to account for the effects of time-varying predictors on a multilevel model's variance component when deciding on whether or not to retain a time-varying predictor in the model.

### Recentering Predictors (14)

The primary rational for subtracting a constant from each observed value, otherwise known as “recentering” the data, is that it simplifies interpretation. If subtracted from a temporal predictor, the recentered data refers to the true value of the dependent variable to a particular subject in time. Time invariant data might be recentered before analysis to make direct interpretation of parameters possible (i.e., through the use of a common baseline). In the case of time invariant data, the process is to subtract the sample mean from the observed value resulting in the level-2 fitted intercepts representing the average fitted values of initial status. Recentering time invariant data may also allow a more intuitive understanding of the data by converting it to a common standard, such as using “12” as a centering constant for a predictor representing years of education in the U.S., etc. Recentering time variant predictors around a substantively meaningful constant other than around the gran-mean is also well known in the art.

Centering time on the first wave of data collection is usually the preferred methodology. Aligning π₀ᵢ with the first wave of data collection allows us to interpret its value using simple nomenclature—is the subject i's true initial status. The slope of the sub-level 1 model, π₁ᵢ, Represents the rate at which individual i changes over time. The full multilevel model for change accommodates automatically for certain kinds of complex error structure issues such as issues of residual autocorrelation and heteroscedasticity.

### Altitude Readiness Management System (Arms)

The ARMS, also known as the Altitude Illness Management Decision Aid

(AIAMDA), estimates outcomes from current status, buy taking in a set of inputs including but not limited to: starting elevation, target elevation, ascent rate, duration at target elevation, gender, acclimatization status, work intensity and work duration, medication, task performance metric, and sea-level performance metrics. Using the developed predictive models developed, the various modules described above produce outputs, including but not limited to: AMS probability, AMS severity-stratified and Task Performance at sea level.

The ARMS/AIAMDA comprises at least one or more of the following modules as described in detail below. While random coefficient models are demonstrated below, alternate methodologies can be utilized such as using both random coefficients and repeated covariance structure.

### Modules

Table for Definitions of Model Variables (Table 2) contained in the three AMS models developed from the USARIEM Mountain Medicine Database: AMS Severity (General linear mixed model), AMS Prevalence (General logistic mixed model), and AMS Category of Severity (General proportional odds mixed model). All of these models are specific for repeated measures data (one subject has 1-10 measurements of AMS and these measurements are typically correlated) with unbalanced data (AMS measured at differing time points in different studies).

TABLE 2
Definitions of Model Variables

| | | Type of |
|---|---|---|
| Variable | Definition | Data |
| AMS-C | Acute Mountain Sickness Cerebral Factor Score (Skewed | Continuous |
| | with a lot of zeros) | |
| Log-AMS-C | Natural logarithm of AMS-C scores to meet normality | Continuous |
| | assumptions. Normality met by skewness and kurtosis | |
| | statistics and Kolmogrow-Smirnov test of normality | |
| AMS-Prevalence | If AMS-C ≧0.7, then AMS = 1 otherwise AMS = 0 | Binary |
| No AMS | If AMS <0.7 | Ordinal (0) |
| Mild AMS | If AMS-C ≧0.7 and <1.530 | Ordinal (1) |
| Moderate AMS | If AMS-c ≧1.530 and <2.630 | Ordinal (2) |
| Severe AMS | If AMS ≧2.630 | Ordinal (3) |
| Age | | Continuous |
| Sex | Men = 1/Women = 0 | Binary |
| Activity | High = 1/Low = 0 | Binary |
| | High = ≧50% maximal oxygen uptake for ≧45 min upon | |
| | arrival at altitude | |
| Height (m) | | Continuous |
| Weight (kg) | | Continuous |
| Body Mass Index (BMI) | Indicative of obesity if ≧30 kg/m² | Continuous |
| (kg/m²) | | |
| Race | 1 if white, 0 all other races | Binary |
| Smoking Status | 1 if smoker, 0 if non-smoker | Binary |
| Altitude (m) | Elevation | Continuous |
| Time at altitude (h) | Elapsed time after ascent | Continuous |
| Time at altitude² (h²) | Time² | Continuous |
| Centered time at | (Time at altitude − 20 h)/24 h | Continuous |
| altitude (Ctime) (days) | | |
| Centered time at | CTime² | Continuous |
| altitude² | | |
| (Ctime²)(days²) | | |
| ESQ-III | Environmental Symptoms Questionnaire (Questionnaire | |
| | used to collect AMS-C data) | |
| Unacclimatized | No altitude exposure in previous 3 months | |
| Rapid ascent | <2 h to ascend to altitude | |
| Root mean square | Measure of how well model predicts: square root of the | |
| error (RMSE) | (predicted value-actual value)²/n − 1 | |
| Confidence interval (CI) | 95% confident AMS-C scores will fall in this range | |
| Odds | Probability of the event happening/probability of the event | |
| | not happening | |
| Odds ratio | Odds at time point 0 h/odds at time point 20 h | |
| Ryŷ² | Correlation squared between actual values and predicted | |
| | values from continuous model | |
| Akaike Information | Measure of the best model. Lower values better | |
| Criteria (AIC) | | |

### Acute Mountain Sickness Assessment Module

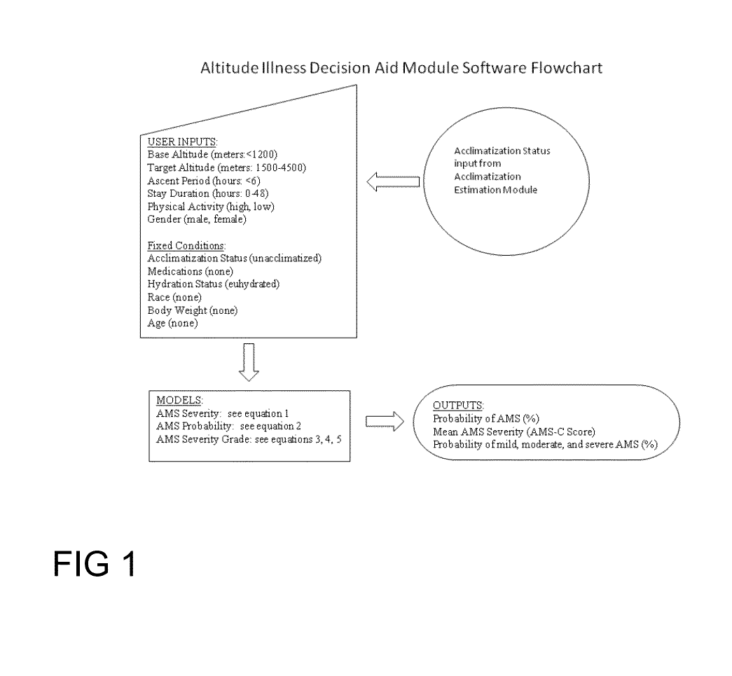

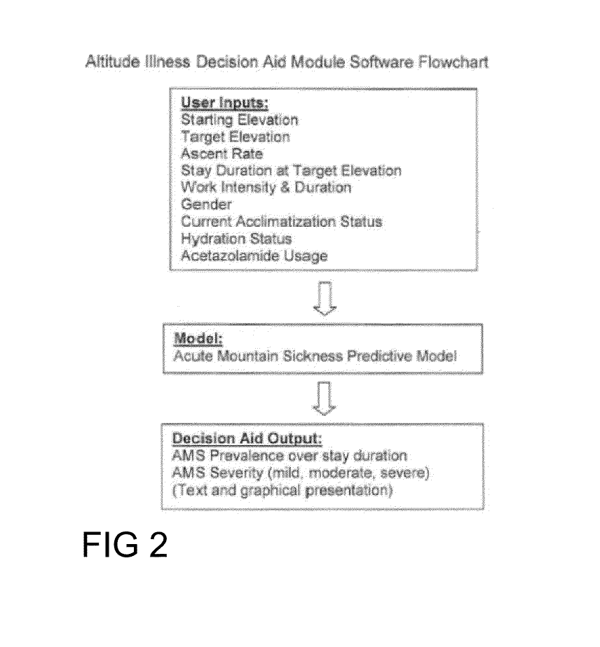

This module provides an estimate of prevalence and severity of AMS. A novel aspect of this invention as embodied in the AMS Assessment Module is its ability to predict the dynamic change in AMS severity and prevalence over varying ranges of time and altitudes. Another novel aspect of this invention as embodied in the AMS Assessment Module is its ability to adjust AMS risk prediction based on a number of input parameters (in some instances selectable by the user) to include, by way of example, work intensity, gender, acclimatization status, and so on (see alternate embodiments in FIGS. 1 and 2). A further novel aspect of this invention is its use of percentages to show changes of risk for negative outcomes based on varying parameters. This can be done on “on-the-fly” to provide an intuitive and interactive assessment of risk under differing conditions to give leaders and decision-makers a sense of the safe operating parameters for a particular mission.

Tables 3, 4 and 5 demonstrate embodiments of the AMS Cerebral Factor (AMS-C) Score Prediction Model, the AMS Prevalence Prediction (Binary) Model and the AMS Grade Severity Prediction Model respectively, as incorporated as part of the Altitude Acclimatization Management Module Decision Aid

TABLE 3
AMS Cerebral Factor (AMS-C) Score Prediction Model

| | |
|---|---|
| INPUTS | Exposure Time: T (hr) |
| | Altitude: ALT (km) |
| | Activity: ACT (low = 0, high = 1) |
| | Sex: SEX (female = 0, male = 1) |
| TRANSFORMATIONS & | Centered Time: |
| CONSTANTS | CT (CT = (T hr − 20 hr)/24 hr) |
| | e = 2.718 |
| AMS-C Score Prediction | $AMS \text{-} C = {e}^{[ \begin{matrix}- 4.55 + ( {CT}^{*} - 0.66 ) + ( {( {CT}^{⋀} 2 )}^{*} 1.82 ) + \\ ( {ALT}^{*} 1.03 ) + ( {ALT}^{*} {CT}^{*} 0.18 ) + \\ ( {{ALT}^{*} ( {CT}^{⋀} 2 )}^{*} - 1.11 ) + ( {ACT}^{*} 0.09 ) + \\ ( {ACT}^{*} {CT}^{*} 0.37 ) + ( {{ACT}^{*} ( {CT}^{⋀} 2 )}^{*} 0.55 ) + \\ ( {SEX}^{*} 0.33 ) + ( {SEX}^{*} {CT}^{*} - 0.16 ) + \\ ( {{SEX}^{*} ( {CT}^{⋀} 2 )}^{*} - 0.94 )\end{matrix} ]}$ |

TABLE 4
AMS Prevalence Prediction (Binary) Model

| | |
|---|---|
| INPUTS | Exposure Time: T (hr) |
| | Altitude: ALT (km) |
| | Activity: ACT (low = 0, high = 1) |
| | Sex: SEX (female = 0, male = 1) |
| TRANSFORMATIONS & | Centered Time: |
| CONSTANTS | CT (CT = (T hr − 20 hr)/24 hr) |
| | e = 2.718 |
| AMS-C Score Prediction | AMS logit = [−7.04 + (CT * −4.11) + |
| | (CT\hat{ }2 * −2.74) + (ALT * 1.69) + |
| | (ALT * CT * 1.07) + (ACT * 0.54) + |
| | (ACT * CT * 0.39) + (SEX * 0.50) + |
| | (SEX * CT * 0.21) + (SEX * (CT\hat{ }2) * |
| | −1.29) |
| | Probability (%) AMS = |
| | e^{(AMS logit)}/1 + e^{(AMS logit)} |

TABLE 5
AMS Grade of Severity Prediction Model

| | |
|---|---|
| INPUTS | Exposure Time: T (hr) |
| | Altitude: ALT (km) |
| | Activity: ACT (low = 0, high = 1) |
| | Sex: SEX (female = 0, male = 1) |
| TRANSFORMATIONS & | Centered Time: |
| CONSTANTS | CT (CT = (T hr − 20 hr)/24 hr) |
| | e = 2.718 |
| Severe Grade AMS | logit: 3 = [−10.66 + (CT * −3.79) + |
| Calculation | (CT\hat{ }2 * −3.03) + (ALT * 1.82) + |
| | (ALT * CT * 0.93) + (ACT * 0.55) + |
| | (ACT * CT * 0.39) + (SEX * 0.57) + |
| | (SEX * CT * 0.22) + (SEX * (CT\hat{ }2) * |
| | −1.66) |
| Moderate + Severe | logit: 4 = [−9.04 + (CT * −3.79) + |
| Grade AMS Calculation | (CT\hat{ }2 * −3.03) + (ALT * 1.82) + |
| | (ALT * CT * 0.93) + (ACT * 0.55) + |
| | (ACT * CT * 0.39) + (SEX * 0.57) + |
| | (SEX * CT * 0.22) + (SEX * (CT\hat{ }2) * |
| | −1.66) |
| Mild + Moderate + Severe | logit: 5 = [−7.46 + (CT * −3.79) + |
| Grade AMS Calculation | (CT\hat{ }2 * −3.03) + (ALT * 1.82) + |
| | (ALT * CT * 0.93) + (ACT * 0.55) + |
| | (ACT * CT * 0.39) + (SEX * 0.57) + |
| | (SEX * CT * 0.22) + (SEX * (CT\hat{ }2) * |
| | −1.66) |
| Severe Grade AMS | e^{(logit:3)}/1 + e^{(logit:3)} |
| Probability (%) | |
| Moderate Grade AMS | (e^{(logit:4)}/1 + e^{(logit:4)}) − (e^{(logit:3)}/1 + e^{(logit:3)}) |
| Probability (%) | |
| Mild Grade AMS | (e^{(logit:5)}/1 + e^{(logit:5)}) − (e^{(logit:4)}/1 + e^{(logit:4)}) |
| Probability | |

TABLE 6
AMS-C Multilevel Model for change (aka Random Coefficient Model)
Level 1 Sub-Model: Describes how each person changes over time
(within person change)
Yᵢⱼ = b₀ᵢ + b₁ᵢCTimeᵢⱼ + b₂ᵢCTimeᵢⱼ² + εᵢⱼ
Yᵢⱼ = AMS-C scores log transformed in individual i at time j.
i = 1 . . . 308 (individuals)
j = 0 . . . 48 h (time)
b₀ᵢ = intercept of the individual change trajectory for individual i
b₁ᵢ = Instantaneous rate of change (akin to velocity) for individual i at time
point j
b₂ᵢ = accelearation/deceleration in change (rate of change in change with
increasing time) for individual i
Ctime = (Time − 20 h) time centered at 20 h
εᵢⱼ = random measurement error
Level 2 Submodel: Describes how these changes over time differ across
persons based on person specific characteristics (between person
differences in change)
bₒᵢ = β₀₀ + β₀₁ Altitudeᵢ + β₀₂Activityᵢ + β₀₃Sexᵢ + ζ₀ᵢ
b₁ᵢ = β₁₀ + β₁₁ Altitudeᵢ + β₁₂Activityᵢ + β₁₃Sexᵢ + ζ₁ᵢ
b₂ᵢ = β₂₀ + β₂₁ Altitudeᵢ + β₂₂Activityᵢ + β₂₃Sexᵢ + ζ₂ᵢ
Yᵢⱼ = AMS-C scores log transformed in individual i at time j.
i = 1 . . . 308 (individuals)
j = 0 . . . 48 h (time)
b₀ᵢ = intercept of the individual change trajectory for individual i
b₁ᵢ = Instantaneous rate of change (akin to velocity) for individual i at
time point j
b₂ᵢ = accelearation/deceleration in change (rate of change in change
with increasing time) for individual i
Ctime = (Time − 20 h) time centered at 20 h
εᵢⱼ = random measurement error
Reduced Form of the Model (derivation below):
Yᵢⱼ = b₀ᵢ + b₁ᵢCTimeᵢⱼ + b₂ᵢCTimeᵢⱼ² + εᵢⱼ
Yᵢⱼ = AMS-C scores log transformed in individual i at time j.
i = 1 . . . 308 (individuals)
j = 0 . . . 48 h (time)
b₀ᵢ = intercept of the individual change trajectory for individual i
b₁ᵢ = Instantaneous rate of change (akin to velocity) for individual i at
time point j
b₂ᵢ = accelearation/deceleration in change (rate of change in change
with increasing time) for individual i
Ctime = (Time − 20 h) time centered at 20 h
εᵢⱼ = random measurement error

### Derivation of Reduced Form of the Model:

Yᵢⱼ=b₀ᵢ+b₁ᵢCTimeᵢⱼ+b₂ᵢCTimeᵢⱼ²+εᵢⱼ

Substitute level 2 submodel into level 1 model:

Yᵢⱼ=β₀₀+β₀₁Altitudeᵢ+β₀₂Activityᵢ+β₀₃Sexᵢ+ζ₀ᵢ+[β₁₀β₁₁Altitudeᵢ+β₁₂Activityᵢ+β₁₃Sexᵢ+ζ₁ᵢ](CTimeᵢⱼ)+[β₂₀+β₂₁Altitudeᵢ+β₂₂Activityᵢ+β₂₃Sexᵢ+ζ₂ᵢ](Ctimeᵢⱼ)²+εᵢⱼ

Multiply out terms:

Yᵢⱼ=β₀₀+β₀₁Altitudeᵢ+β₀₂Activityᵢ+β₀₃Sexᵢ+ζ₀ᵢ+β₁₀CTimeᵢⱼ+β₁₁(Altitudeᵢ)(CTimeᵢⱼ)+β₁₂Activityᵢ(CTimeᵢⱼ)+β₁₃Sexᵢ(CTimeᵢⱼ)+ζ₁ᵢ(CTimeᵢⱼ)+β₂₀(Ctimeᵢⱼ)²+β₂₁Altitudeᵢ(Ctimeᵢⱼ)²+β₂₂Activityᵢ(Ctimeᵢⱼ)²+β₂₃Sexᵢ(Ctimeᵢⱼ)²+ζ₂ᵢ(Ctimeᵢⱼ)²+εᵢⱼ

Combine like terms into fixed and random effects:

Yᵢⱼ={β₀₀+β₀₁Altitudeᵢ+β₀₂Activityᵢ+β₀₃Sexᵢ+β₁₀CTimeᵢⱼ+β₁₁(Altitudeᵢ)(CTimeᵢⱼ)+β₁₂Activityᵢ(CTimeᵢⱼ)+β₁₃Sexᵢ(CTimeᵢⱼ)+β₂₀(CTimeᵢⱼ)²+β₂₁Altitudeᵢ(Ctimeᵢⱼ₎²+β₂₂Activityᵢ(Ctimeᵢⱼ₎²+β₂₃Sexᵢ(Ctimeᵢⱼ)²}+{ζ₀ᵢζ₁ᵢ(CTimeᵢⱼ)+ζ₂ᵢ(Ctimeᵢⱼ)²+εᵢⱼ}

TABLE 7
Interpretation of Slopes and Intercepts (Fixed Effects: (12))

| | |
|---|---|
| 1. | Intercept = β₀₀ = the intercept term denoting the model-implied value of AMS-C when |
| | Ctime = 0 (i.e., after 20 h of altitude exposure), altitude = 0 m, activity = 0 (low-active), and |
| | sex = 0 (female). |
| 2. | Ctime = β₁₀ = the main effect of the instantaneous rate of change in AMS-C when ctime = 0 |
| | altitude = 0 m, activity = 0 (low-active), and sex = 0 (female). This changes with time. |
| 3. | Ctime² = β₂₀ = the main effect of the curvature (acceleration/deceleration) in AMS-C when |
| | altitude = 0 m activity = 0 (low-active), and sex = 0 (female). This curvature does not change |
| | with time. The curve comes down as rapidly as it goes up. |
| 4. | Altitude = β₀₁ = the main effect of altitude denoting the model-implied shift in the magnitude |
| | of the intercept of the trajectory given a one-unit (1000 m) shift in altitude |
| 5. | Activity = β₀₂ = the main effect of activity denoting the model-implied shift in the magnitude of |
| | the intercept of the trajectory given a one-unit (0 to 1) shift in activity from low to high. |
| | Difference in intercepts for group 1 versus group 0. |
| 6. | Sex = β₀₃ = the main effect of sex denoting the model-implied shift in the magnitude of the |
| | intercept of the trajectory given a one-unit (0 to 1) shift in sex from female to male. |
| | Difference in intercept for group 1 versus group o. |
| 7. | Altitude * Ctime = β₁₁ = the interaction between ctime and altitude denoting the model-implied |
| | shift in the magnitude of the instantaneous rate of change in AMS-C given a one-unit shift |
| | (1000 m) in altitude. |
| 8. | Activity * Ctime = β₁₂ = the interaction between ctime and activity denoting the model- |
| | implied shift in the magnitude of the instantaneous rate of change given a one-unit shift (0 |
| | to 1) in activity from low to high. Difference in linear slopes between group 1 versus group 0. |
| 9. | Sex * Ctime = β₁₃ = the interaction between ctime and sex denoting the model-implied shift |
| | in the magnitude of the instantaneous rate of change given a one-unit shift (0 to 1) in sex |
| | (female to male). Difference in linear slopes between group 1 versus group 0. |
| 10. | Altitude * Ctime² = β₂₁ = the interaction between ctime² and altitude denoting the model- |
| | implied shift in the magnitude of the acceleration or deceleration in AMS-C given a one-unit |
| | shift (1000 m) in altitude. |
| 11. | Activity * Ctime² = β₂₂ = the interaction between ctime² and activity denoting the model- |
| | implied shift in the magnitude of the acceleration/deceleration given a one-unit shift (0 to 1) |
| | in activity from low to high. Difference in acceleration between group 1 and group 0 |
| 12. | Sex * Ctime² = β₂₃ = the interaction between ctime² and sex denoting the model-implied shift |
| | in the magnitude of the acceleration/deceleration given a one-unit shift (0 to 1) in sex |
| | (female to male). Difference in slopes between group 1 and group 0. |

TABLE 8
Random effects (4):

Level 1:
σ²_{ε} = within person variance (summarizes the scatter of each person's
data around his or her own change trajectory)
Level 2:
σ²₀ = variance of the intercepts controlling for the effects of altitude,
activity, and sex (summarizes between-person variability in intercept)
σ²₁ = variance of the linear terms controlling for the effects of altitude,
activity and sex (summarizes between-person variability in instantaneous
rate of change)
σ²₂ = variance of the quadratic term controlling for the effects of altitude,
activity, and sex (summarizes between-person variability in the curvature
of change (acceleration/deceleration)

TABLE 9
Goodness of Fit Statistics:

[symbol]

= correleation between actual and predicted scores squared
AIC = Akaike Information Criteria (lower the better)
Interpretations for Table 8 are similar but predict % of people with
AMS in AMS prevalence model and % of people with mild, moderate,
and severe AMS with AMS grade of severity model. Altitude * Ctime²
and Activity * Ctime² were not significant in these models.

### Level of Experimentation in Developing AMS Models:

The AMS-scores were not normally distributed. The data contained a lot of zeros and was skewed. Accordingly, the data was log-transformed to get a normal distribution of AMS-C scores. To prevent zero scores all AMS-C scores zero scores were randomly assigned a value between 0 and 0.15.

Individual plots were inspected to determine whether a linear, quadratic or cubic time term was needed in the model. It was determined that a quadratic term was best. Model selection was developed with many parameters that were eliminated iteratively from the model using the AIC criteria and significance (P<0.10). Standardized residuals ≦3 are considered acceptable for outliers.

For instance, the first model contained the altitude, ctime, ctime², sex, physical activity, age, ht, wt, bmi, race, and smoking status as well as interactions between all of these factors. Maximum likelihood was used as the estimation method for parameter estimates.

The correlation between repeated measures was accounted for using individual random coefficients for each individual and this was an unstructured covariance structure. If we used a repeated measurements approach a spatial power covariance structure would be used.

It should be understood that additional predictors may be added to the models and still be considered within the scope of this invention, including but not limited to: different acclimatization status, physiologic variables such as heart rate, blood pressure, ventilation, cardiac output, hematologic variables such as hemoglobin, hematocrit, lactate, osmolality, and hydration status and aerobic fitness.

### Physical Performance Capability Assessment Module

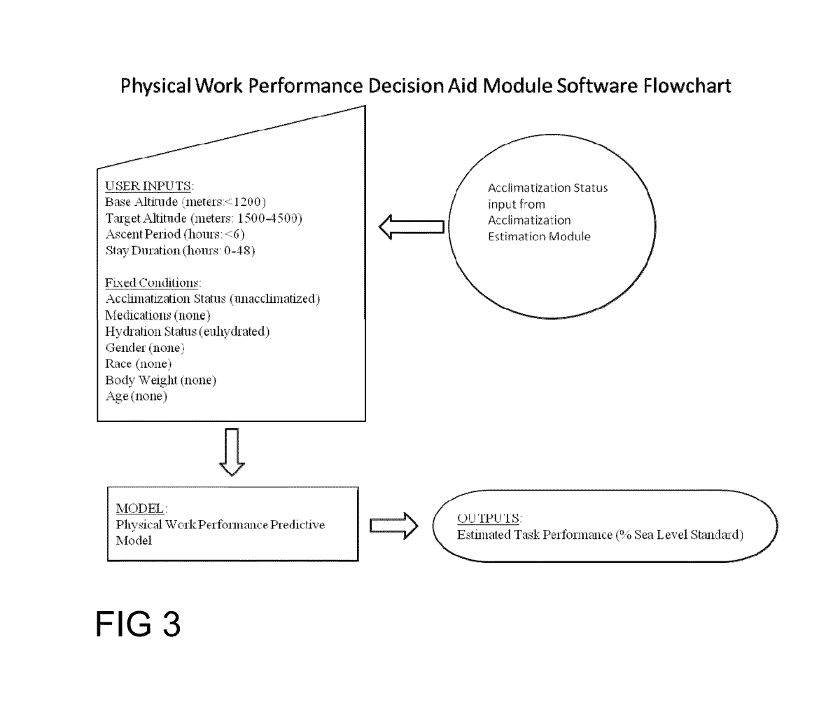

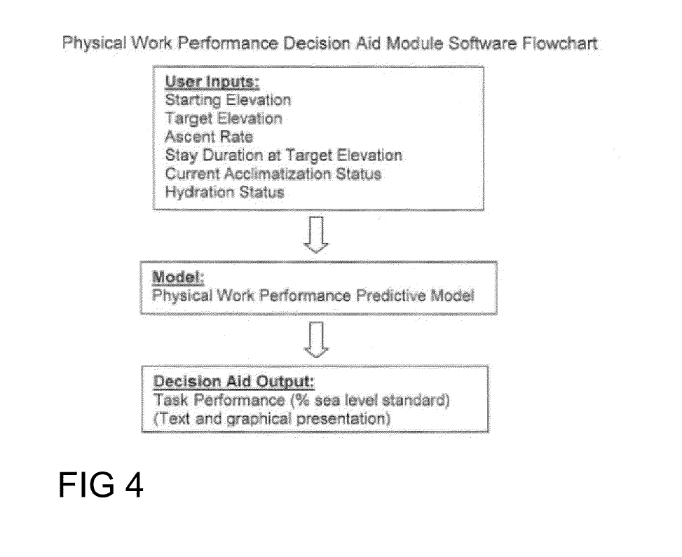

In various aspects of this invention, the Physical Performance Capability Assessment Module or Physical Work Performance Assessment Module as it is otherwise known provides an estimate of the decrement in physical work performance for selected tasks as a function of target altitude and acclimatization status. Flowcharts describing alternate embodiments of the logical process of the Physical performance Capability Assessment Module are disclosed in FIGS. 3 and 4.

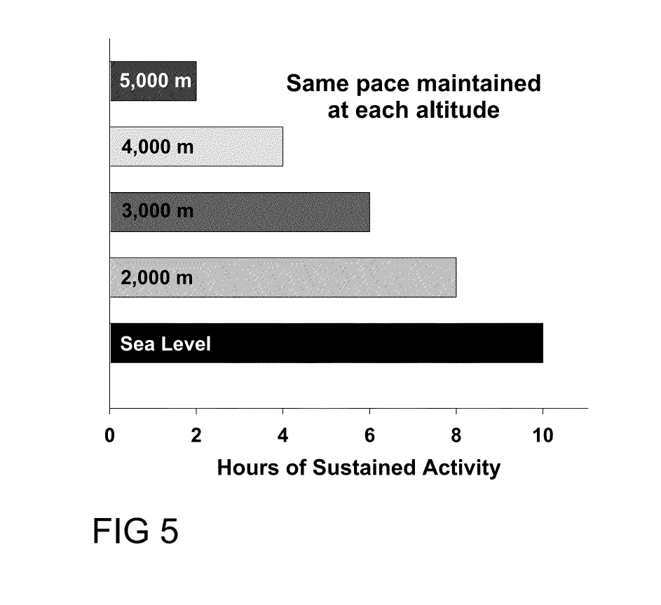

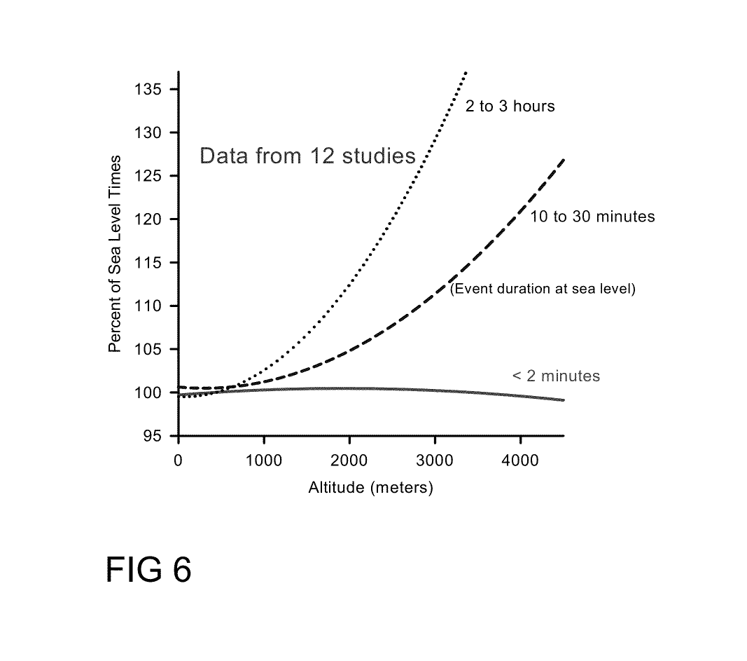

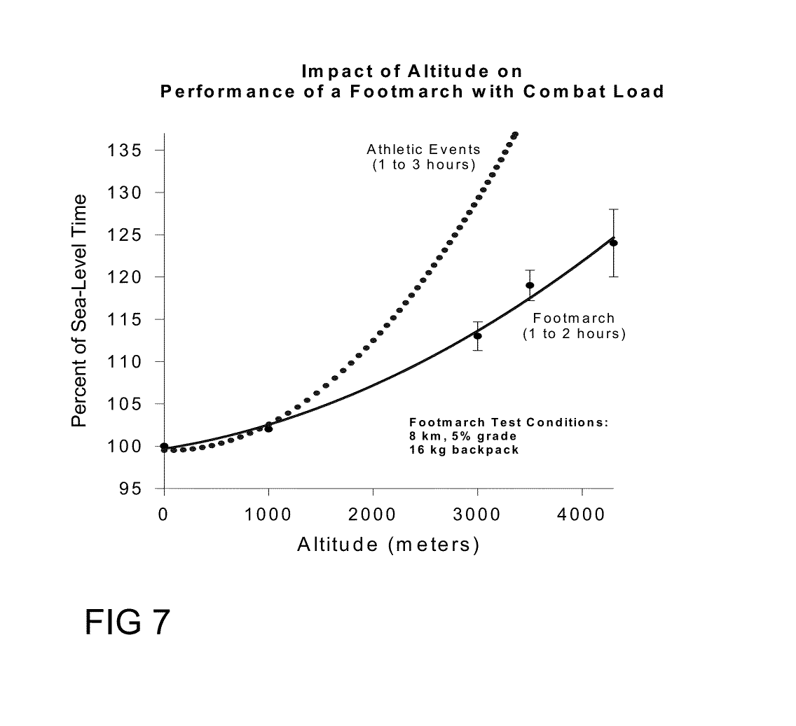

Physical performance is decremented with increasing altitude. Approaches to quantifying impact of altitude on physical performance include: Fixed Pace Work (duration to exhaustion) and Fixed Relative Intensity (% VO2Max) Work (duration to complete task). One aspect of this invention is at least one predictive model of physical performance at altitude developed by analyzing the impact of increasing altitude on Fixed Pace Performance (see FIG. 5). In an alternate embodiment of the invention, the predictive model of physical performance at altitude is based on analyzing the impact of increasing altitude on Fixed Relative Intensity (% VO2max) Performance (see FIG. 6) Here we see a meta-analysis of published athletic event results at different altitudes. This data could also be derived from specific task performance at altitude assessment, for instance under specified task test conditions such as an 8KM foot march, on a %5 grade with a 16 kg backpack (see FIG. 7).

The Physical Performance Capability Assessment Module estimates outcomes from current status, buy taking in a set of inputs including but not limited to: starting elevation, target elevation, ascent rate, duration at target elevation, gender, acclimatization status, work intensity and work duration, medication, task performance metric, and sea-level performance metrics. Using the developed predictive models described above, the module produces outputs, including but not limited to: AMS probability, AMS severity-stratified and Task Performance at sea level.

In certain embodiments, the Physical Performance Capability Assessment Module is a simple linear multiple regression model with % decrease in performance (continuous variable) from sea-level to altitude as the dependent variable and altitude as the predictor as well as sea level aerobic fitness and other physiologic variables. The performance measure is only made at one time point so we don't need a random coefficient model. The percentage decrease in performance need to be transformed to fit an exponential function given that the percentage decrease is not linear. Ascent rate is accounted for in all our models because our database contains data that defines the number of hours of exposure. We use a common time trial task that is to be completed by the subject as quickly as possible. The work rate may differ depending on the motivation of the subjects but it is a reliable measure of performance. The subjects are controlled for medication. Sea level performance is always measured prior to task performance to determine a baseline in order to calculate the percentage decrement in performance at altitude.

### Altitude Acclimatization Assessment Module

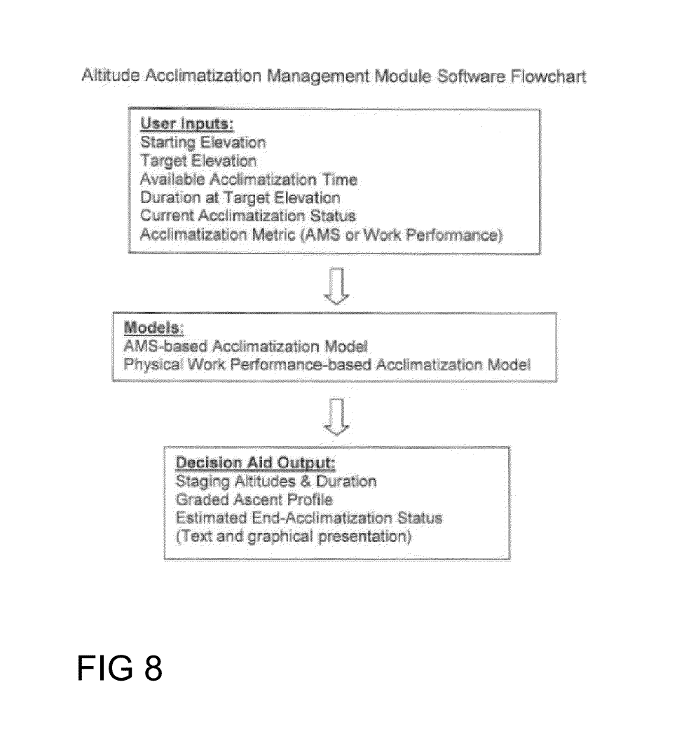

In various embodiments of the invention, the Altitude Acclimatization Assessment Module provides an estimate of current altitude acclimatization status and recommended ascent profiles to induce altitude acclimatization to a target or operational altitude. Additionally, since altitude acclimatization status is outcome-metric dependent, that is, since the status can be expressed in terms of decreased risk of altitude illness and or improved physical work performance, the acclimatization metrics will be user determined. In one embodiment of the invention, the module accepts user determined recommendations for inducing altitude acclimatization using either staged or graded assent profiles as depicted in the logical flow presented in FIG. 8.

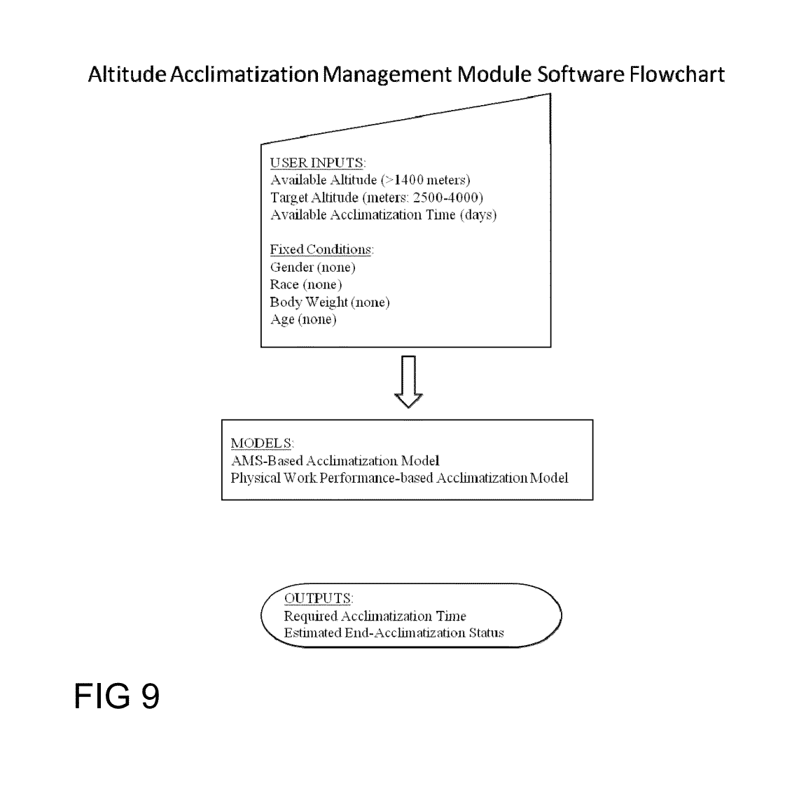

In various embodiments of the present invention, user requested estimates of current altitude acclimatization status will follow the logic disclosed in the flowchart illustrated in FIG. 9, producing outputs such as required acclimatization time and estimated end-acclimatization status, for example.

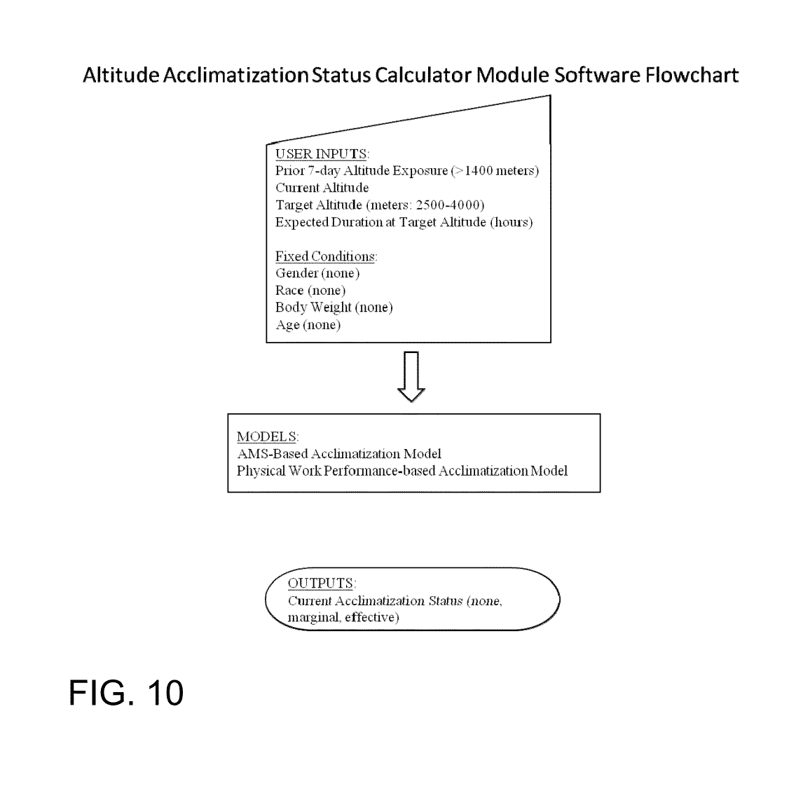

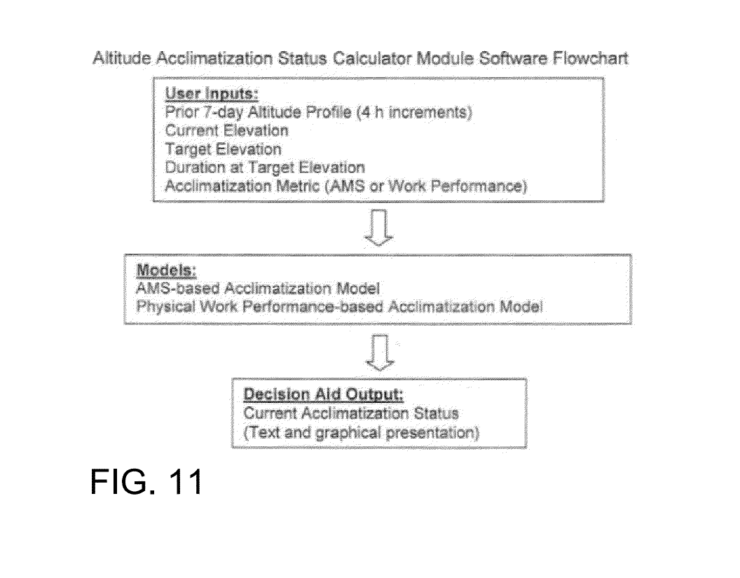

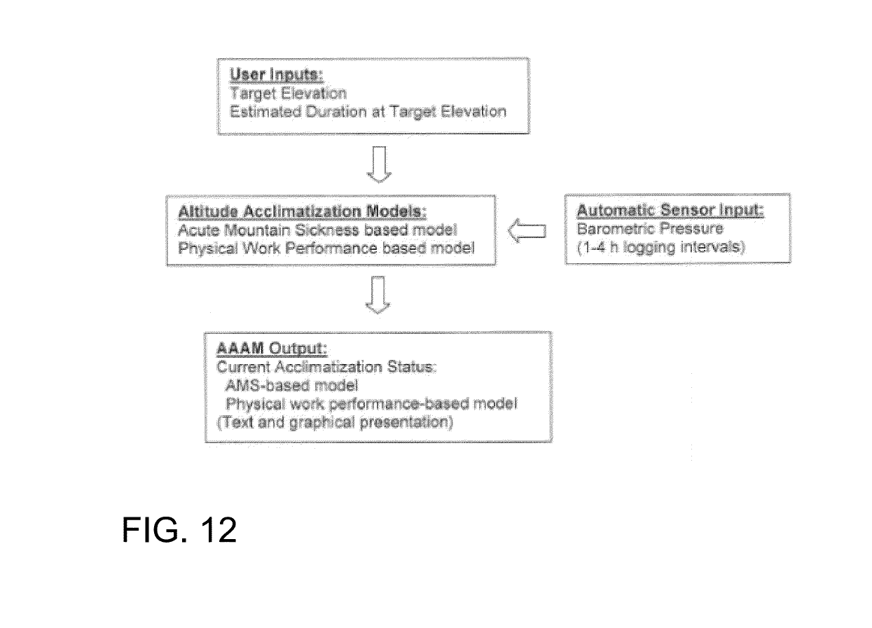

In various embodiments of the present invention, user requested estimates of current altitude acclimatization status will follow the logic disclosed in the flowchart illustrated in FIG. 10, producing outputs such as current acclimatization status, for example. In an alternate embodiment of the Altitude Acclimatization Status Calculator Module, varying user input parameters are processed by the AMS-based Acclimatization Model and Physical Work Performance-based Acclimatization Model of this invention to produce and display current acclimatization status in both text and graphical form (see FIG. 11). In yet another alternate embodiment of the Altitude Acclimatization Status Calculator Module, automatic sensor input (for example, barometric pressure taking a various logging intervals) is used to inform the Altitude Acclimatization Models of this invention to produce and display current acclimatization status in both textual and graphical forms (See FIG. 12).

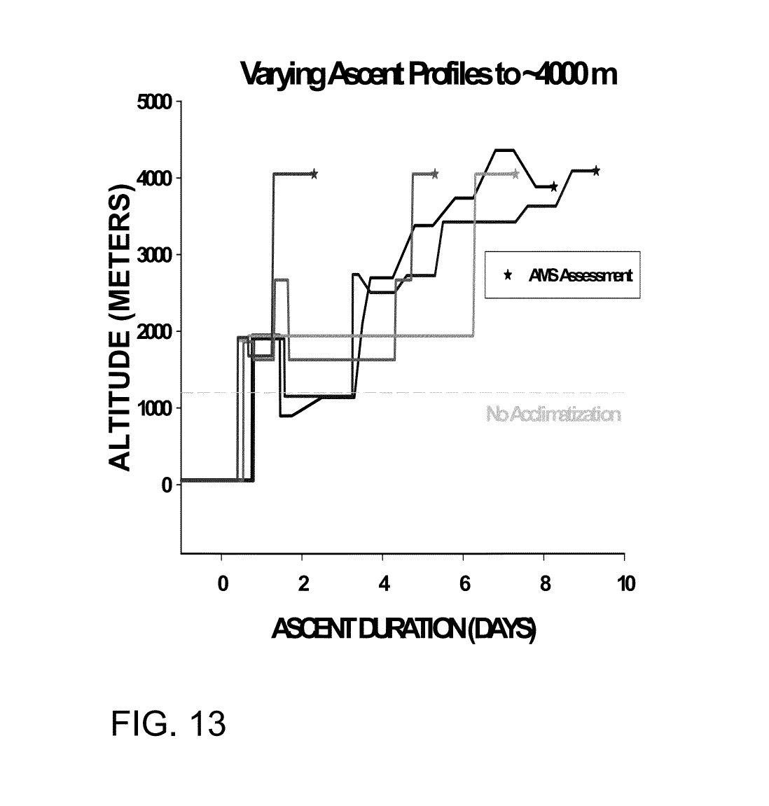

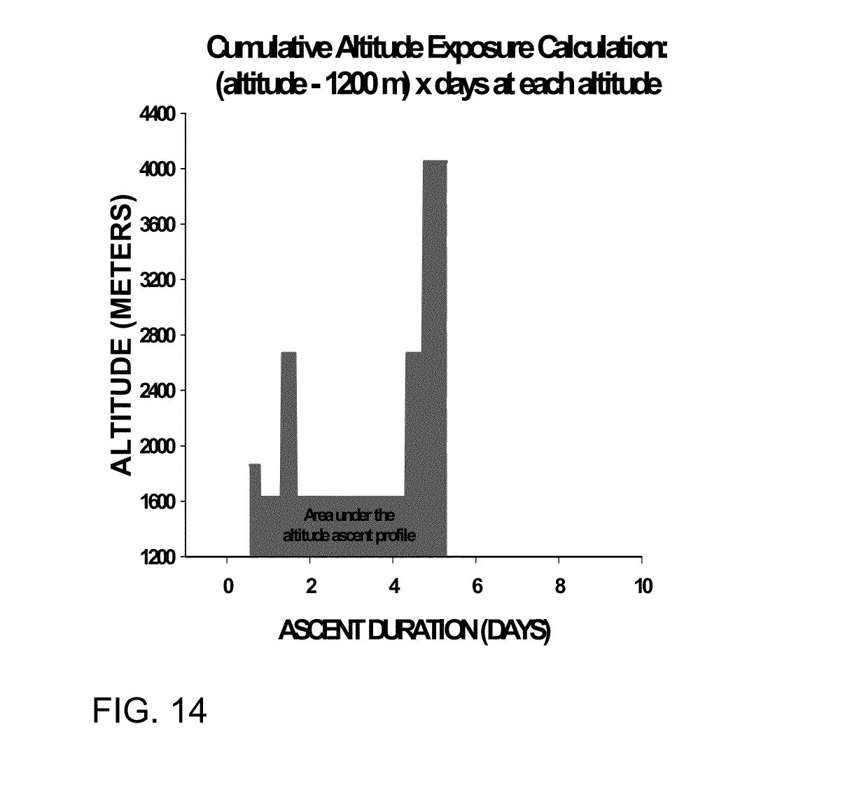

This invention addresses the problem of assessing individual acclimation given varying individual ascent profiles. As disclosed as part of this invention, the solution is to calculate a cumulative altitude exposure for each ascent profile (integrate area under the curve). See FIGS. 13-14.

Degree of altitude acclimatization is measured against a reference altitude. There are multiple outcome metrics to quantify altitude acclimatization including: prevalence & severity of AMS, physical performance, sleep quality and quantity, arterial oxygen levels, heart rate.

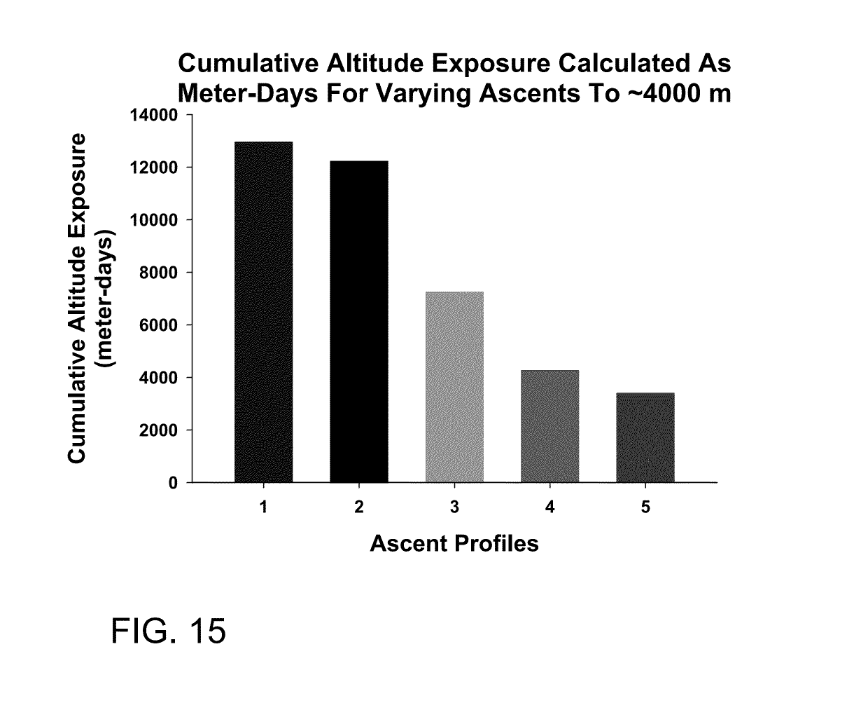

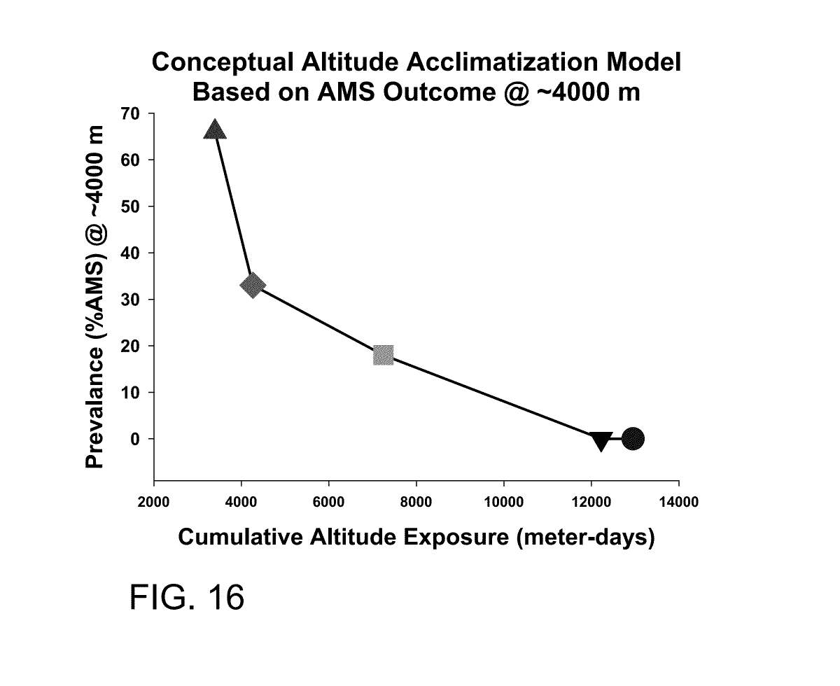

In one embodiment of this invention the relationship between cumulative altitude exposure and acclimatization (AMS) is determined and a prevalence of AMS is calculated at a given altitude—see FIGS. 15 and 16. A simple measurement of altitude exposure (barometric pressure and duration) can be used to estimate individual altitude acclimatization status for a target altitude and outcome metric (e.g., AMS, work performance).

The altitude acclimatization module recommends acclimatization strategies and records and calculates altitude acclimatization status using a data set of measurements, including but not limited to starting elevation, target elevation, available acclimatization time, duration at target elevation and current acclimatization status. Using the developed predictive models described above, the module produces outputs, including but not limited to: staging altitudes (duration) and graded ascent profiles.

The altitude acclimatization status model will use the presence or absence of AMS (binary variable) as the dependent variable and meter hours of altitude exposure above a predetermined altitude (for example 1200m) as the dependent variable (continuous variable). Meter hours of altitude exposure will be calculated during an ascent in the field as (for example, 24 h at 3500 m and 10 h at 4500 m) as (24 h*3500−1200)+(10 h*4500−1200) for a total of 55,200+33,000=88,200 meter hours. This is a novel development to calculate acclimatization status. We may calculate as meter days or km hours but that is simply a transformation of the variable. We may also use factors such as, for example: age, gender, bmi, smoking status, and all physiologic and hematologic variables as predictors.

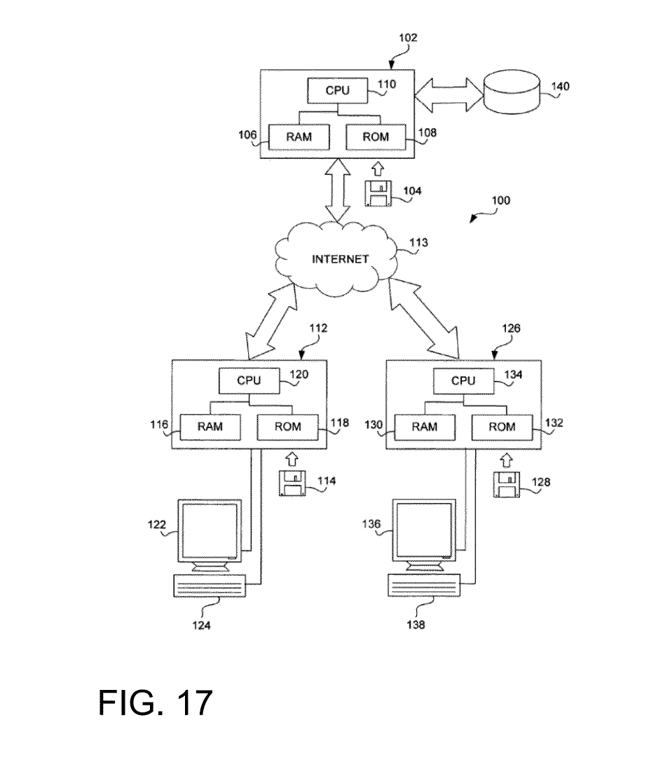

Some configurations of the present invention and referring to FIG. 17, a computer network 100 is configured for providing decision support. The computer network 100 is useful in many varied contexts in which statistical regression models can be used to predict outcomes. To provide decision support, some configurations of the present invention are configured to generate outputs, including graphical outputs and patient reports that incorporate such outputs.

In some configurations, computer network 100 comprises a server computer room 102 that executes a server module. The server module comprises software instructions recorded on a machine-readable medium or media 104. Machine-readable medium or media may compromise, for example, one or more floppy diskette's, CD-ROMs, CD-RWs, DVDs, DVD-Rs, DVD-RWs, memory devices such a USB memory sticks or other types of memory cards, internal readable and writable memory 106 of any of various kinds, such as internal or external RAM, read only memory (ROM) 108 of any of various kinds, hard disks optical drives, and combinations thereof. As used herein, “media” includes not only “removable” media, but also “non-removable” media such as primary and secondary storage. For example, RAM, ROM, and hard disk drives are included as “media,” as well as the aforementioned types of media. Server computer 102 can include devices for reading removable media, such as CD-ROM drives, a DVD drive, a floppy disk drive, etc. In many configurations, server computer 102 will comprise at least a readable and writable memory 106, read-only memory 108 or non-volatile memory of a suitable type, and a processor 110 (e.g., a central processing unit or CPU) which may itself comprise one or more microprocessor, co-processors, etc. Thus, the term, “processor,” as used herein, is not literally restricted to a single CPU. Moreover, server computer 102 may itself comprise a network of one or more computers, as can any other device referred to as a “computer” herein.

Computer network 100 further comprises one or more first client computers 112. In many configurations, it is in communication with the server computer 102 via a network 113, for example, the Internet. In many configurations of the present invention, client computer 112 comprises a first client module comprising software instructions recorded on the machine-readable medium or media 114. In many configurations, client computer 112 further comprises at least a readable and writable memory 116, read-only memory 118, and a processor 120 that may itself comprise one or more microprocessors, coprocessors, etc. First client computer 112 may itself comprise one or more computers in a network. First client computer 112 further may comprise a first user display device 122, such as a CRT display, LCD display, plasma display, and/or a hardcopy device such as a printer. First client computer 112 may also comprise a first user input device 124, such as a keyboard, a mouse, a touchscreen (which may be part of the display 122), and/or a trackball, etc. First client computer 112 is not limited to desktop or laptop computers that can include any computing device that can communicate over a network. For example, in some configurations, a first client computer 112 can be a digital assistant (PDA) or a wireless telephone with a display screen, or other “smart phone” type devices.

Computer network 100 further comprises one or more second client computers 126. In many configurations, second client computer 126 is in communication with server computer 102 via network 113. Also in many configurations, second client computer 126 comprises a second client module comprising software instructions recorded on a machine-readable medium or media 128. In many configurations, second client computer 126 further comprises at least a readable and writable memory 130, and a processor 134 that may itself comprise one or more microprocessors, coprocessors, etc. Second client computer 126 may itself comprise one or more computers in a network. Second client computer 126 further comprises a second user display device 136, such as a CRT display, LCD display, plasma display, and/or a hardcopy device such as a printer. Second client computer 126 also comprises a second user input device 138, such as a keyboard, a mouse, a touchscreen (which may be part of the display 136), and/or a trackball, etc.

As used herein, software instructions are said to “instruct the computer to display” information even if such information is communicated via a network to another computer for display on a remote display terminal. In this sense code running on a Web server instructs a processor executing that coed to “display” a webpage, even though the code actually instructs the processor to communicate data via a network that allows a browser program to instruct in other computer to construct the display of the webpage on the display of the other computer. For example, the server module described in the examples presented herein can include a Web server and the client modules can comprise Web browsers. Also, in some configurations, client computers 112 and 126 comprise laptop, desktop, or mobile computing devices or communication terminals. The broader scope of the phrase “instruct the computer to display” is used because server computer 102 and the one or more client computers 112, 126 need not necessarily be different computers. For example, communication protocols known in the art allows server software module and a client software module running on multitasking computer systems to communicate with one another on the same computer system, and the same server software module can also communicate with a client software module running on a different computer via a network connection.

The terms “display” and “accept” as used in the description herein referred to a suitably programmed computing apparatus “displaying” or “accepting” data, not to a person “displaying” or “accepting” something. A person might, however view the display data on an output device on a page produced by an output device or supplied except the data using an input device.

In some configurations of the present invention, a method is provided to provide decision support via software that comprises the server module. Some configurations of the present invention provide server modules that utilize that ASP.NET platform available from Microsoft Corporation, Redmond, Wash. As well as and as Internet information services (IIS) and MSSQL server from Microsoft Corporation for Web services and data storage, respectively. A multitier system architecture provided in some configurations enables scaling of server module components as needed to meet specific demands of a particular deployment. In addition a modular design framework is provided in some configurations to facilitate extensibility and incorporation of new functionality via custom modules. In some configurations, the server module is written in C++ or C#; except for its SQL data access components which are stored procedures written in SQL. Configurations of the present invention are not limited to implementation using the tools described above. For example, configurations of present invention can run on the LINUX operating system and be built using a different suite of applications. The selection of an appropriate operating system and suite of applications can be left as a design choice to one of ordinary skill in the art after such person gains an understanding of the present invention from the present description.

Although the flow charts provided herein are illustrative of configurations methods used herein, it will be understood that the order of the steps shown to be buried from the order illustrated in other configurations of the present invention, that steps illustrated as being separate can be combined (e.g., various displays and request for data can be combined into a single output screen), and that not all steps illustrated are necessarily required in all configurations.

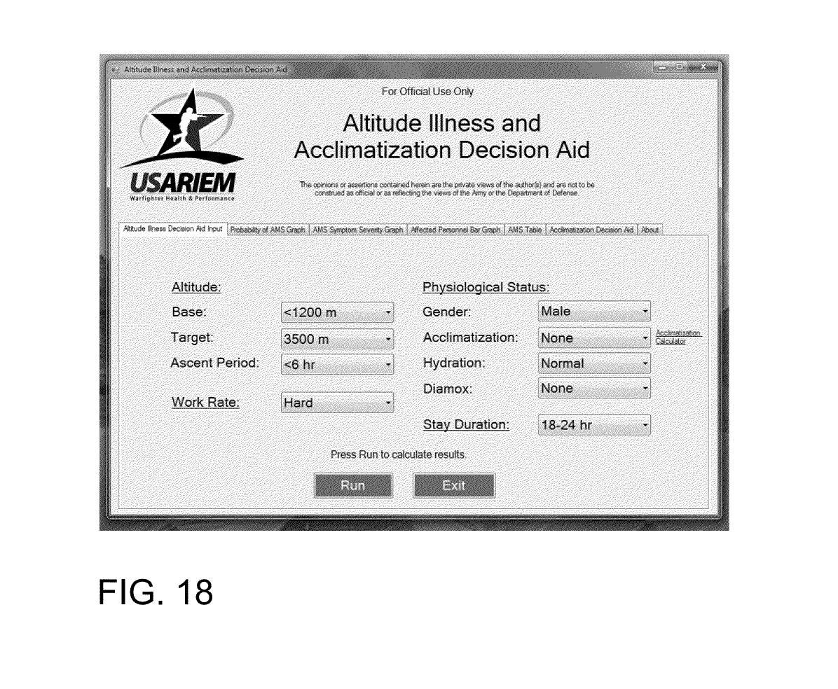

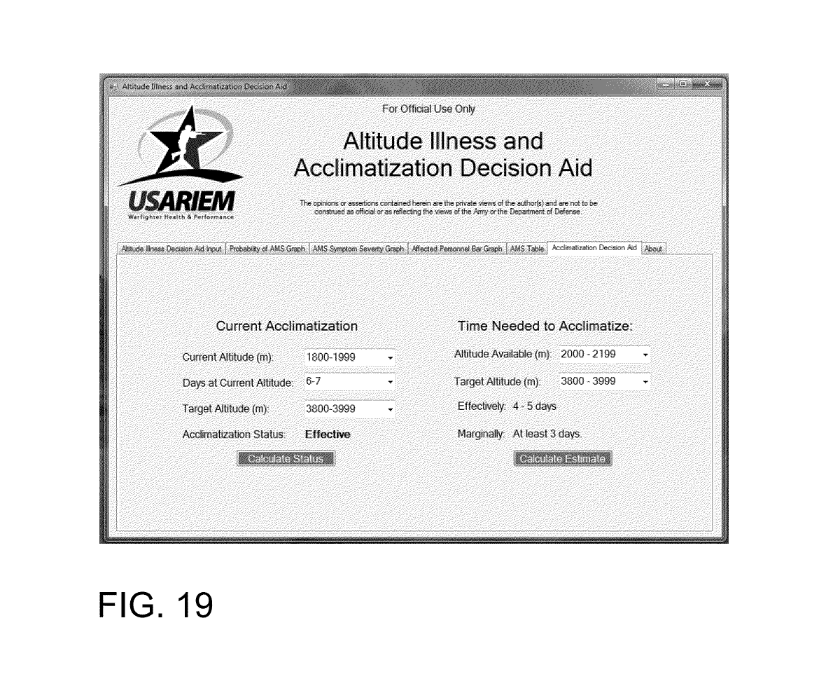

The technical effect of the present invention is achieved first by user logging in with the appropriate credentials. Server module instructs processor 110 to display a visual selection of input parameters, for example, on a user display device 122. An example of such a display shown in FIGS. 18 and 19 and may comprise a Graphical User Interface (GUI). In some configurations, access to these features is available only to those with administrative rights.

In some configurations, the GUI includes standard GUI elements such as windows, dialog boxes, menus, drop-down lists, radio-buttons, check boxes, icons, etc.; and the module provides functionality to define and express parameter input and output display options, such as mouse movements and mouse clicks. User interaction with the interface is achieved by one or more methods that may include, for example, pointing and clicking with the mouse, touchpad, or other input device, or typing on a keyboard, or speaking into a microphone and using voice command recognition software. In some configurations, models, normative data, parameter inputs, display options, etc. (comprehensively referenced herein as Data) are imported, either in part or in their entirety, from all-text representations, examples of which include, but are not limited to, XML-based documents. Some configurations allow imported Data to be edited and modified, stored in a memory of the server computer or elsewhere, and/or re-exported in their original formats and/or other formats.

A general regression model framework is used in some configurations were expressing predictions. The model types can include, for example, linear, generalized linear, cumulative multinomial, generalized multinomial and proportional hazard models. Model types may be defined in terms of a coefficient vector and an optimal covariance matrix for calculating confidence intervals.

Next, instructions in the server module instructor processor 110 to request one or more regression model parameters, and, in appropriate cases, limits and/or lists of possible input values. An example of possible limit is a range from 0 to 120, which might, for example, be a limiting range appropriate for an “age” parameter name, and an example of a list of possible input values is “Male, Female” for a “Sex” parameter name. The parameter types and lists of possible input values can be used to select appropriate input formats when the model is used (e.g., a drop-down list for a parameter name having an associated list).

In some configurations, the request for model parameters is sent via an XML Web service for programmatic access. In configurations in which the request is sent via an XML Web service, the request is not necessarily “displayed” as such.

In some configurations, coefficient values are obtained by instructions to processor 110 to run a regression analysis on data obtained from a database 140, which may be a local database stored in a computer 104 or a database accessible via network such as network 113. A list comprising the outcome, associated coefficients and accepted names, types, and/or limits for variables are stored in a memory (e.g., memory 106, a secondary storage unit, or even a register of the processor, of server computer 106 for later use at step. (The term “later use” is intended to be interpreted broadly and can include, for example, use as part of the running of a stored model at a later date, use as part of a self-contained PDA version of the application, or use by a non-registered user who approached the application through the web to do a “one-off” run of a model.) Some configurations also update β-weights and covariance matrices that are stored for the model.

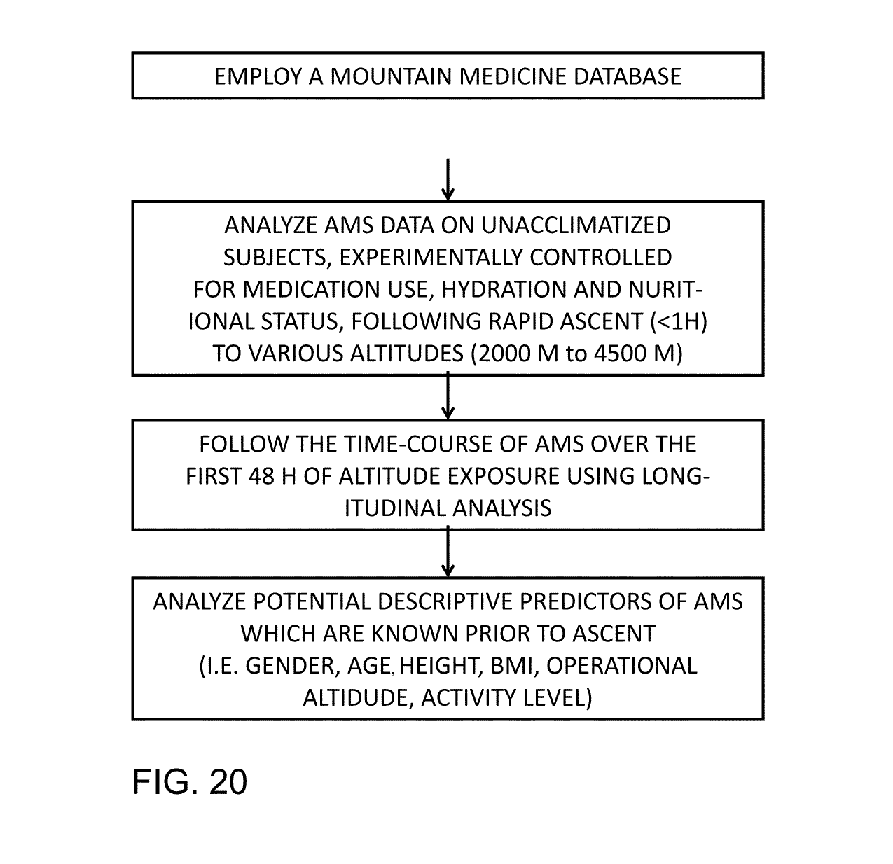

In some configurations, the procedure represented by flow chart shown in FIG. 20 (or by variations thereof such as those described herein) represents the input of a regression model specification for a specific treatment at a specific outcome. The procedure represented by flowchart in FIG. 20 (or its variations) can be repeated to add further regression model specifications representing different combinations of variables for different procedures, such as medical or surgical procedures. Some configurations further allow the editing and/or deletion of stored models. The parameters of regression model specifications are also referred to herein as variables and/or functions of variables, such as in regard steps in which values to variables or functions of variables are assigned.

Referring back to FIG. 17, at least one server module also contains instructions configured to instruct processor 110 to allow a user (usually, but not necessarily different from the user at first client computer 112) at second client computer 126 to log into the server module. The user at second client computer 126 is able select one or more of the stored regression model specifications, input data for the stored models, run a regression analysis that can be presented with results of the regression analysis are analyses.

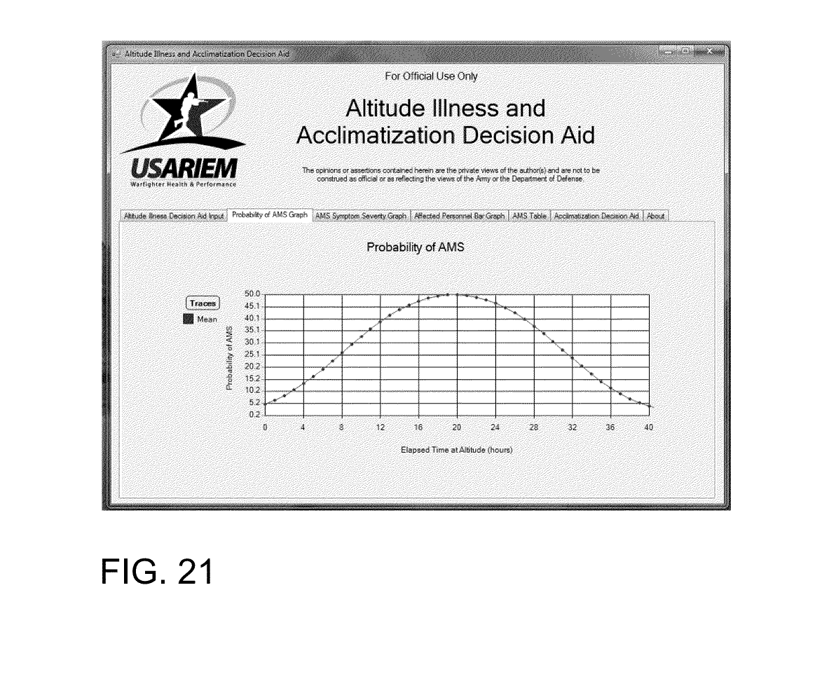

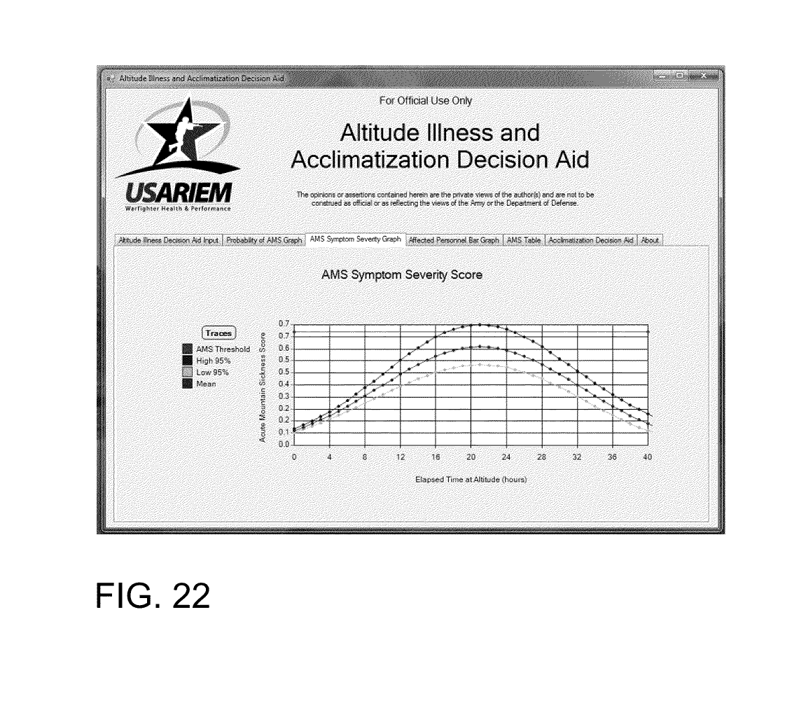

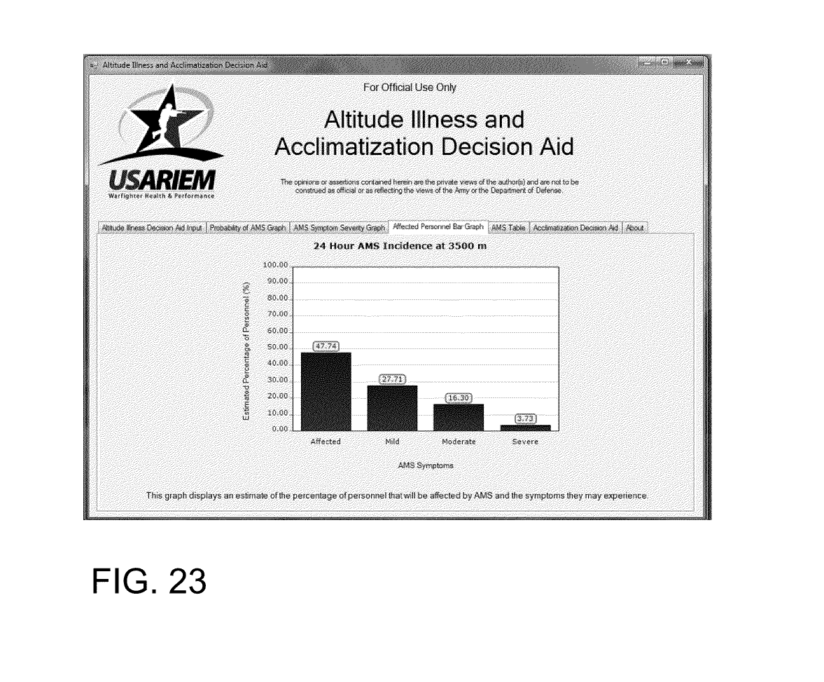

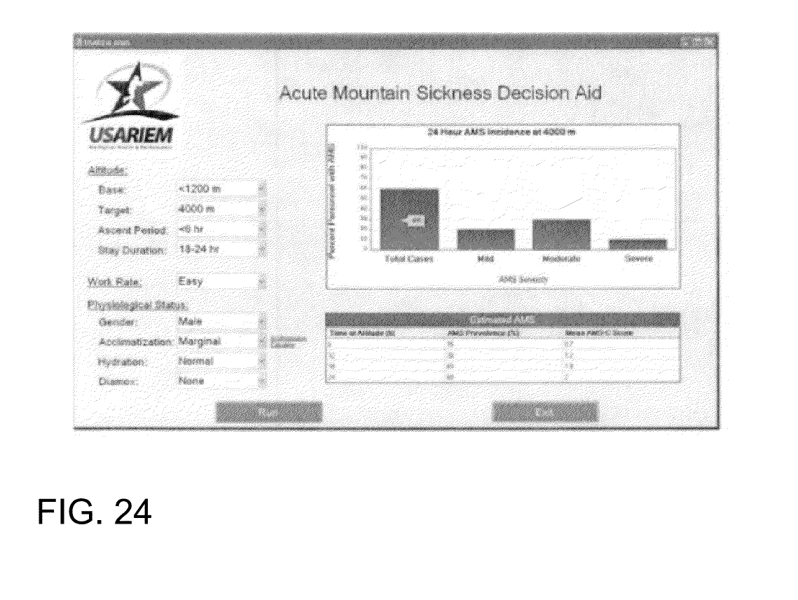

The server module accepts the collected Data (which may also include an identification of a person or object to which the variables apply) and runs the selected regression model specifications. The results of the selected regression model specifications are displayed. An example of such a display shown in FIGS. 21-24. The displayed results can also include a representation of a statistical range, such as a visual representation in some configurations. Also in some configurations, and referring again to FIG. 17, processor 110 is instructed to use customizable content for example, letterhead data), previously stored in a memory or database accessible to processor 110 and optionally including return addresses, logos etc. to print the results or to cause the results to be printed.

Main effects and interaction terms derived from input parameters and their transformations can be derived in some configurations of the present invention, and regression coefficients for calculating point estimates for outcome of interest and optional covariance estimates can be provided for computing confidence intervals.

Once regression model specifications have been built and deployed, healthcare providers (or, in other environments, other individuals) can readily access them through an integrated and customizable portal interface using a variety of web-enabled devices. Dynamically generated data and free screens are provided based on the variables required by the selected models.

Some configurations of the present invention render model outputs in a variety of graphical and non-graphical formats, including solid bar plots, gradient bar plots, whisker line plots, high charts, and/or digital LED-style displays, which can be user-selectable. Output from multiple models can be grouped onto a single plot to facilitate inter-model comparison. In addition, some configurations allow a user to customize the output plot style, the selection of models to include a final output and the display of confidence intervals (when model covariance data has been provided). In various configurations, users can print outcome plots using customizable report templates in order to generate documents such as educational materials and informed consent sheets. Also in some configurations, outcomes researchers can customized report and page content using a built-in Microsoft Word®-like interface or by editing HTML code. A feature-rich set of portal content modules, including work-group directories, discussion threads, and document repositories Be provided in server module configurations of the present invention to allow outcomes research groups to easily create, manage, and build their own collaborative websites.

It will thus be appreciated that configurations of the present invention can be used to handle various aspects of data collection, validation, storage/retrieval, and processing, thereby freeing outcomes researchers from intricacies of programming and networking.

While the invention has been described in terms of various specific embodiments, those skilled in the art will recognize that the invention can be practiced with modifications within the spirit and scope of the claims.

The principles described below may be generally followed to produce analogous results in any field of healthcare for any disease or condition.

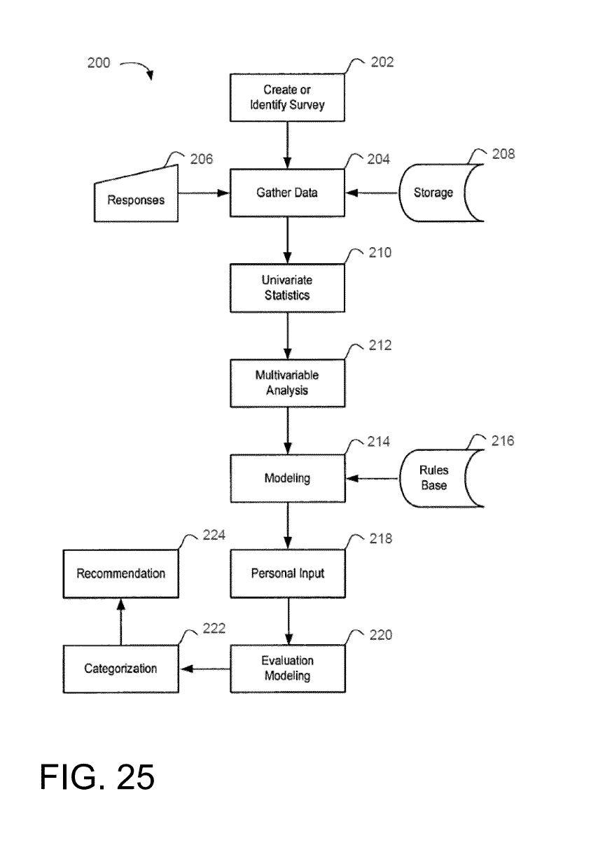

Turning now to FIG. 25 illustrating the general process 200 for practicing the aforementioned concepts. The process 200 may be implemented through the use of program instructions on a single computer, in a distributed processing environment, or with human intervention at respective illustrated steps. Step 202 entails the creation or identification of a survey designed to procure medically relevant information, such as health status information, assessments of AMS (e.g., ESQ-III Surveys) and possibly other information that may overlap with medical information, such as demographic information and clinical information. As a particular example of medical information, health status information means information that focuses upon the disease or medical condition as measured by symptomology, physical effects, or mental effects of the disease. The health status information may also monitor the effects of treatment. In these contexts, demographic data means descriptive information that could be used to characterize reclassify a person in a statistical meaningful way, for example, age, smoking habits, income, geographic location, race, gender, military service, or drinking habits. Clinical information may include medical history information about the person or diagnostic test results from that person.

Particularly useful clinical information includes the identification of adverse outcomes, which are defined as medical events that people normally wish to avoid. Adverse outcomes may include, for example, hospitalizations, death, onset of illness, and surgery. The clinical data may also include positive outcomes, such as survival, remission, or the effectiveness of a class of therapeutic modality in treating the disease.

A variety of health status questionnaires are available and generally known to medical practitioners. Many of these questionnaires have been validated by direct or indirect means to show that patient responses to the questionnaires bear some resemblance in describing a present disease state or mental condition. The severity of AMS, for example, may determined from information gathered using the Environmental Symptoms Questionnaire (ESQ-III) (22, 23) or shortened version of the ESQ-III (24)—See Table 10.

Pre-existing questionnaires may be selected for use as the survey in step 202. This manner of selection accelerates the time required for completion of step 202. Alternatively, it is not necessary to use health status questionnaires, and any medical information may be applied for these purposes it, e.g., laboratory test results, such as blood work, biopsy, endocrine tests; genetic tests, such as Microarray testing for variety diseases or conditions; health screening tests; cancer tests; and physical examination findings. Different questionnaires can be used. It would represent a different dependent outcome variable (LLS score instead of AMS-C score). You would use the same models (i.e, random coefficient model) but the significant terms in the model may be different. It may lead to different predictors, all of which are within the scope of this invention.

A survey may be created in step 202 using research that identifies conditions, results, symptoms and/or descriptions of the medical disease or condition. This research is preferably completed by a medical expert as to the disease or medical condition. Questions may be prepared to present survey respondents with a variety of selectable options that are each assigned a score on a relative scale that indicates the relative severity of the disease or medical condition. The overall survey may be scored on the basis of accumulated scores from some or all answers to the questions. The questions may be scored on the basis of the overall score or subsets of questions addressing domains or categories of disease symptomatology, frequency of symptomatology, quality-of-life, and satisfaction with treatment. The creation of surveys for purposes of using them according to the various instrumentalities and embodiments of the invention does not fundamentally differ from traditional techniques of producing these surveys or questionnaires.

In step 204, the survey that is created or identified in step 202 may be administered to a test study group of persons who provide responses 206. Administration may occur by using written or electronic instrumentalities. Additional data including clinical or demographic data may optionally be obtained from additional responses 206 or from electronic data storage 208, such as the database of a health insurance company, medical informatics company, medical hospital, or government agency.

The data-gathering step 204 may proceed over a period of time, such that the survey responses 206 may continually updated throughout this period, with the initial response forming a baseline. The survey responses are scored by suitable scoring system, and the data is subjected to statistical processing steps in steps 210 and 212. Univariate statistics may be calculated in step 210 to identify potentially significant predictors of future health states. The statistical results may, for example, relate health status information from the responses 206 to adverse outcomes and/or positive outcomes in clinical data. The medical information may be used to stratify the outcomes into ranges. Still further, the statistical information may be related to outcomes over a period of time.

Demographic data and clinical data may be used to correct outcomes for factors that are not directly related to the medical condition that is the focus of the medical information survey, such as by correcting overall mortality in a study. In step 214, the results of statistical calculations from steps 210 and 212 may be subjected to expert review, for example, review by medical and statistical experts in the field. The lessons gleaned from this review may be represented by program logic in stored in a rules base 216. Statistical correlations or algorithms may also be created for use in prognostic modeling. The results of step 216 may produce an inverted statistical model rules that may be used to assess probabilities of outcomes on the basis of medical information.

In step 218, a person (such as a patient or other individual) may be administered a questionnaire that is identical, or at least statistically identical, to the survey that was created or identified in step 202 (see Table 10). Additional surveys may be administered or other data sources may be used to obtain, as completely as possible from the person, an identical set of data in comparison to the data that was gathered from individuals in the test study group in step 204. Step 220 may include submitting the personal input data from step 218 for processing through the inverted model derived from step 214. The result of the evaluation modeling step 220 may be to assess the probabilities of outcomes on the basis of the persons medical information. The results from step 220 may be characterized in step 222, e.g., by the use of the limiting values or rules-based score groupings, to select persons who are at a relatively greater or lower risk of having a particular outcome. In step 224, a recommendation may be generated, for example, that the person seek out a physician for treatment, or that the person may wish to consider one medical procedure over another, or the information may be used to inform decision makers and mission planners regarding high altitude operations.

### Example 1

### Disease Management Program

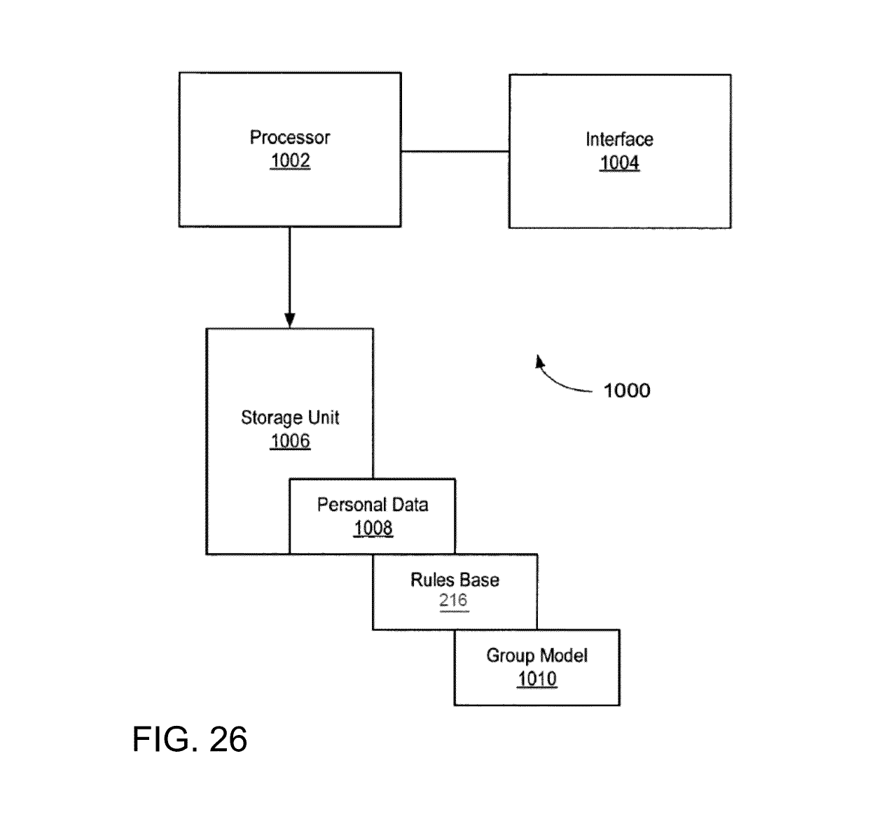

By way of example, FIG. 26 shows a medical evaluation system 1000 that is configured for predicting or describing patient health outcomes in a person with acute mountain sickness. Medical evaluation system 1000 may include processor 1002, graphical user interface 1004, and a data storage unit 1006. The graphical user interface 1004 may be configured for presenting questionnaires to the person. Graphical user interface 1004 may receive the responses from the person for subsequent processing by processor 1002 and storage in the data storage unit 1006, e.g., in a logically defined personal database storage component 1008. Graphical user interface 1004, by way of example, could be administered over the Internet, locally through a touchscreen, five computer keyboard, by voice recognition technology, or through mouse-driven interfaces. An appropriate device containing interface 1004 may, for example, be a personal computer, personal data assistant (PDA), cellular telephone, or other electronic device.

In medical system 1000, processor 1002 is communicatively connected to interface 1004 for scoring the responses and evaluating the responses. Processor 1002 reports evaluation results to assist in user through interface 1004, or by another means such as a printer or electronic messaging. By way of example, the group data 1010 may be compiled from a cluster or may be representative of the national or global population. In one embodiment, group data 1010 may be downloaded from the Internet. It is a feature of the test study group model 1010 is that it may contain information from a statistically validated survey, i.e., one having statistical correlation indicators indicating that measured predictive parameters are closely related to a measured outcome. For example, validation may be proven through the use of delimiting metrics, such as P values less than at the limiting value of 0.05. the study group model 1010 may be accessed to provide a prognostic ranking or other measure of health outcomes. New responses in the personal data 1008 may be scored and input for comparison against the group study model 1010 and the expert-defined rules-based 216 to assess the respondents odds of encountering an outcome. A user of medical system 1000 may be able to generate reports from the system by interactively adjusting pre-defined delimiters or parameters.

A patient's current treatment regimen may be automatically reported to the personal database 1008 by other databases (not shown) that are linked to storage unit and 1006. Further statistical linkage of medical information dated the actual health outcomes associated with the recommended treatments may provide statistical optimization that improves health outcomes for group of patients that is studied.

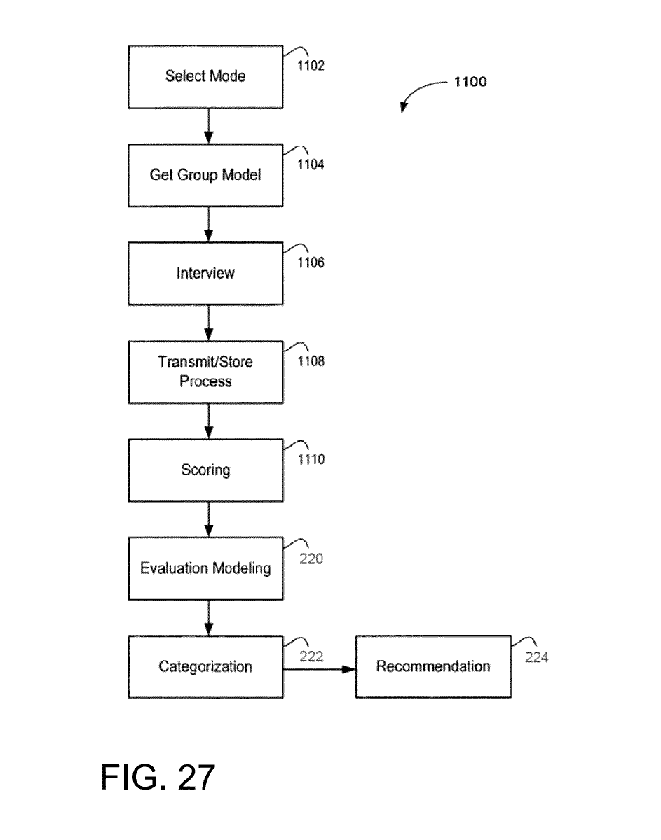

FIG. 27 shows a flowchart illustrating operation 1100 of system 1000, in accord with one method. Operation 1000 commences with the mode selection 1102, which may entail user selection of a medical mode for a particular disease or medical condition from among a plurality of such diseases or conditions, e.g., acute mountain sickness. Step 1104 Intel's processor 1102 retrieving a model group that may comprise selected medical information questionnaire, program instructions for implementing the rules base 216, and the group model 1010 for the selected medical mode.

The graphical user interface 1004 receives responses from a person in an interview step 1106, which may also entail retrieval of information, such as demographic and clinical information, from other databases (not shown). Processor 1002 may receive transmitted personal responses from graphical user interface 1004, store the responses in the personal database 1008, and process the responses. Processing may include scoring 1110 to obtain scores, followed by evaluation modeling 220, categorization 222, and recommendation 224, as described above in the context of FIG. 25.

Those skilled in the art should appreciate that storage units may illustratively represent the same storage memory and/or one or a combination of storage unit and computer memory within a computer system. Instructions that perform the operations discussed above may be stored in storage media or computer memory structures may be retrieved and executed by a processor. Some examples and instructions include software, program code, and firmware. Some examples of storage media include memory devices, tapes, disks, integrated circuits, and servers. Instructions are operational and executed by a processor to direct the processor to operate in accord with the invention.

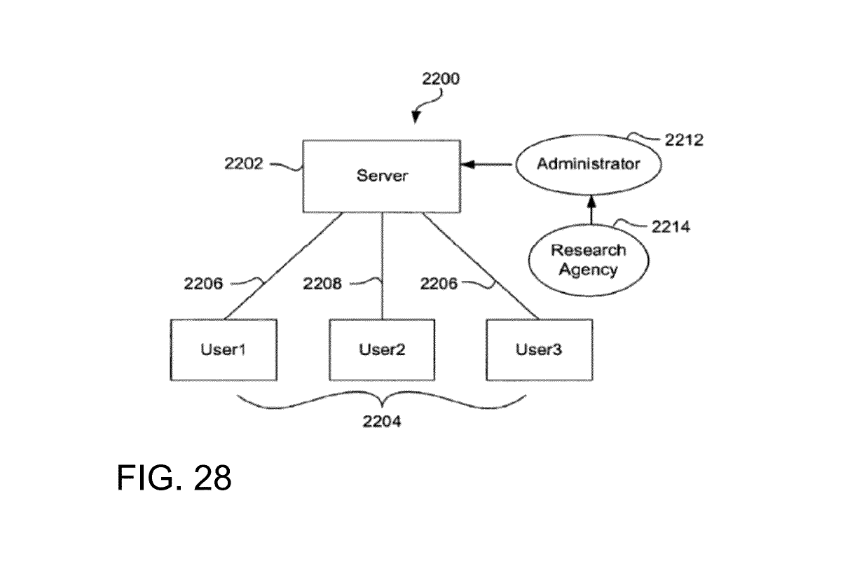

FIG. 28 illustrates an Wide Area Network (WAN) or Local Area Network (LAN) such as an intranet or the Internet, represented as system 2200 that may be configured with program instructions and data to implement the foregoing instrumentalities, such as the process 200 of FIG. 25, the medical system 1000 of FIG. 26, or the operation 1100 of FIG. 27. Internet system 2200 may, for example, be a proprietary local area network (LAN) or a wide area network (WAN). Server 2202 is connected with a plurality of users 2204 or able to access the server 2202 for statistical processing of information. Connections 2206, 2208, end 2210 may be any type of data connection including wireless connection, coaxial connection, optical connection, Internet connection, or other type of connection across any geographic area. The Internet system 2200 may be implemented in a local hospital or in a plurality of local hospitals across the city, estate, end nation, or countries throughout the world. The users 2204 are each provided with suitable electronic equipment for establishing these connections, such as personal computers or PDAs. This equipment is preferably adapted for compatibility with other extant systems, such as billing systems, patient information systems, emergency response systems, and barcoding identification end tracking systems for patients end materials.

The server 2202 may, for example, store group data 1010 and/or may provide back-up storage for individual medical evaluation systems, as discussed above. Additionally server 2202 may provide a local agent or translator for plurality of individual medical evaluation systems to exchange information.

Server 2202 provide centralized control under the supervision of an administrator 2212. A research agency 2214 generate statistical models of any type that may relate validated statistical models with human responses to status questionnaires for any purpose. For example, the statistical model may be used provided prognostic indication of a health outcome or to assist the patient selecting a therapeutic modality, as described above. The program instructions configuring server 2202 for use towards these ends are capable of accepting new models for different purposes, where these models are provided by the research agency 2214. In this matter, the research agency is able to provide updates to existing models that have been revalidated and/or expanded by comparing outcomes and demographics to survey responses. Additionally, the research agency may provide new models that may be selected by users 2204 to meet a particular need in the intended environment of use.

In yet additional configurations, the present invention includes a statistical processing system that includes a server 2202 operably configured with program instructions implementing a plurality of statistical models to at least one of (a) predict a health outcome based on questionnaire responses, (b) assisted patients choice of therapeutic modality based on questionnaire responses, and (c) assess a health risk or status based on questionnaire responses. The system further includes a research agency 2214 communicating with server 2202 and providing the statistical models using of visual interface communicated by server 2202. Server 2202 is configured to analyze requests received from users 2204 over the Internet 2302, and intranet, or another network that relates to a plurality of statistical models and to reduce redundancy requests for patient data. Also, in some configurations, the statistical processing system further includes server 2202 operatively configured to present medical information questions to a user 2204 for human response and for receiving human responses to the medical information questions. Further, in some configurations, the statistical processing system has program instructions that are configured to assign a percentage range associated with likelihoods of encountering adverse outcomes.

### Example 2

### Survey Data Collection

### Study Population

A relational database (26 studies, 476 men and women, and 1,468,823 data points) using experimentally-controlled conditions with individual ascent profiles, relevant demographic and physiologic subject descriptors, and functional outcomes across time at various altitudes is developed. Due to our unique hypobaric chamber and Pikes Peak laboratory facilities, USARIEM has been able to collect AMS data (1292 data points) on 308 unacclimatized (no altitude exposure in the previous 3 months) men and women following rapid ascent (<2 h) and stay at fixed altitudes (1659-4501 m) during the first 48 h of exposure (highest AMS risk) under experimentally-controlled conditions (no medication use, adequate hydration, physical activity assessment, controlled temperature and humidity) to develop robust predictive models of AMS. Table 11 contains the mean, standard deviation, and range of the main variables utilized in developing AMS severity, prevalence, and grade of severity models over time at altitude. There was an equal distribution of women (15-20%) in the four age quartiles (18-23, 24-30, 31-37, and 38-45 yr). In our data set, 62.5% of the data points and 66.9% of the individuals were at altitudes >3500 m. All volunteers were fit, healthy, and relatively young. All received medical examinations, and none had any pre-existing medical condition that warranted exclusion from participation. Each gave written and verbal acknowledgment of their informed consent and was made aware of their right to withdraw without prejudice at any time. The studies were approved by the Institutional Review Board of the USARIEM in Natick, Mass. Investigators adhered to the policies for protection of human subjects as prescribed in Army Regulation 70-25, and the research was conducted in adherence with the provisions of 32 CFR Part 219.

### Selection of Studies

Twenty studies conducted over the past 20 years at USARIEM were included in this analysis. Although some studies were conducted in natural altitude conditions (i.e., Pikes Peak, US Air Force Academy) and others were conducted in the hypobaric chamber, statistical analysis revealed no differences in the major dependent variable (i.e., AMS) between the two conditions when evaluated at the same barometric pressure. Ascent times in the hypobaric chamber were more rapid (<15 min) than ascent times in the mountains (<2 h). The time variable did not start until arrival at the destination altitude. In studies that utilized any type of medication treatment only the placebo subjects were included in the analysis. See Table 11 for a complete description of the data set.

### Dependent Variables: Altitude Illness Measures

AMS was assessed at various time points depending on the protocol for each study. In addition to a baseline measurement of AMS at sea level, a minimum of 1 and maximum of 9 repeated measurements of AMS were made per individual at altitude. Given that AMS does not typically develop until 4-6 h of altitude exposure, only time points greater than 4 h were considered in the severity, prevalence, and grade of severity models. The severity of AMS was determined from information gathered using the Environmental Symptoms Questionnaire (ESQ-III) (22, 23) or shortened version of the ESQ-III (24) (see Table 10). A weighted AMS cerebral factor score (AMS-C)≧0.7 indicated the presence of AMS. The AMS-C scores were log-transformed for data analysis to conform to normality assumptions and zero scores for AMS-C were assigned a random value between 0.01 and 0.15 in order to perform the log transformation.

AMS was also broken down into severity categories by cutoff-scores partially established in the ESQ (22, 23). These categories were defined as follows: 1) Mild AMS: ≧0.7 and <1.530, 2) Moderate AMS: ≧1.530 and <2.630, and 3) Severe AMS: ≧2.630.

TABLE 11
Characteristics of Unacclimatized Men (239) and Women (n = 69)
Lowlanders (n = 308; 1,292 data points) utilized in the data set.

| VARIABLE | MEAN | SD | MIN | MAX |
|---|---|---|---|---|
| Age (yr) | 23.8 | 5.4 | 18 | 45 |
| Weight (kg) | 76.3 | 12.1 | 47.1 | 113.3 |
| Height (m) | 1.75 | 0.83 | 1.47 | 1.98 |
| Body-mass index (kg/m²) | 24.8 | 2.9 | 18.3 | 33.8 |
| Altitude (km) | 3.822 | 0.721 | 1.659 | 4.501 |
| Men (%) | 77.6 | | | |
| Smokers (%) | 15.6 | | | |
| Whites (%) | 77.9 | | | |
| High Active (%) | 63.6 | | | |
| AMS (%) (Altitude Measures) | | | | |
| Sick | 65.3 | | | |
| Not-Sick | 34.7 | | | |
| AMS-C (Altitude Measures) | | | | |
| Sick | 1.378 | 0.872 | 0.296 | 4.876 |
| Not-Sick | 0.129 | 0.093 | 0.012 | 0.451 |
| AMS-C Measures/Subject | 4.2 | 2.4 | 1 | 10 |
| (Altitude Measures) | | | | |

AMS; Acute Mountain Sickness,
SD, standard deviation,
MIN, minimum,
MAX, maximum,
AMS (%) is based on subjects that were sick on at least one measurement occasion during their altitude exposure.

### Independent Variables

Physical activity levels were collapsed into two categories: low activity 50% maximal oxygen uptake for 45 min upon arrival at altitude) and high activity (>50% of maximal oxygen uptake for >45 min upon arrival at altitude). Altitude coded in kilometers (i.e, one unit increase in altitude was equivalent to a 1000 m increase in altitude), time coded in 24-h increments (one unit increase in time was equivalent to 24-h), physical activity level (low and high), and sex (men and women) were entered as major predictor variables in the model. The following covariates were also included in the model: age, BMI (weight/height2), race (white and all others), and smoking status (current smoker or >3 month non-smoker).

### Example 3

### Statistical Processing of Data Collection

We modeled AMS using individual growth models containing subject-specific intercepts and slopes for AMS severity, prevalence, and grade of severity over time at altitude with PROC MIXED and PROC GLIMMIX (SAS, Cary, N.C.) (17). General linear and logistic mixed models allow the intercepts and slopes to vary by individuals such that individual predictions of AMS can be calculated for subjects in the data set (14, 25). These models can accommodate repeated measures data, missing data over time, irregularly space measurements, and can easily handle both time-varying and time-invariant covariates (14, 25). For the AMS grade of severity model (i.e, mild, moderate, and severe), we utilized a proportional odds model with different intercepts for adjacent categories.

Unconditional means models (i.e, with no predictors) were initially fit for AMS-C scores to evaluate whether significant variation in the data warranted inclusion of predictor variables. An unconditional growth model for the pattern of change in AMS-C over time (i.e., linear vs. quadratic vs. cubic) was assessed by regressing time, time2, and time3 on AMS-C in turn as both fixed and random effects. If higher orders of time were not significant (P<0.05), they were dropped from the model as both a fixed and random effect and the model was rerun. Time was centered at 20 h of exposure for ease of interpretation of intercepts. After determining a suitable parsimonious individual growth model, all level-2 covariates and their interactions with time and each other were included in the model. Non-significant covariates (P>0.10) and their interactions with time and each other were eliminated from the model one at a time starting with the least significant effect until the final model was determined.

Model diagnostics for general linear and logistic mixed models were performed to compare the data with the fitted models to highlight any discrepancies. Diagnostic tools included residual analysis, outlier detection, influence analysis, and model assumption verification. There were no systematic trends in the residuals that indicated a misspecified model. Twenty one subjects had AMS-C scores that were potential outliers but after careful inspection it was determined that the data were not erroneous. The distribution of the random effects for intercept, time and time2 were all normally distributed assessed by skewness and kurtosis statistics and the Kolmogorov-Smirnov test of normality. Internal validation of both models was conducted utilizing Efron bootstrap resampling with replacement on 1000 bootstrap samples (26). The difference between the root mean square error for the AMS severity model (0.93) and RMSE for the 1000 bootstrap samples (1.23) was small and within the measurement error of the ESQ. The percent correct classification of sick versus not sick in the AMS prevalence model was 95.2% in the original model and 90.1% for the mean of the 1000 bootstrap samples when the cut-off value for the predicted probability was set at >50%.

### Example 4

### Multivariable Prognostic Models

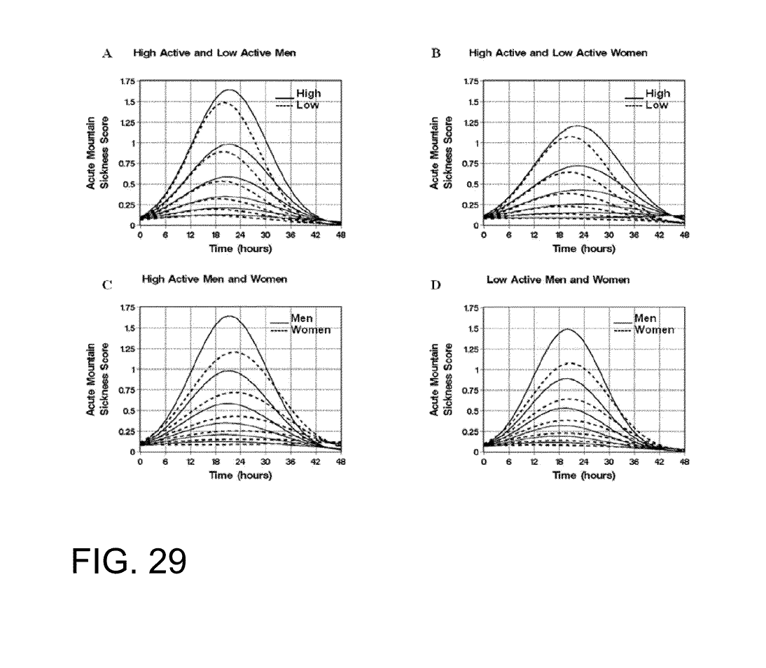

Table 12 presents the results of a fitting a taxonomy of multilevel models for change to the AMS-C severity data starting with the unconditional means model (model A), unconditional growth model with intercept, time and time2 (model B), individual growth model with one predictor (i.e., altitude) (model C), and the final individual growth model with three predictors (i.e, altitude, activity and sex) (model D). FIG. 29 presents the population-average predictions for AMS-C severity scores using the model specified in Table 12.

TABLE 12
Parameter Estimates and Standard Errors from Fitting a Taxonomy of
Multilevel Models Examining Changes in Acute Mountain Sickness Cerebral
Factor (AMS-C) C Scores over the First 48 h of Exposure to Various Altitudes.

| | | | |
|---|---|---|---|
| Model A | Model B | | Model D |
| Unconditional | Unconditional | Model C | (Altitude/Activity/ |
| Means | Growth | (Altitude) | Sex) |

Fixed Effects

| | | | | |
|---|---|---|---|---|
| Intercept | −1.32 (0.06)** | −0.26 (0.09)* | −4.07 (0.42)** | −4.55 (0.49)** |
| CTime | | 0.28 (0.08)** | −0.31 (0.44) | −0.66 (0.55) |
| CTime² | | −2.75 (0.15)** | 1.51 (0.74)* | 1.82 (0.91)* |
| Altitude | | | 0.98 (0.11)** | 1.03 (0.11)** |
| Altitude * CTime | | | 0.14 (0.11) | 0.18 (0.12) |
| Altitude * CTime² | | | −1.10 (0.19)** | −1.11 (0.19)** |
| Activity | | | | 0.09 (0.17) |
| Activity * CTime | | | | 0.37 (0.18)* |
| Activity * CTime² | | | | 0.55 (0.34) |
| Sex | | | | 0.33 (0.18) |
| Sex * CTime | | | | −0.16 (0.17) |
| Sex * CTime² | | | | −0.94 (0.32)* |

Variance Components

| | | | | |
|---|---|---|---|---|
| Within person | 1.55 (0.08)** | 0.71 (0.04)** | 0.71 (0.04)** | 0.71 (0.04)** |
| Intercept | 0.61 (0.07)** | 1.57 (0.18)** | 1.05 (0.14)** | 1.04 (0.13)** |
| Time | | 0.56 (0.12)** | 0.55 (0.12)** | 0.54 (0.11)** |
| Time² | | 2.62 (0.58)** | 1.85 (0.49)** | 1.75 (0.47)** |

Goodness-of-Fit Statistics

| | | | | |
|---|---|---|---|---|
| R²yŷ | | 0.25 | 0.34 | 0.37 |
| AIC | 4523 | 3794 | 3730 | 3722 |

*P < 0.05,
**P < 0.001.
Time was centered (CTime) at 20 h of altitude exposure.
R²yý = correlation (yý)².
AIC = Akaike Information Critera.
Example computation of an AMS-C score in the final model is as follows for a high active (activity = 1), male (sex = 1), at 4500 m (altitude = 4.5) at 20 h of exposure (CTime = 0): AMS-C = e^{[-4.55+(1.03*4.5)+(0.09*1)+(0.33*1)]} = 1.66. The parameter estimates are per 24 h increase in time, 1000 m increase in altitude and the reference category for sex is female and activity is low active. The intercept represents the value for an inactive female at 20 h of exposure and 0 m altitude.

Novel results from this model include the following: 1) AMS severity above 200 m increased (P<0.05) ˜2-fold [(e1.026−1)*100] for every 1000 m increase in altitudes at 20 h regardless of activity or sex, 2) AMS severity above 2000 m peaked between 18-22 h and was reduced to initial levels by 48 h regardless of altitude, activity or sex, 3) high active men and women demonstrated similar peak AMS-C scores but took ˜3-4 h longer to resolve AMS than their low active counterparts, and 4) men demonstrated 38% [(e.3258−1)100] higher (P<0.05) peak AMS severity scores than women regardless of altitude or activity. The absolute increase in AMS severity for every 1000 m increase in altitude is non-linear due to the fact that a 2-fold increase is based on the initial AMS severity scores which start at a lower level at 2000 m compared to 3000 m. For instance, the predicted AMS-C score increases from 0.54 to 0.89 going from 2000 to 3000 m (0.54*1.79*+0.54) but increases from 0.89 to 1.55 going from 3000 m to 4000 m.

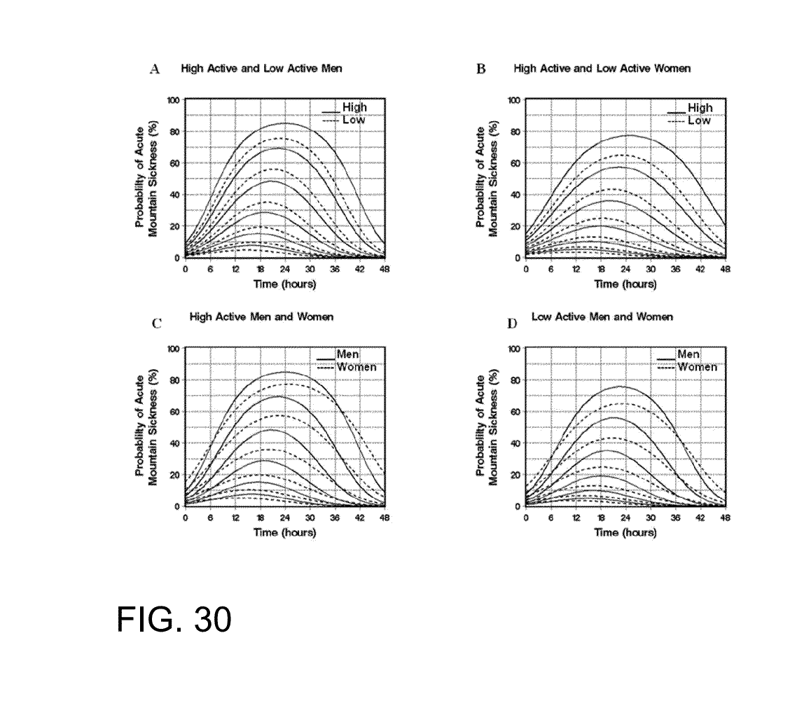

Table 13 presents the parameter estimates for both the AMS prevalence (i.e, sick vs. not sick) and grade of severity (i.e, mild, moderate and severe) models. FIG. 30 presents the population-average predictions for the prevalence of AMS in four different subgroups using the equation contained in Table 13. Table 14 contains the odds ratios (OR) evaluated at different altitudes between 2000-4500 m going from 0 to 20 h of altitude exposure in both low and high active men and women. Novel results from the AMS prevalence model include the following: 1) the odds (OR 5.43, CI: 3.24 to 9.10) of experiencing AMS increased (P<0.001) by ˜4.5 fold for every 1000 m increase in altitude at 20 h, 2) AMS prevalence peaked between 16 to 24 h and was reduced to initial levels by 48 h at all altitudes except 4500 m, 3) high actives demonstrated a 72% increase (P<0.05) in the odds (OR 1.72, CI 1.03-3.08) of AMS regardless of altitude or sex at 20 h, 4) men demonstrated a tendency (P=0.10) for increased odds of AMS (OR 1.65, CI 0.84-3.25) regardless of altitude or activity at 20 h, and 5) high and low active women increased (P<0.05) their odds (Table 14) of experiencing AMS going from baseline to 20 h of exposure when the altitude was 3000 m but the threshold altitude for increased odds in men was ≧2500 m for low actives and ≧2000 m for high actives.

TABLE 13
Parameter Estimates and Standard Errors from the Logistic Mixed-
Effects Regression Model of AMS Prevalence (i.e., Sick vs. Not Sick) and
Grade of Severity (i.e., Mild, Moderate, Severe) Outcome Measures
over Time at Altitude.

| | | AMS Grade |
|---|---|---|
| | AMS Prevalence Model | of Severity Model |
| | Parameter Estimates and | Parameter Estimates and |
| VARIABLE | Standard Error | Standard Error |
| Intercept (Binary) | −7.04 (1.15)** | |
| Intercept 3 | | −10.66 (1.27)** |
| Intercept 2 | | −9.04 (1.26)** |
| Intercept 1 | | −7.46 (1.25)** |
| CTime | −4.11 (1.74)* | −3.79 (1.85)* |
| CTime² | −2.74 (0.54)** | −3.03 (0.52)** |
| Altitude | 1.69 (0.26)** | 1.82 (0.28)** |
| Altitude * CTime | 1.07 (0.39)** | 0.93 (0.42)* |
| Activity | 0.54 (0.29)* | 0.55 (0.31) |
| Activity * CTime | 0.39 (0.38) | 0.39 (0.38) |
| Sex | 0.50 (0.34) | 0.57 (0.34) |
| Sex * CTime | 0.21 (0.33) | 0.22 (0.35) |
| Sex * CTime² | −1.29 (0.68)* | −1.66 (0.65)* |

*P < 0.05,
**P < 0.001.
Time was centered (CTime) at 20 h of altitude exposure.
There is only one intercept for the binary outcome model but three intercepts for the ordinal outcome model. The ordinal AMS prevalence model is modeling the probability of being in a higher ordered category of AMS. The probability of AMS from the binary or ordinal model is calculated using the following formula: AMS (%) = e^{logit}/1 + e^{logit}. An example calculation of the logit using the binary equation for a high active (activity = 1), male (sex = 1), at 4500 m (altitude = 4.5) at 20 h of exposure (CTime = 0) is logit = [−7.04 + (1.69 * 4.5) + (0.54 * 1) + (0.50 * 1)]. In this case the logit = 1.609 and the AMS probability (e^{1.609}/1 + e^{1.609}) equals 83.4%. The ordinal logit can be calculated using the ordinal equation for the probability of severe AMS using intercept 3, severe plus moderate AMS using intercept 2, and severe plus moderate plus mild AMS using intercept 1. The parameter estimates are per 24 h increase in time, 1000 m increase in altitude and the reference category for sex is female and activity is low active. The intercept represents the value for an inactive female at 20 h of exposure at 0 m.

TABLE 14
Odds Ratio Estimates and 95% Confidence Intervals (CI) from the Binary AMS Prevalence
Model going from 0 to 20 hours of Altitude Exposure in Low Active Men, High Active
Men, Low Active Women, and High Active Women at Various Altitudes.
Odds Ratio Estimates

| Group | Altitude | 2000 m | 2500 m | 3000 m | 3500 m | 4000 m | 4500 m |
|---|---|---|---|---|---|---|---|
| Low Active | Estimate | 3.7 | 5.9* | 9.3* | 14.4* | 22.5* | 35.1* |
| Men | 95% CI | 0.7-19.4 | 1.5-22.8 | 3.1-27.4 | 6.1-34.2 | 10.9-46.5 | 17.1-72.2 |
| High Active | Estimate | 5.2* | 8.2* | 12.7* | 19.9* | 31.1* | 48.4* |
| Men | 95% CI | 1.3-20.5 | 2.7-24.1 | 5.5-29.2 | 10.4-37.8 | 17.2-56.1 | 24.0-98.1 |
| Low Active | Estimate | 1.3 | 2.0 | 3.2* | 4.9* | 7.7* | 12.1* |
| Women | 95% CI | 0.2-6.8 | 0.5-8.1 | 1.0-10.0 | 1.8-12.9 | 3.2-18.3 | 5.0-28.9 |
| High Active | Estimate | 1.8 | 2.8 | 4.4* | 6.8* | 10.7* | 16.6* |
| Women | 95% CI | 0.4-7.8 | 0.8-9.6 | 1.6-12.3 | 2.7-16.9 | 4.4-25.9 | 6.2-44.5 |

*P < 0.05.
An odds ratio in this table is calculated by dividing the odds (probability of the event happening divided by the probability of the event not happening) of AMS at two different time points for a given altitude. For example, the probability of AMS (calculated in the previous table) for a high active male at 4500 m at 20 h of exposure is 83.4% and 9.4% (calculation not shown) at 0 h of exposure. The odds of AMS for the high active male at 4500 m at 20 h of exposure is 5.02 (i.e., 0.834/1-0.834) and at 0 h of exposure is 0.104 (i.e., .094/1-.094). The odds ratio, therefore, of AMS at 20 h compared to 0 h of exposure in a high active male at 4500 m is 48.4 (i.e., 5.02/.104).

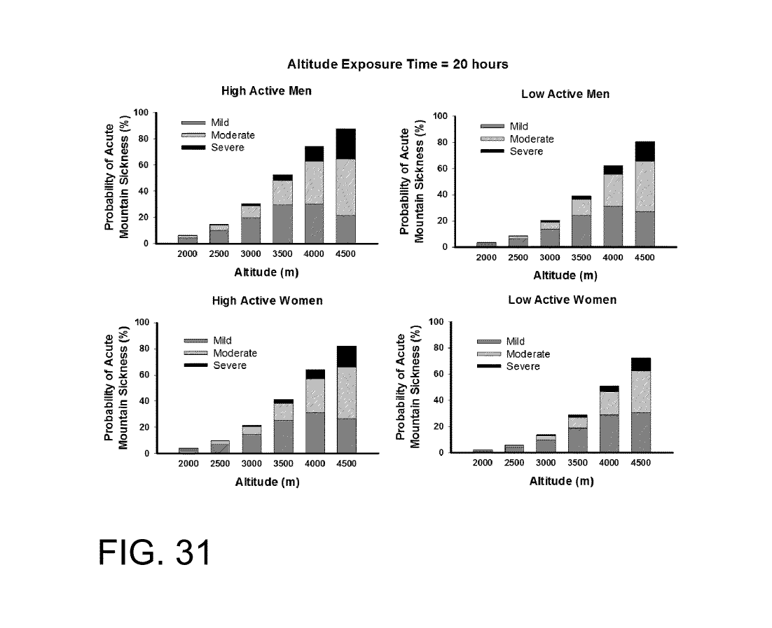

FIG. 31 presents the population-average predictions for the prevalence of mild, moderate, severe and total AMS at 20 h of exposure at six different altitudes (i.e., 2000 m, 2500 m, 3000 m, 3500 m, 4000 m, and 4500 m) in four subgroups of the population. Results from this model are the following: 1) the odds of being in a higher ordered category of AMS (OR 6.204, CI: 3.54-10.88) was increased (P<0.05) ˜5-fold for every 1000 m increase in altitude regardless of activity or sex at 20 h, 2) high actives demonstrated a 73% increase (P<0.05) in the odds (OR 1.73; CI 1.03-3.21) of being in a higher ordered category of AMS at 20 h regardless of altitude or sex and 3) men demonstrated a tendency (P=0.10) for increased odds (OR 1.77, CI 0.89-3.49) of being in a higher ordered category of AMS at 20 h. Fifty-one out of 308 individuals experienced severe AMS (16.56%) and all but one of those subjects was above 4000 m.

### Example 5

### Categorization and Recommendation

This invention comprises the first predictive models of AMS severity, prevalence, and grade of severity following rapid ascent and stay over a wide range of fixed altitudes during the first 48 h of exposure in unacclimatized lowlanders. The USARIEM Mountain Medicine database, which contains data collected under experimentally-controlled conditions, allowed for the development of quantifiable estimates of AMS which were previously nonexistent. These AMS models quantify the increased risk of AMS for a given gain in elevation, the time course of AMS symptoms (i.e., when symptoms peak and recover) and the baseline demographics and physiologic descriptors that increase the risk of AMS. In addition, these models provide estimates of the different grades of AMS severity (i.e., mild, moderate, and severe) over a wide range of altitudes. Lastly, these AMS models are unique compared to previous models because they do not require previous exposure to altitude to calculate the predicted risk of AMS. These models can be utilized to predict AMS prior to exposure to a wide range of altitudes in any unacclimatized lowlander just by knowing the destination altitude, length of stay at altitude, physical activities planned during the stay at altitude, and general baseline demographics.

The major predictive factors for estimating AMS severity, prevalence and grade of severity in these models are altitude, time at altitude, physical activity level, and sex. Altitude was the most significant factor in the models. Previous research has already demonstrated a dose/response relationship between increased altitude and increased AMS severity and prevalence (27-31) but available estimates are general and lack precision. For instance, previous guidance suggests 18-40% prevalence of AMS between 2000-3000 m. The ability to provide accurate pinpoint estimates of AMS using an equation at any given altitude between 2000-4500 m represents a significant advancement in the field. These models also provide quantification of the increased risk of AMS for a given gain in elevation. These models predict that AMS severity increases ˜2-fold, the odds of experiencing AMS (i.e., prevalence) increases ˜4.5 fold, and the probability of falling into a higher ordered category of AMS increases ˜5-fold for every 1000 m gain in elevation when evaluated at 20 h of exposure regardless of activity level or sex. This increase in non-linear in that it depends on the initial starting value such that the absolute 2-fold increase from 2000 to 3000 m is less than the 2-fold increase from 3000 to 4000 m because AMS starts at a higher level at 3000 m.

The proportional odds model demonstrates that the proportion of severe cases of AMS, which is the category that would require evacuation or immediate medical attention, increases significantly (i.e., 10-20%) around 4000 m, depending on the subgroup examined. This prediction agrees closely with the percentage of reported evacuations (14.6%) due to severe altitude illness during current military operations in Afghanistan (7). This type of information is important for clinicians, health care workers, and military leaders advising personnel rapidly ascending to high mountainous regions because operational plans can be altered if the risk of ascending to a higher elevation outweighs the benefit. If plans or mission cannot be altered, as often occurs in the military, the degree of increased risk associated with ascending to a higher elevation will at least be well understood.

The second most significant factor in the AMS models was time at altitude. This is the first time that any model has quantitatively delineated the time course of AMS over a wide range of altitudes. Our models predict that AMS-C peaks after ˜21 h of altitude exposure when only time is considered in the model. When altitude and subject characteristics are taken into account, AMS still peaks following 16-24 h of altitude exposure and resolves by 48 h of exposure except at 4500 m. This finding disagrees with general guidance provided in the literature suggesting that AMS peaks within 24-48 h of altitude exposure and resolves over the next 3-7 days (32-34). Our models predict that AMS peaks sooner and resolves earlier than previously suggested. If individuals ascend around 8 am to 12 noon, predictions from our model would indicate that AMS peaks by 5-9 am the next morning, and resolves the following morning at a given altitude if no further ascent occurs. This guidance holds for the lower altitudes (<4000 m) but as individual ascend to higher altitudes (i.e., 4500 m) the prevalence of AMS remains increased after 48 h of exposure. For higher elevations, resolution of AMS symptoms may take another day or two of acclimatization.

These are the first models of AMS severity and prevalence to account for the effect of time spent at altitude (2, 10, 27). Previous AMS models only examined one time point (i.e., the morning after the first night at altitude), usually only one altitude, and provided no information on when AMS symptoms peak and recover. Estimates of AMS at differing time points other than after the first night at altitude are important when planning both short-term (i.e., 6-12 h) and long-term (i.e., 24-48 h) military missions, recreational activities, and search and rescue operations.

High physical activity has been shown to increase the prevalence of AMS within the first 10 h of exposure to ˜4500 m most likely due to reductions in arterial oxygen saturation and alterations in fluid balance during exercise (35,36). Increased exertion during ascent to altitude in trekkers and mountaineers also increases the risk of developing AMS (30, 37). The degree of increase in this risk, however, has never been quantified. Our model demonstrates that high actives demonstrated a 72% increase in the odds of AMS and 73% increase in the proportional odds of falling into a higher ordered category of AMS regardless of sex or altitude. Although peak AMS-C scores at 20 h did not differ between high and low actives, high actives did take ˜3-4 h longer to resolve AMS than low actives. Our model, therefore, agrees with previous guidance suggesting limited activity in the first 24 h at altitude, if possible, to decrease the risk of experiencing AMS.

The relationship between gender and the risk of AMS has been reported in numerous studies on trekkers and mountaineers (2, 10, 29, 38). Most studies have reported that men and women are equally susceptible to AMS (6, 10, 29, 30, 38, 39) or that women have a slightly greater risk of developing AMS (2). We found that women demonstrated 29% lower (P=0.05) AMS severity scores at 20 h regardless of altitude or activity level, which agrees with one previous report (40). The odds of experiencing AMS and odds of falling into a higher ordered category of AMS also tended (P=0.10) to be lower in women compared to men. The severity but not the prevalence of AMS was therefore higher in males. This finding may be due to the fact that all of our women in our database were pre-menopausal and progesterone, a known ventilatory stimulant, is higher in women compared to men (41, 42). An increase in ventilation is an important aspect of altitude acclimatization and has been associated with a reduction in AMS (43, 44). Although a few studies found increased ventilation in acclimatized women compared to men (46) more recent work has not substantiated this finding in unacclimatized women (46). Other physiologic differences between genders (i.e., differences in endothelial permeability, free radical production, or perception of pain) may be contributing to this gender difference in AMS symptom severity but more work is needed to elucidate potential physiologic mechanisms.

The odds ratio going from 0-20 h of exposure also differed between men and women. In this time frame, active men are clearly at risk as low as 2000 m but active women are not at risk until 3000 m. Most reviews suggest that AMS is rare below 2500 m (20, 34) but some have reported the development of AMS as low as 1800 m to 2100 m (28, 47). Our model supports the later conclusion but only for active males. Thus, another important feature of the present models relates to being able to differentiate for the first time differences and onsets of AMS severity, prevalence, and grade of severity between men and women at relatively low altitudes.

The fact that age, BMI, race, and smoking status were not significant factors in predicting AMS severity, prevalence, or grade of severity is consistent with many previous reports (2, 9, 30, 39). Although some (6, 10, 38) have reported a decreased prevalence of AMS with increasing age and lower BMI, these conclusions were based on older (age 50 yrs) and obese individuals (BMI 30 kg/m2). Ri-Li et al. (40) reported a greater nocturnal desaturation at altitude in obese individuals which contributed to a greater prevalence of AMS and also found that heavier individuals were more likely to develop AMS at altitude (40). Our data set was limited to relatively fit individuals between 18 and 45 yr with a mean age of ˜24 yr. We cannot, therefore, exclude the possibility that age or obesity may have been a factor in our model had we utilized older or obese individuals in our data set. Although conclusions from this model suggest that race is not a significant factor for the development of AMS within the broad classification categories utilized in the model (i.e, white and non-white), this factor requires further study due to the limited number of non-white individuals in our database.

The results suggest that in addition to altitude and time spent at altitude, high activity increases the risk of developing AMS. The AMS models also suggest that AMS severity is increased in men but the prevalence of AMS is the same in both men and women. Although predictions from these models are limited to a homogeneous population that is relatively young and fit, these AMS models for the first time quantify the increased risk of AMS for a given gain in elevation, the time course of AMS symptoms, the baseline demographics that increase the risk of AMS, and estimates of different grades of AMS severity (i.e., mild, moderate, and severe). These AMS models can be utilized to predict AMS prior to exposure to a wide range of altitudes in any unacclimatized lowlander just by knowing the destination altitude, length of stay at altitude, physical activities planned during the stay at altitude, and general baseline demographics.

Personal Altitude Acclimatization Monitor (PAAM)

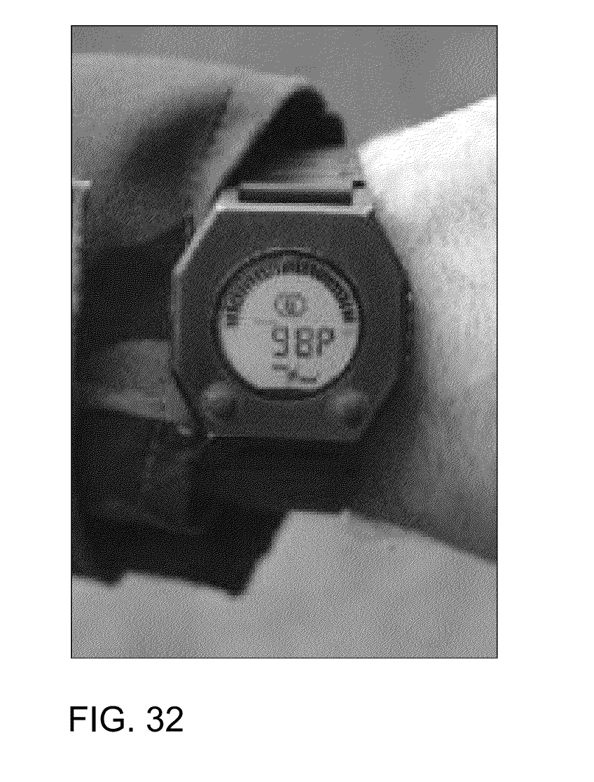

The Personal Altitude Acclimatization Monitor (PAAM) is a hardware platform that comprises, in various embodiments, either a “wrist-watch”, “pedometer”, PDA or “Smart Phone” by way of example. See FIG. 32. The PAAM automatically logs & estimates individual/unit altitude acclimatization status using inputs, including but not limited to: barometric pressure and time and target altitude to produce a reportable output, such as target altitude acclimatization status, for example. The data may be automatically collected or entered manually by way of user data entry. Models appropriate for use in PAAM apparatus or systems include, but are not limited to the three AMS models, one physical performance model and one altitude acclimatization model as described above.

The PAAM, or alternatively, the Automated Altitude Acclimatization Monitor (AAAM) is a mobile, portable, and durable hardware platform that integrates sensors such as, by way of nonlimiting example, a barometric pressure sensor, with the disclosed predictive models of altitude acclimatization to a range of altitudes (for example, 1,600 meters to 4,500 meters) of this invention. The hardware platform may constitute, by way of nonlimiting example altimeter-recording devices, wristwatches, GPS devices, and smart-phones.

The user will initialize the AAAM, and select a “target” elevation to acclimatize to. A built-in barometric pressure sensor will measure and record the user's altitude profile preset time intervals (e.g., for example every 10 minutes to every 60 minutes) over the period of acclimatization (for example, a range of 2 days to several weeks). The disclosed altitude acclimatization module disclosed as part of this invention will be used to by an on-board CPU to calculate the user's current acclimatization status in real-time. The AAAM hardware platform will be equipped with means for displaying the data generated by the on-board CPU, to include, for example, the user's current acclimatization status expressed in terms of decreased risk of developing AMS and/or improved physical work performance capabilities at a specified operational altitude.

The AAAM hardware platform may be equipped with means for the storage and retrieval of data, such as, for example, longitudinal user altitude profile data. The AAAM hardware platform will be equipped with input means allowing the user to change the operational altitude of interest, and to determine the acclimatization status over a range of varying altitudes.

A software application will automate environment data acquisition and storage and provide real-time altitude acclimatization status outputs in both text and graphical formats.

While a specific embodiment of the invention will be shown and described in detail to illustrate the application of the principles of the invention, it will be understood that the invention may be embodied otherwise without departing from such principles.

### REFERENCES

The contents of each of which, and the contents of every other publication, including patent publications such as PCT International Patent Publications, being incorporated herein by this reference.
(1) Bartsch P., a. R. R. (2001). Accute mountain sickness and high-altitude edema. In High Altitdue: An Exploration of Human Adaptation. T. H. a. R. Schoene. New York, Marcel Dekker: 731-775
(2) Vann, R. D., Pollock, N. W., Pieper, C. F., Murdoch, D. R., Muza, S. R., Natoli, M. J., & Wang, L. Y. (2005). Statistical models of acute mountain sickness. [Research Support, U.S. Gov't, Non-P.H.S.]. High Alt Med Biol, 6(1), 32-42. doi: 10.1089/ham.2005.6.32
(3) Hackett, P. H., & Roach, R. C. (2001). High-altitude illness. [Review]. N Engl J Med, 345(2), 107-114.
(4) Anonymous. (2001). A guide to acclimatization, illness end physical work performance at high Altitude (US Army Center for Health Promotion and Preventative Medicine, Natick, Mass.).
(5) Houston, C. S., & Dickinson, J. (1975). Cerebral form of high-altitude illness. [Case Reports]. Lancet, 2(7938), 758-761.
(6) Gaillard, S., Dellasanta, P., Loutan, L., & Kayser, B. (2004). Awareness, prevalence, medication use, and risk factors of acute mountain sickness in tourists trekking around the Annapurnas in Nepal: a 12-year follow-up. High Alt Med Biol, 5(4), 410-419.
(7) Peoples, G. E., Gerlinger, T., Craig, R., & Burlingame, B. (2005). The 274th Forward Surgical Team experience during Operation Enduring Freedom. Mil Med, 170(6), 451-459.
(8) Windsor, J. S., Firth, P. G., Grocott, M. P., Rodway, G. W., & Montgomery, H. E. (2009). Mountain mortality: a review of deaths that occur during recreational activities in the mountains. [Review]. Postgrad Med J, 85(1004), 316-321.
(9) Mairer, K., Wille, M., & Burtscher, M. (2010). The prevalence of and risk factors for acute mountain sickness in the Eastern and Western Alps. [Comparative Study]. High Alt Med Biol, 11(4), 343-348.
(10) Wagner, D. R., Fargo, J. D., Parker, D., Tatsugawa, K., & Young, T. A. (2006). Variables contributing to acute mountain sickness on the summit of Mt Whitney. [Research Support, Non-U.S. Gov't]. Wilderness Environ Med, 17(4), 221-228.
(11) Bartsch, P., Bailey, D. M., Berger, M. M., Knauth, M., & Baumgartner, R. W. (2004). Acute mountain sickness: controversies and advances. [Review]. High Alt Med Biol, 5(2), 110-124.
(12) An introduction to generalized linear models By Annette J. Dobson, 2002 by Chapman & Hall/CRC Press, ISBN 1-58488-165-8
(13) Generalized Linear Models, Second Edition By P. McCullagh, John A. Nelder, 1999 CRC Press, ISBN 0-412-31760-5
(14) Singer, J. D., & Willett, J. B. (2003). Applied longitudinal data analysis: modeling change and event occurrence. Oxford; New York: Oxford University Press.
(15) HLM. 7383 N. Lincoln Ave. Suite 100, Lincolnwood, Ill. 60712-1747: Scientific Software International, Inc.
(16) MLwiN. 20 Bedford Way, London, UC1H OAI UK: Multilevel Model Project, Institute of Education.
(17) SAS. SAS Campus Drive, Cary, N.C. 27513-2414: SAS Insitute Inc.
(18) Stata. 4905 Lakeway Drive, College Station, Tex. 77845, US: Stata corporation.
(19) S-PLUS. 1700 Westlake Ave North, Suite 500, Seattle, Wash. 98109-3044, US: Insightful Corp.
(20) BUGS (Bayesian inference Using Gibbs Sampling). Cambridge, UK: MRC Biostatistics Unit.
(21) KReft, I. G. G., de Leeuw, J., Kim, K. S. (1990). Comparing four different statistical packages for hierarchical linear regression: GENMOD, HLM, ML2, and VARCL (Technical report 311). Los Angeles: Center for the Study of Evaluation, University of California at Los Angeles.
(22) Sampson, J. B., & Kobrick, J. L. (1980). The environmental symptoms questionnaire: revisions and new filed data. Aviat Space Environ Med, 51(9 Pt 1), 872-877.
(23) Shukitt, B. L., Banderet, L. E., & Sampson, J. B. (1990). The Environmental Symptoms Questionnaire: corrected computational procedures for the alertness factor. Aviat Space Environ Med, 61(1), 77-78.
(24) Beidleman, B. A., Muza, S. R., Fulco, C. S., Rock, P. B., & Cymerman, A. (2007). Validation of a shortened electronic version of the environmental symptoms questionnaire. [Validation Studies]. High Alt Med Biol, 8(3), 192-199.
(25) Hedeker, D. R., & Gibbons, R. D. (2006). Longitudinal data analysis. Hoboken, N.J.: Wiley-Interscience.
(26) Efron, B., & Tibshirani, R. (1993). An introduction to the bootstrap. New York: Chapman & Hall.
(27) Conkin, J., & Wessel, J. H., 3rd. (2008). Critique of the equivalent air altitude model. [Research Support, U.S. Gov't, Non-P.H.S. Review]. Aviat Space Environ Med, 79(10), 975-982.
(28) Honigman, B., Theis, M. K., Koziol-McLain, J., Roach, R., Yip, R., Houston, C., . . . Pearce, P. (1993). Acute mountain sickness in a general tourist population at moderate altitudes. Ann Intern Med, 118(8), 587-592.
(29) Maggiorini, M., Buhler, B., Walter, M., & Oelz, O. (1990). Prevalence of acute mountain sickness in the Swiss Alps. [Comparative Study Research Support, Non-U.S. Gov't]. BMJ, 301(6756), 853-855.
(30) Mairer, K., Wille, M., Bucher, T., & Burtscher, M. (2009). Prevalence of acute mountain sickness in the Eastern Alps. High Alt Med Biol, 10(3), 239-245. doi: 10.1089/ham.2008.1091
(31) Roeggla, G., Roeggla, M., & Wagner, A. (1993). Acute mountain sickness at moderate altitudes. [Comment Letter]. Ann Intern Med, 119(7 Pt 1), 633; author reply 633-634.
(32) Gallagher, S. A., & Hackett, P. H. (2004). High-altitude illness. [Review]. Emerg Med Clin North Am, 22(2), 329-355, viii.
(33) Imray, C., Wright, A., Subudhi, A., & Roach, R. (2010). Acute mountain sickness: pathophysiology, prevention, and treatment. [Review]. Prog Cardiovasc Dis, 52(6), 467-484.
(34) Pandolf, K. B., Burr, R. E., & United States. Dept. of the Army. Office of the Surgeon General. (2001). Medical aspects of harsh environments. Falls Church, Va.
(35) Bartsch, P., Maggiorini, M., Schobersberger, W., Shaw, S., Rascher, W., Girard, J., . . . Oelz, O. (1991). Enhanced exercise-induced rise of aldosterone and vasopressin preceding mountain sickness. [Research Support, Non-U.S. Gov't]. J Appl Physiol, 71(1), 136-143.
(36) Roach, R. C., Maes, D., Sandoval, D., Robergs, R. A., Icenogle, M., Hinghofer-Szalkay, H., . . . Loeppky, J. A. (2000). Exercise exacerbates acute mountain sickness at simulated high altitude. [Clinical Trial Research Support, U.S. Gov't, Non-P.H.S.]. J Appl Physiol, 88(2), 581-585.
(37) Burtscher, M., Likar, R., Nachbauer, W., Philadelphy, M., Puhringer, R., & Lammle, T. (2001). Effects of aspirin during exercise on the incidence of high-altitude headache: a randomized, double-blind, placebo-controlled trial. [Clinical Trial Randomized Controlled Trial Research Support, Non-U.S. Gov't]. Headache, 41(6), 542-545.
(38) Hackett, P. H., Rennie, D., & Levine, H. D. (1976). The incidence, importance, and prophylaxis of acute mountain sickness. [Clinical Trial Comparative Study Randomized Controlled Trial]. Lancet, 2(7996), 1149-1155.
(39) Schneider, M., Bernasch, D., Weymann, J., Holle, R., & Bartsch, P. (2002). Acute mountain sickness: influence of susceptibility, preexposure, and ascent rate. [Comparative Study]. Med Sci Sports Exerc, 34(12), 1886-1891.
(40) Ri-Li, G., Chase, P. J., Witkowski, S., Wyrick, B. L., Stone, J. A., Levine, B. D., & Babb, T. G. (2003). Obesity: associations with acute mountain sickness. [Research Support, Non-U.S. Gov't]. Ann Intern Med, 139(4), 253-257.
(41) Dutton, K., Blanksby, B. A., & Morton, A. R. (1989). CO2 sensitivity changes during the menstrual cycle. [Comparative Study]. J Appl Physiol, 67(2), 517-522.
(42) White, D. P., Douglas, N.J., Pickett, C. K., Weil, J. V., & Zwillich, C. W. (1983). Sexual influence on the control of breathing. [Comparative Study Research Support, Non-U.S. Gov't Research Support, U.S. Gov't, P.H.S.]. J Appl Physiol, 54(4), 874-879.
(43) Beidleman, B. A., Muza, S. R., Fulco, C. S., Cymerman, A., Ditzler, D., Stulz, D., . . . Sawka, M. N. (2004). Intermittent altitude exposures reduce acute mountain sickness at 4300 m. [Clinical Trial]. Clin Sci (Lond), 106(3), 321-328.
(44) Sutton, J. R., Bryan, A. C., Gray, G. W., Horton, E. S., Rebuck, A. S., Woodley, W., . . . Houston, C. S. (1976). Pulmonary gas exchange in acute mountain sickness. [Research Support, U.S. Gov't, P.H.S.]. Aviat Space Environ Med, 47(10), 1032-1037.
(45) Cudkowicz, L., Spielvogel, H., & Zubieta, G. (1972). Respiratory studies in women at high altitude (3,600 m or 12,200 ft and 5,200 m or 17,200 ft). Respiration, 29(5), 393-426.
(46) Muza, S. R., Rock, P. B., Fulco, C. S., Zamudio, S., Braun, B., Cymerman, A., . . . Moore, L. G. (2001). Women at altitude: ventilatory acclimatization at 4,300 m. [Clinical Trial Comparative Study Research Support, U.S. Gov't, Non-P.H.S. Research Support, U.S. Gov't, P.H.S.]. J Appl Physiol, 91(4), 1791-1799.
(47) Muhm, J. M., Rock, P. B., McMullin, D. L., Jones, S. P., Lu, I. L., Eilers, K. D., . . . McMullen, A. (2007). Effect of aircraft-cabin altitude on passenger discomfort. [Clinical Trial Research Support, Non-U.S. Gov't]. N Engl J Med, 357(1), 18-27.

What is claimed is:

1. A method of utilizing a health outcome prediction model, the method comprising:
storing in computer readable memory associated with a health outcome prediction and management system at least one statistical health model,
wherein the at least one statistical health model is a medical prognostic risk stratification model and/or a medical prognostic outcomes prediction model in the form of at least one of a:
linear model,
a generalized linear model,
a cumulative multinomial model,
a generalized multinomial model,
a proportional hazard model;
providing via the health outcome prediction and management system one or more user interfaces including a plurality of fields that enable one or more users to specify for the at least one statistical health model:
an outcome predicted by the at least one statistical health model;
one or more outcome predictors;
a mathematical relationship between:
the outcome predicted by the at least one statistical health model, and
the one or more outcome predictors;
automatically generating data-input interfaces for collecting patient-specific predictors utilized when executing the at least one statistical health model based at least in part on the one or more outcome predictors;
processing, via a computing device, the one or more outcome predictors and information regarding a patient received via the automatically generated data-input interfaces, using the at least one statistical health model; and
providing, via the computing device, an output from the at least one statistical health model.

2. The method of claim 1, the method further comprising providing via the health outcome prediction and management system a user interface including a plurality of fields configured to:
receive one or more predictor coefficients; and
receive one or more predictor coefficient covariances for calculating confidence intervals.

3. The method of claim 1, wherein the at least one statistical health model is configured to determine a statistical outcome of a medical procedure, medical treatment or intervention, and/or medical condition with respect to the patient.

4. The method of claim 1, wherein the at least one statistical health model is non-linear.

5. The method of claim 1, wherein the at least one statistical health model includes one or more outcome predictor transforms, wherein a first of the one or more outcome predictor transforms is an identity, inverse, square root, power, polynomial, exponential, logarithm, or mapping transformation.

6. The method of claim 1, the method further comprising converting at least one of the one or more statistical health model predictors into a predictor vector.

7. The method of claim 1, the method further comprising providing a web service via which a patient population database is passed through the at least one statistical health model to project disease prevalences.

8. The method of claim 1, wherein the at least one statistical health model is configured to perform at least one of the following:
predict a health outcome based on questionnaire responses,
assist a decision maker's choice of operational modality based on questionnaire responses,
assess a health risk or status based on questionnaire responses.

9. The method of claim 1, the method further comprising providing structured lists of parameters and default values to a remote system.

10. The method of claim 1, the method further comprising obtaining values of coefficients for the least one statistical health model.

11. The method of claim 1, the method further comprising receiving default values of model parameters.

12. The method of claim 1, the method further comprising transmitting to a remote client a response including HTML, WML, or XML formatting, including lists of the model parameters and default values.

13. The method of claim 1, the method further comprising receiving from the remote system patient risk assessments using health query responses and health parameter data.

14. The method of claim 1, the method further comprising providing for display a user interface configured to receive information regarding the patient and the patient medical condition(s).

15. The method of claim 1, the method further comprising providing a programmatic interface to receive information regarding the patient and one or more patient medical conditions.

16. The method of claim 1, the method further comprising providing, via the computing device, an output from the at least one statistical health models for display and/or returning an output from the at least one statistical health model via a programmatic interface.

17. A tangible computer-readable medium having computer-executable instructions stored thereon that, if executed by a computing device, cause the computing device to perform a method comprising:
storing in computer readable memory associated with a health outcome prediction and management system at least one statistical health model,
wherein the at least one statistical health model is a medical prognostic risk stratification model and/or a medical prognostic outcomes prediction model in the form of at least one of a:
linear model,
a generalized linear model,
a cumulative multinomial model,
a generalized multinomial model,
a proportional hazard model;
providing via the health outcome prediction and management system one or more user interfaces including a plurality of fields that enable one or more users to specify for the at least one statistical health model:
an outcome predicted by the at least one statistical health model;
one or more outcome predictors;
a mathematical relationship between:
the outcome predicted by the at least one statistical health model, and
the one or more outcome predictors;
automatically generating data-input interfaces for collecting patient-specific predictors utilized when executing the at least one statistical health model based at least in part on the one or more outcome predictors;
processing, via a computing device, the one or more outcome predictors and information regarding a patient received via the automatically generated data-input interfaces using the at least one statistical health models; and
providing, via the computing device, an output from the at least one statistical health model.

18. The tangible computer-readable medium of claim 17, the method further comprising providing via the statistical health model translation system a user interface including a plurality of fields configured to:
receive one or more predictor coefficients; and
receive one or more predictor coefficient covariances for calculating confidence intervals.

19. The tangible computer-readable medium of claim 17, wherein the at least one statistical health model is configured to determine a statistical outcome of a medical procedure, medical treatment or intervention, and/or medical condition with respect to the patient.

20. The tangible computer-readable medium of claim 17, wherein the at least one statistical health is non-linear.

21. The tangible computer-readable medium of claim 17, wherein the at least one statistical health model includes one or more outcome predictor transforms, wherein a first of the one or more outcome predictor transforms is an identity, inverse, square root, power, polynomial, exponential, logarithm, or mapping transformation.

22. The tangible computer-readable medium of claim 17, the method further comprising converting the at least one statistical health model predictors into a predictor vector.

23. The tangible computer-readable medium of claim 17, the method further comprising providing a web service via which a patient population database is passed through the at least one statistical health model to project disease prevalences.

24. The tangible computer-readable medium of claim 17, wherein the at least one statistical health model is configured to perform at least one of the following:
predict a health outcome based on questionnaire responses,
assist a decision maker's choice of operational modality based on questionnaire responses,
assess a health risk or status based on questionnaire responses.

25. The tangible computer-readable medium of claim 17, the method further comprising providing structured lists of parameters and default values to a remote system.

26. The tangible computer-readable medium of claim 17, the method further comprising obtaining values of coefficients for the at least one statistical health model.

27. The tangible computer-readable medium of claim 17, the method further comprising receiving default values of model parameters.

28. The tangible computer-readable medium of claim 17, the method further comprising transmitting to a remote client a response including HTML, WML, or XML formatting, including lists of the model parameters and default values.

29. The tangible computer-readable medium of claim 17, the method further comprising receiving from the remote system patient risk assessments using health query responses and health parameter data.

30. The tangible computer-readable medium of claim 17, the method further comprising providing for display a user interface configured to receive information regarding the patient and the patient medical condition(s).

31. The tangible computer-readable medium of claim 17, the method further comprising providing a programmatic interface to receive information regarding the patient and one or more patient medical conditions.

32. The tangible computer-readable medium of claim 17, the method further comprising providing via the health outcome prediction and management system one or more user interfaces that enable one or more users to specify via a plurality of defined fields:
one or more limits and/or lists of possible input values for the one or more outcome predictors; and
one or more transforms for the one or more statistical health model predictors.

33. A system, comprising:
a computing device;
tangible computer-readable medium having computer-executable instructions stored thereon that, if executed by a computing device, cause the computing device to perform a method comprising:
storing in computer readable memory associated with a health outcome prediction and management system at least one statistical health model,
wherein the at least one statistical health model is a medical prognostic risk stratification model and/or a medical prognostic outcomes prediction model in the form of at least one of a:
linear model,
a generalized linear model,
a cumulative multinomial model,
a generalized multinomial model,
a proportional hazard model;
providing via the health outcome prediction and management system one or more user interfaces including a plurality of fields that enable one or more users to specify for the at least one statistical health model:
an outcome predicted by the at least one statistical health model;
one or more outcome predictors;
a mathematical relationship between:
the outcome predicted by the at least one statistical health model, and
the one or more outcome predictors;
automatically generating data-input interfaces for collecting patient-specific predictors utilized when executing the at least one statistical health model based at least in part on the one or more outcome predictors;
processing, via a computing device, the one or more outcome predictors and information regarding a patient received via the automatically generated data-input interfaces, where the information received via the automatically generated data-input interfaces includes one or more patient medical conditions using the at least one statistical health model; and
providing, via the computing device, an output from the selected one or more of the at least one statistical health model.

34. The system of claim 33, the method further comprising providing via the health outcome prediction and management system a user interface including a plurality of fields configured to:
receive one or more predictor coefficients; and
receive one or more predictor coefficient covariances for calculating confidence intervals.

35. The system of claim 33, wherein the at least one statistical health model is configured to determine a statistical outcome of a medical procedure, medical treatment or intervention, and/or medical condition with respect to the patient.

36. The system of claim 33, wherein the at least one statistical health model is non-linear.

37. The system of claim 33, wherein the at least one statistical health model includes one or more outcome predictor transforms, wherein a first of the one or more outcome predictor transforms is an identity, inverse, square root, power, polynomial, exponential, logarithm, or mapping transformation.

38. The system of claim 33, the method further comprising converting at least one statistical health model predictors into a predictor vector.

39. The system of claim 33, the method further comprising providing a web service via which a patient population database is passed through at the at least one statistical health model to project disease prevalences.

40. A machine-readable medium or media having instructions recorded thereon that when executed by a processor:
(a) input a regression model specification related to providing predictions regarding the outcome for a patient of a medical treatment;
(b) repeat (a) a plurality of times to obtain and store a plurality of the regression model specifications;
(c) output a user interface for display, the user interface including a plurality of fields to receive patient parameters corresponding to a request for input of variables;
output for display a set of stored regression model specifications;
accept a selection of the displayed regression model specifications for use;
output for display a user interface that requests a user to provide input of variables for the selected regression model specifications;
accept input values for the variables requested; and
use the accepted input values to determine and provide for display results of the selected stored regression model specifications.

41. A machine readable medium in accordance with claim 40 wherein the instructions when executed store accepted variable values in a database with an indication of person or object to which they apply, to retrieve the stored variable values from the database when a different regression model specification is selected for use for the same person or object, and to provide, as default values, the stored variable values for the same person or object for the different regression specification that is selected.

42. A machine readable medium in accordance with claim 40 wherein the instructions when executed enable the printing of the results using customizable content stored in a memory or database, and wherein the results comprise a visual representation of a statistical range.

43. A machine readable medium in accordance with claim 40 wherein to obtain coefficients associated with the selected regression model specifications, the instructions when executed instruct the processor to retrieve variable values from a database and perform a regression using the retrieved variable values.

44. A machine readable medium in accordance with claim 40 wherein the instructions when executed instruct the processor to display a visual selection of mathematical variable transforms for at least some variables and to accept a selection of the mathematical variable transforms and store the selection in a memory.

45. A machine readable medium in accordance with claim 40, wherein the results of the selected stored regression model specifications include a medical outcome prediction, a confidence level, and a symptom probability.

46. A method for providing decision support, the method comprising using a programmed computer to:
(a) input a regression model specification related to providing predictions regarding the outcome for a patient of a medical treatment;
(b) repeat (a) a plurality of times to obtain and store in computer readable memory a plurality of the regression model specifications; and
(c) output for display a user interface including one or more fields to receive respective patient parameters corresponding to the reduced redundancy request for input of variables;
display a set of stored regression model specifications;
accept a selection of the displayed regression model specifications for use;
display a user interface that requests a user to provide input of variables for the selection of regression model specifications;
accept input values for the variables requested; and
use the accepted input values to determine and display results of the selected stored regression model specifications.

47. The system of claim 33, further comprising presenting the predicted estimates as a function of time at high altitude.

48. The system of claim 33, further comprising basing estimates of altitude illness and acclimatization on validated predictive models over a wide range of altitudes.

49. The system of claim 33, further comprising:
calculating altitude accent profiles in terms of meter/days; and
using the accent profiles to develop individual altitude acclimatization protocols.

50. The system of claim 33, further comprising at least one module, where the module is in the form of at least one of a:
acute mountain sickness assessment module,
physical performance capability assessment module,
altitude acclimatization assessment module.

51. The system of claim 33, further comprising:
tracking acclimatization status in real time;
using the real-time acclimatization status to make a physical performance capability assessment; and
adjusting individual work-rate intensity to the individual risk of developing AMS.

52. The system of claim 33, further comprising providing an estimate of altitude acclimatization status based on likelihood of altitude sickness and the magnitude of work impairment.

53. The system of claim 33, further comprising a wearable device and/or as part of a networked system that automatically tracks a subject's altitude exposure and provides real-time estimates of altitude acclimatization for a wide range of possible target or operation altitudes.

54. The system of claim 33, wherein the at least one statistical health model is designed to consider data comprising at least one of the following parameters: subject demographics, sex, age, resident altitude, rate of ascent, operational altitude, work intensity, duration of exposure at operational altitude, AMS symptom severity scores, data collection time-points, physical performance assessment metrics, cognitive performance assessment metrics, specialized skill performance assessment metrics, ventilation, blood & urine parameters, pulse oximetry, medications, VO2 Max, Body-Mass Index, actigraphy, diet, descriptive predictors (i.e. fitness level), physiological predictors (e.g., sea-level PETCO₂, and resting heart rate (HR).

55. The system of claim 33, further comprising estimates of acclimatization as a function of target altitude.

56. The system of claim 33, further comprising estimates of estimates of acclimatization status for a range of higher altitudes.

57. The system of claim 33, further comprising real-time estimates of the altitude acclimatization status of personnel based on their longitudinal histories.
